(19) United States
(12) Patent Application Publication
(10) Pub. No.: US 2026/0071032 A1
(43) Pub. Date: Mar. 12, 2026

(54) METHOD OF PRODUCING POWDERED POLYAMIDE

(71) Applicant: ASAHI KASEI KABUSHIKI KAISHA, Chiyoda-ku, Tokyo (JP)

(72) Inventors: Kenichi YAKIGAYA, Chiyoda-ku, Tokyo (JP); Ryo MIYATAKE, Chiyoda-ku, Tokyo (JP); Yutaro YAMADA, Chiyoda-ku, Tokyo (JP); Noko HONDA, Chiyoda-ku, Tokyo (JP); Shoji OTANI, Chiyoda-ku, Tokyo (JP); Naoyuki KUSUYAMA, Chiyoda-ku, Tokyo (JP)

(73) Assignee: ASAHI KASEI KABUSHIKI KAISHA, Chiyoda-ku, Tokyo (JP)

(21) Appl. No.: 19/110,970

(22) PCT Filed: Sep. 21, 2023
(86) PCT No.: PCT/JP2023/034371

§ 371 Date: Mar. 12, 2025

(30) Foreign Application Priority Data
Sep. 28, 2022 (JP) 2022-154567
Oct. 31, 2022 (JP) 2022-175053
Oct. 31, 2022 (JP) 2022-175054
Oct. 31, 2022 (JP) 2022-175058
Mar. 2, 2023 (JP) 2023-032202
Mar. 8, 2023 (JP) 2023-036053
Mar. 8, 2023 (JP) 2023-036054

(51) Int. Cl. C08J 3/14; C08J 3/12

(52) U.S. Cl. CPC C08J 3/14; C08J 3/126; C08J 2377/06; C08J 2431/08

(57) ABSTRACT

A method of producing powdered polyamide includes: a step 1 of heating and dissolving a polyamide resin composition in a metal chloride alcohol solution containing a metal chloride and an alcohol to obtain a polyamide thermal dissolution liquid; a step 2 of diluting the polyamide thermal dissolution liquid with an alcohol to obtain an alcohol dilution; and a step 3 of cooling the alcohol dilution to cause precipitation of powdered polyamide. The mass proportion of metal chloride relative to 100 mass % of the metal chloride alcohol solution in step 1 is 23 mass % to 35 mass %, the polyamide thermal dissolution liquid contains 0.2 mol to 2.5 mol of water relative to 1 mol of metal chloride in step 1, and the polyamide thermal dissolution liquid is diluted without dropping below a temperature of 50° C. in step 2.

### TECHNICAL FIELD

The present disclosure relates to a method of producing powdered polyamide.

In particular, aspect (I) of the present disclosure relates to a method of producing powdered polyamide. Aspect (I) of the present disclosure preferably relates to a method of producing powdered polyamide with reduced amounts of waste liquid and energy usage. Aspect (II) of the present disclosure relates to a method of producing recycled polyamide with a reduced amount of waste liquid. Aspect (III) of the present disclosure relates to a method of producing recycled polyamide. In more detail, aspect (III) of the present disclosure relates to a method of producing recycled polyamide using a polyamide base fabric coated with silicone or the like as a raw material. Aspect (IV) of the present disclosure relates to a methanol composition that can be used as a solvent having low metal corrosiveness and high polyamide solubility and to a method of producing a polyamide composition, a polyamide composition, and a powder for which this methanol composition is used. Aspect (V) of the present disclosure relates to a method of producing polyamide. Aspect (VI) of the present disclosure relates to a method of producing polyamide, a method of producing polyethylene terephthalate, and a method of producing polyamide and polyethylene terephthalate. Aspect (VII) of the present disclosure relates to a method of producing recycled polyamide. In more detail, aspect (VII) of the present disclosure relates to a method of producing recycled polyamide using a polyamide base fabric coated with urethane or the like as a raw material.

### BACKGROUND

In relation to aspect (I) of the present disclosure, polyamides such as nylon 6 and nylon 66, which are representative examples of engineering plastics, are irreplaceable materials in modern society that have heat resistance and good mechanical characteristics and that are widely used in fibers, automotive components, electrical product components, and so forth.

In recent years, techniques related to the recycling of plastics have been developed with aims of resource conservation and carbon neutrality, and polyamides are no exception thereto.

Recycling is broadly categorized as what is referred to as “material recycling” in which a material that has previously been shaped is pelletized once again and what is referred to as “chemical recycling” in which depolymerization is performed in order to reuse monomers. Although lack of stable quality is a concern in the case of material recycling because polymer degradation and additive components present in a shaped item remain in that form in the recycled polymer, material recycling is selected in situations such as when a material is to be cycled with a fixed application because material recycling is not accompanied by chemical reactions and has little requirement for auxiliary raw materials, and thus can be performed with little expenditure of resources and energy. Moreover, material recycling techniques are also useful in order to perform chemical recycling because in a situation such as when additive matter, a coating, or the like is to be removed from processed or used polyamide that has been recovered from a factory or the market, this polyamide undergoes a step of recovering clean polyamide in the same manner as in material recycling prior to chemical recycling.

Moreover, obtained polyamides are required to have various particle properties depending on the application thereof. Examples of such requirements include a large particle diameter being preferable in order to prevent scattering during powder handling and uniform particles having a small particle size distribution being preferable from a viewpoint of processability and mixability of additives. There is also demand for techniques for controlling these particle properties.

Moreover, in relation to aspect (II) of the present disclosure, polyamides such as nylon 6 and nylon 66, which are representative examples of engineering plastics, are irreplaceable materials in modern society that have heat resistance and good mechanical characteristics and that are widely used in fibers, automotive components, electrical product components, and so forth.

In recent years, techniques related to the recycling of plastics have been developed with aims of resource conservation and carbon neutrality, and polyamides are no exception thereto.

Recycling methods are broadly categorized as what is referred to as “material recycling” in which a material that has previously been shaped is pelletized once again and what is referred to as “chemical recycling” in which monomers obtained through depolymerization of a polymer are reused. Although lack of stable quality is a concern in the case of material recycling because polymer degradation and additive components present in a shaped item are carried through to the recycled polymer in that form, material recycling is advantageous in terms of not being accompanied by chemical reactions and having little requirement for auxiliary raw materials, which makes it possible to limit expenditure of resources and energy. Accordingly, material recycling is selected in situations such as when a material is to be cycled with a fixed application. Moreover, in order to remove additive matter, a coating, or the like from a processed and/or used polyamide shaped item that has been recovered from a factory or the market, this polyamide may undergo a step of recovering clean polyamide in the same manner as in material recycling prior to chemical recycling. Therefore, material recycling techniques are also useful in order to perform chemical recycling.

Examples of physical methods for removing foreign matter from a used polyamide shaped item so as to place the shaped item in a clean state include a method in which a recovered shaped item is pulverized and then subjected to gravity separation (Patent Literature (PTL) 1). Although this method enables separation with little energy, it is difficult to separate polyamide and foreign matter in a situation in which the polyamide and the foreign matter are strongly bound through mixing, bonding, and/or adhesion, for example. There is also a method in which some or all superfluous foreign matter is dissolved in a solvent and removed. However, foreign matter is typically added or applied onto polyamide, and some or all of this foreign matter is present in an inner part of a structure of the polyamide, which makes it difficult to completely dissolve the foreign matter using a solvent and separate the foreign matter from the polyamide structure.

Another possible method involves using a solvent to dissolve polyamide in a shaped item, removing foreign matter as insoluble matter, and subsequently causing precipitation of and collecting the polyamide by an arbitrary method. However, examples of solvents that can dissolve polyamides include strong acids such as formic acid and sulfuric acid and also expensive solvents such as HFIP, and these solvents are often not suitable for industrial use. One example in which a solvent suitable for industrial use is used is a dissolution and recovery method through ethylene glycol (PTL 2). However, polyamide glycolysis is a concern in this method because an extremely high temperature reaction is required, and it is also necessary to remove/dry all of the used solvent from a sherbet-like solid, and thus this method is considered to have high energy requirement when this is taken into account together with heating during the reaction. Accordingly, a method involving dissolution using a calcium chloride solution of an alcohol has been established as a method that can be implemented at a low temperature using general purpose raw materials. For example, a method that involves using a methanol solution of calcium chloride to treat a fabric-like polyamide shaped item coated with silicone and thereby dissolve polyamide, and subsequently diluting the solution with a large amount of water or methanol to obtain a target polyamide as a powder has been proposed (PTL 3).

Furthermore, in relation to aspect (III) of the present disclosure, polyamides such as nylon 6 and nylon 66, which are representative examples of engineering plastics, are irreplaceable materials in modern society that have heat resistance and good mechanical characteristics and that are widely used in fibers, automotive components, electrical product components, and so forth. In particular, nylon 66 is extremely important because it is used in applications where heat resistance and durability are required in particularly harsh environments.

In recent years, techniques related to the recycling of plastics have been developed with aims of resource conservation and carbon neutrality, and polyamides are no exception thereto.

Recycling is broadly categorized as what is referred to as “material recycling” in which a material that has previously been shaped is pelletized once again and what is referred to as “chemical recycling” in which depolymerization is performed in order to reuse monomers. Although lack of stable quality is a concern in the case of material recycling because polymer degradation and additive components present in a shaped item remain in that form in the recycled polymer, material recycling is selected in situations such as when a material is to be cycled with a fixed application because material recycling is not accompanied by chemical reactions and has little requirement for auxiliary raw materials, and thus can be performed with little expenditure of resources and energy. Moreover, material recycling techniques are also useful in order to perform chemical recycling because in a situation such as when additive matter, a coating, or the like is to be removed from processed or used polyamide that has been recovered from a factory or the market, this polyamide undergoes a step of recovering clean polyamide in the same manner as in material recycling prior to chemical recycling.

As previously described, it is necessary to change the recovery method depending on the application since various types of foreign matter are present in processed and used polyamides. Although polyamides have a wide range of applications, one example of an application of nylon 66 is in automobiles where high safety is required. For example, nylon 66 is used in components surrounding engines where high heat resistance is required and is also used in base fabrics of airbags where durability during rupture is required. Of these applications, airbag base fabrics experience little degradation and are suitable for material recycling. Besides used airbags, offcuts and the like that arise during cutting out of parts during production and sewing of airbag base fabrics can also serve as subjects of recycling.

A base fabric of an airbag is typically a product that is obtained by spinning and then weaving nylon 66 to obtain a woven fabric and subsequently coating the woven fabric with a silicone resin. Consequently, it is necessary to separate the coating and the nylon 66 in order to perform material recycling of the airbag base fabric.

Also, in relation to aspect (IV) of the present disclosure, polyamides such as nylon 6 and nylon 66, which are representative examples of engineering plastics, are irreplaceable materials in modern society that have heat resistance and good mechanical characteristics and that are widely used in fibers, automotive components, electrical product components, and so forth.

In recent years, techniques related to the recycling of plastics have been developed with aims of resource conservation and carbon neutrality, and polyamides are no exception thereto. In particular, polyamide 66 (poly(hexamethylene adipamide)) is a polyamide that is produced in a large quantity and is one polyamide for which recycling should be a priority.

Recycling is broadly categorized as what is referred to as “material recycling” in which a material that has previously been shaped is pelletized once again and what is referred to as “chemical recycling” in which depolymerization is performed in order to reuse monomers. Although lack of stable quality is a concern in the case of material recycling because polymer degradation and additive components present in a shaped item remain in that form in the recycled polymer, material recycling is selected in situations such as when a material is to be cycled with a fixed application because material recycling is not accompanied by chemical reactions and has little requirement for auxiliary raw materials, and thus can be performed with little expenditure of resources and energy. Moreover, material recycling techniques are also useful in order to perform chemical recycling because in a situation such as when additive matter, a coating, or the like is to be removed from processed or used polyamide that has been recovered from a factory or the market, this polyamide undergoes a step of recovering clean polyamide in the same manner as in material recycling prior to chemical recycling.

Examples of physical methods for removing foreign matter from used polyamide so as to place the polyamide in a clean state include a method in which recovered material is pulverized and then subjected to gravity separation (PTL 1). Although this method enables separation with little energy, it is difficult to separate polyamide and foreign matter in a situation in which the polyamide and the foreign matter are strongly bound through mixing, bonding, adhesion, or the like as in a coating of an airbag. There is also a method in which some or all superfluous foreign matter is dissolved in a solvent and removed. However, foreign matter is typically added or applied onto polyamide, and some or all of this foreign matter is present in an inner part of a structure of the polyamide, which makes it difficult to completely dissolve the foreign matter.

Another method involves dissolving polyamide in a solvent, removing foreign matter as insoluble matter, and subsequently causing precipitation of and collecting the polyamide by an arbitrary method. However, examples of solvents that can dissolve polyamides include highly corrosive strong acids such as formic acid and sulfuric acid and also solvents that are not readily available such as HFIP, and these solvents are often not suitable for industrial use. One example in which a solvent that is easy to use in industry is used is a dissolution and recovery method through ethylene glycol (PTL 2). However, polyamide glycolysis is a concern in this method because an extremely high temperature reaction is required, and it is also necessary to remove/dry all of the used solvent from a sherbet-like solid, and thus this method is considered to have high energy requirement when this is taken into account together with heating during the reaction. Accordingly, a method involving dissolution using an alcohol solution of a metal chloride such as calcium chloride has been established as a method that uses a low temperature and general purpose raw materials. For example, PTL 3 discloses a method that involves using a methanol solution of calcium chloride to treat a polyamide fabric coated with silicone and thereby dissolve polyamide, and subsequently diluting the solution with a large amount of water or methanol to obtain a target polyamide as a powder.

Although this method is thought to be extremely useful as a method of recovering polyamide, the calcium chloride methanol solution has very high corrosiveness and easily causes corrosion of general purpose metals such as carbon steel and stainless steel (SUS304, SUS316, etc.). Consequently, such general purpose metals cannot be used in equipment for dissolving polyamide using a calcium chloride methanol solution, and it is necessary to use Alloy C276, or the like, which is a nickel-based alloy having high chlorine corrosion resistance, or it is necessary to use an apparatus that has been treated by non-metal glass lining, rubber lining, fluorine lining, or the like. The use of general purpose materials is necessary from perspectives of ease of acquisition and processability as a material.

Moreover, in relation to aspect (V) of the present disclosure, polyamide resins display excellent characteristics and are, therefore, used in production of various machines and components, such as in production of automobiles, machines, and electrical and electronic components. In particular, polyamide resins are widely used as shaping materials for sliding components such as gears, cams, and bearings due to excelling particularly in terms of mechanical characteristics and wear resistance.

In recent years, techniques related to the recycling of plastics have been developed with aims of resource conservation and carbon neutrality, and polyamides are no exception thereto.

Recycling is broadly categorized as what is referred to as “material recycling” in which a material that has previously been shaped is pelletized once again and what is referred to as “chemical recycling” in which depolymerization is performed in order to reuse monomers.

Although lack of stable quality is a concern in the case of material recycling because degraded polymer and additive components present in a shaped item remain in that form in the recycled polymer, material recycling is selected in situations such as when a material is to be cycled with a fixed application because material recycling is not accompanied by chemical reactions and has little requirement for auxiliary raw materials, and thus can be performed with little expenditure of resources and energy.

Moreover, material recycling techniques are also useful in order to perform chemical recycling because in a situation such as when additive matter, a coating, or the like is to be removed from a processed or used polyamide-containing material that has been recovered from a factory or the market, this material undergoes a step of recovering clean polyamide in the same manner as in material recycling prior to chemical recycling.

Since a large particle diameter may be preferable in order to prevent scattering during powder handling and uniform particles having a small particle size distribution may be preferable from a viewpoint of processability and mixability of additives, for example, there is demand for techniques for controlling these particle properties.

One example of a physical method for removing foreign matter from used polyamide so as to place the polyamide in a clean state is a method in which the polyamide is dissolved in a solvent, foreign matter is removed as insoluble matter, and then the polyamide is caused to precipitate and is recovered by an arbitrary method. However, examples of solvents that can dissolve polyamides include strong acids such as formic acid and sulfuric acid and also expensive solvents such as HFIP, and these solvents are often not suitable for industrial use.

One example in which a solvent that is easy to use in industry is used is a dissolution and recovery method through ethylene glycol (PTL 2). However, polyamide glycolysis is a concern in the recovery method of PTL 2 because an extremely high temperature reaction is required, and it is also necessary to remove/dry all of the used solvent from a sherbet-like solid, and thus this method is considered to have high energy requirement when this is taken into account together with heating during the reaction.

Accordingly, a method involving dissolution using a calcium chloride solution of an alcohol has been established as a method using a low temperature and general purpose raw materials. For example, PTL 3 discloses a method that involves using a methanol solution of calcium chloride to treat a polyamide fabric coated with silicone and thereby dissolve polyamide, and subsequently diluting the solution with a large amount of water or methanol to obtain a target polyamide as a powder.

However, although powdered polyamide can be obtained by the method of PTL 3, this method results in particle diameter distribution widening due to variation of the rate of precipitation that is caused by variation of the dilution ratio over time during dilution with a large amount of solvent. A method in which a polyamide solution is conversely added into a large amount of a solvent is anticipated to enable a smaller particle diameter distribution. However, increasing the dilution ratio to a level where compositional change can be ignored makes it necessary to use a large amount of solvent, and thus this method has been problematic in terms of its large financial and environmental burden.

Moreover, one example of a method for controlling precipitation without raising the dilution ratio is a method such as recrystallization in which dilution is performed through a methanol aqueous solution in a heated state and in which cooling and precipitation are subsequently performed such as described in PTL 4.

However, although conditions for obtaining a porous powder are considered in the technique of PTL 4, there is no description of crystallization conditions for obtaining a good powder or of alteration of the particle size distribution through this crystallization, and the optimal conditions are not clear.

Moreover, in relation to aspect (VI) of the present disclosure, polyamide resins and polyethylene terephthalate resins display excellent characteristics and are, therefore, used in production of various machines and components, such as in production of automobiles, machines, and electrical and electronic components. In particular, polyamide resins are widely used as shaping materials for sliding components such as gears, cams, and bearings due to excelling particularly in terms of mechanical characteristics and wear resistance.

In recent years, techniques related to the recycling of plastics have been developed with aims of resource conservation and carbon neutrality, and polyamides and polyethylene terephthalate are no exception thereto.

Recycling is broadly categorized as what is referred to as “material recycling” in which a material that has previously been shaped is pelletized once again and what is referred to as “chemical recycling” in which depolymerization is performed in order to reuse monomers.

Although lack of stable quality is a concern in the case of material recycling because degraded polymer and additive components present in a shaped item remain in that form in the recycled polymer, material recycling is selected in situations such as when a material is to be cycled with a fixed application because material recycling is not accompanied by chemical reactions and has little requirement for auxiliary raw materials, and thus can be performed with little expenditure of resources and energy.

Moreover, material recycling techniques are also useful in order to perform chemical recycling because in a situation such as when additive matter, a coating, or the like is to be removed from a processed or used polyamide-containing material that has been recovered from a factory or the market, this material undergoes a step of recovering clean polyamide in the same manner as in material recycling prior to chemical recycling.

As previously described, it is necessary to change the recovery method depending on the application since various types of foreign matter are present in processed and used polyamides. Although polyamides have a wide range of applications, one example of an application of nylon 66 is in automobiles where high safety is required. For example, nylon 66 is used in components surrounding engines where high heat resistance is required and is also used in base fabrics of airbags where durability during rupture is required. Of these applications, airbag base fabrics experience little degradation and are suitable for material recycling. Besides used airbags, offcuts and the like that arise during cutting out of parts during production and sewing of airbag base fabrics can also serve as subjects of recycling.

A base fabric of an airbag is typically a product that is obtained by spinning nylon 66 and polyethylene terephthalate and then performing weaving thereof individually or performing weaving thereof in a partially mixed form to obtain a woven fabric.

Consequently, it is necessary to separate the polyamide and polyethylene terephthalate in order to perform material recycling of the airbag base fabric.

Examples of physical methods for removing foreign matter from polyamide containing foreign matter so as to place the polyamide in a clean state include a method in which recovered material is pulverized and then subjected to gravity separation (PTL 1).

Although this method enables separation with little energy, it is difficult to separate polyamide and foreign matter in the case of an airbag base fabric in which the polyamide and foreign matter are strongly bound through mixing, bonding, adhesion, or the like.

Moreover, there is also a method that involves dissolving and removing some or all superfluous foreign matter such as silicone using a solvent (for example, PTL 6).

However, silicone resin remains in recovered polyamide because silicone is present in a state in which it has permeated into fibers of the polyamide. Moreover, the recovered polyamide is recovered in the form of a pulverized fabric. Used airbags and production offcuts have various shapes, and it is difficult to reuse airbags and production offcuts while in those shapes or in the shapes of fiber scraps obtained through cutting thereof. Moreover, even when such airbags and production scraps are to be melted and then reused, they do not have a shape that is suitable for charging to an extruder or the like.

Conversely to the method described above, a method that involves dissolving polyamide in a solvent, removing foreign matter as insoluble matter, and subsequently causing precipitation of and recovering the polyamide by an arbitrary method may be considered.

However, examples of solvents that can dissolve polyamides include strong acids such as formic acid and sulfuric acid and also expensive solvents such as HFIP. Such solvents are often not suitable for industrial use, and decomposition of polyethylene terephthalate is also a concern.

One example in which a solvent that is easy to use in industry is used is a dissolution and recovery method through ethylene glycol (PTL 2).

However, polyamide and polyethylene terephthalate glycolysis is a concern in this method because an extremely high temperature reaction is required, and it is also necessary to remove/dry all of the used solvent from a sherbet-like solid, and thus this method is considered to have high energy requirement when this is taken into account together with heating during the reaction.

Accordingly, a method involving dissolution using a calcium chloride solution of an alcohol has been established as a method using a low temperature and general purpose raw materials.

For example, PTL 3 discloses a method that involves using a methanol solution of calcium chloride to treat a polyamide fabric coated with silicone and thereby dissolve polyamide, and subsequently diluting the solution with a large amount of water or methanol to obtain a target polyamide as a powder.

However, actual use of the method described in PTL 3 for dissolution of silicone-coated polyamide base fabrics has revealed that there is a problem with this method. PTL 3 discloses that it is preferable to use calcium chloride dihydrate having high polyamide solubility or to add a hydrate-equivalent amount of water in addition to anhydrous calcium chloride, and the reason for this is the high polyamide solubility with such a composition.

Furthermore, in relation to aspect (VII) of the present disclosure, polyamides such as nylon 6 and nylon 66, which are representative examples of engineering plastics, are irreplaceable materials in modern society that have heat resistance and good mechanical characteristics and that are widely used in fibers, automotive components, electrical product components, and so forth. In particular, nylon 66 is extremely important because it is used in applications where heat resistance and durability are required in particularly harsh environments.

In recent years, techniques related to the recycling of plastics have been developed with aims of resource conservation and carbon neutrality, and polyamides are no exception thereto.

Recycling is broadly categorized as what is referred to as “material recycling” in which a material that has previously been shaped is pelletized once again and what is referred to as “chemical recycling” in which depolymerization is performed in order to reuse monomers. Although lack of stable quality is a concern in the case of material recycling because polymer degradation and additive components present in a shaped item remain in that form in the recycled polymer, material recycling is selected in situations such as when a material is to be cycled with a fixed application because material recycling is not accompanied by chemical reactions and has little requirement for auxiliary raw materials, and thus can be performed with little expenditure of resources and energy. Moreover, material recycling techniques are also useful in order to perform chemical recycling because in a situation such as when additive matter, a coating, or the like is to be removed from processed or used polyamide that has been recovered from a factory or the market, this polyamide undergoes a step of recovering clean polyamide in the same manner as in material recycling prior to chemical recycling.

As previously described, it is necessary to change the recovery method depending on the application since various types of foreign matter are present in processed and used polyamides. Although polyamides have a wide range of applications, one example of an application of nylon 66 is in automobiles where high safety is required. For example, nylon 66 is used in components surrounding engines where high heat resistance is required and is also used in base fabrics of airbags where durability during rupture is required. Of these applications, airbag base fabrics experience little degradation and are suitable for material recycling. Besides used airbags, offcuts and the like that arise during cutting out of parts during production and sewing of airbag base fabrics can also serve as subjects of recycling.

A base fabric of an airbag is typically a product that is obtained by spinning and then weaving nylon 66 to obtain a woven fabric and subsequently coating the woven fabric with a resin. Consequently, it is necessary to separate the coating and the nylon 66 in order to perform material recycling of the airbag base fabric.

### CITATION LIST

### Patent Literature

PTL 1: JP5841598B2
PTL 2: JP2018-172618A
PTL 3: JP5110704B2
PTL 4: JP-S60-233129A
PTL 5: JP-S62-218421A
PTL 6: JP7024037B1

### SUMMARY

### Technical Problem

An object of the present disclosure is the efficient production of powdered polyamide.

In relation to aspect (I) of the present disclosure, examples of physical methods for removing foreign matter from used polyamide so as to place the polyamide in a clean state include a method in which recovered material is pulverized and then subjected to gravity separation (PTL 1). Although this method enables separation with little energy, it is difficult to separate polyamide and foreign matter in a situation in which the polyamide and foreign matter are strongly bound through mixing, bonding, adhesion, or the like. There is also a method in which some or all superfluous foreign matter is dissolved in a solvent and removed. However, foreign matter is typically added or applied onto polyamide, and some or all of this foreign matter is present in an inner part of a structure of the polyamide, which makes it difficult to completely dissolve the foreign matter, and it is also difficult to adequately control shape, size, and so forth with the obtained polyamide in a pulverized state.

Another method involves dissolving polyamide in a solvent, removing foreign matter as insoluble matter, and subsequently causing precipitation of and recovering the polyamide by an arbitrary method. However, examples of solvents that can dissolve polyamides include strong acids such as formic acid and sulfuric acid and also expensive solvents such as HFIP, and these solvents are often not suitable for industrial use. One example in which a solvent that is easy to use in industry is used is a dissolution and recovery method through ethylene glycol (PTL 2). However, polyamide glycolysis is a concern in this method because an extremely high temperature reaction is required, and it is also necessary to remove/dry all of the used solvent from a sherbet-like solid, and thus this method is considered to have high energy requirement when this is taken into account together with heating during the reaction.

Accordingly, a method involving dissolution using a calcium chloride solution of an alcohol has been established as a method using a low temperature and general purpose raw materials. For example, PTL 3 discloses a method that involves using a methanol solution of calcium chloride to treat a polyamide fabric coated with silicone and thereby dissolve polyamide, and subsequently diluting the solution with a large amount of water or methanol to obtain a target polyamide as a powder.

When we verified such a method of producing polyamide powder through dissolution and precipitation using a metal chloride alcohol solution with industrial production in mind, it became clear that although polyamide powder from which an impurity such as silicone has been removed can indeed be obtained by this method, a significant problem arises when the method is implemented in an industrial context. Since the polyamide powder that precipitated from the solvent ended up containing a large amount of the solvent during precipitation, it was not possible to easily remove solvent that had infiltrated into an inner part of the solid even through filtration or centrifugal separation. Consequently, it is necessary to perform washing numerous times using a large amount of a washing solvent in order to remove an impurity such as a metal chloride in the solid. Moreover, another problem is that a large amount of energy is required in order to remove a large amount of solvent when performing drying in order to remove the solvent from the washed powder.

As a result of diligent investigation of this phenomenon, we determined that increased porosity of particles is the main cause of inclusion of a large amount of solvent. PTL 4 describes a method of controlling the porosity of polyamide. PTL 4 describes an invention of obtaining porous particles by adopting a method in which polyamide is dissolved in a metal chloride methanol solution, a methanol aqueous solution having a limited water content range is added to the polyamide solution in a heated state, and then cooling and precipitation are performed. PTL 4 gives a method in which dilution is performed using methanol as an example for suppressing porosity and relates to an invention that solvent conditions causing precipitation are important. When we investigated suppression of porosity with reference to this invention, although there was a slight suppressive effect, we still obtained a porous solid and could not confirm a remarkable effect.

From a viewpoint of particle diameter control, the method described in PTL 3 can yield powdered polyamide but results in particle diameter distribution widening due to variation of the rate of precipitation that is caused by variation of the dilution ratio over time during dilution with a large amount of solvent. A method in which a polyamide solution is conversely added into a large amount of a solvent is anticipated to enable a smaller particle diameter distribution. However, increasing the dilution ratio to a level where compositional change can be ignored makes it necessary to use a large amount of solvent, and thus this method has a large financial and environmental burden.

One example of a method for controlling precipitation without raising the dilution ratio is a method such as recrystallization in which dilution is performed through a methanol aqueous solution in a heated state and in which cooling and precipitation are subsequently performed such as described in PTL 4. However, although PTL 4 considers conditions for obtaining a porous powder, there is no description of crystallization conditions for obtaining a good powder or of alteration of the particle size distribution through this crystallization, and the optimal conditions are not clear.

Moreover, PTL 5 describes a method in which a polyamide in a pressurized state is dissolved at a high temperature of 130° C. or higher and is then slowly cooled at 3° C./hr to 20° C./hr to obtain a powder. However, treatment at a high temperature is undesirable because at the aforementioned temperature, there is a concern that decomposition of the polyamide by an alcohol and elution of additives from foreign matter may arise even to a small extent. Moreover, slow cooling is time consuming and is, therefore, not suitable as an industrial process.

Accordingly, an object of aspect (I) of the present disclosure is to provide a method of producing powdered polyamide that suppresses porosity and that also generates little waste liquid and has low energy requirement for drying as a result of reducing the amount of contained solvent. Moreover, it would be preferable to provide a method of producing powdered polyamide having a large particle diameter and a small particle size distribution in a preferably short time.

In relation to aspect (II) of the present disclosure, it is desirable that polyamide recovered from a polyamide shaped item does not contain impurities because the composition of additives, etc. is adjusted once again prior to the polyamide being shaped. Washing using a washing liquid such as an organic solvent is necessary in a case in which an organic compound is contained as an impurity, whereas washing using water and/or a washing liquid that contains water is preferable for washing of an inorganic compound. In particular, in a case in which a dissolution process has been performed in a methanol solution of calcium chloride, it is necessary for the washing step to sufficiently remove calcium chloride that was used as a solvent, potassium serving as an additive of the polyamide, and also metals such as copper. When solubilities of these impurities are taken into account, it is preferable that final washing of the polyamide is performed using water.

The inventors attempted to recover polyamide through the method described in PTL 3 in which a polyamide shaped item is treated using a methanol solution of calcium chloride and thereby found that although polyamide can be recovered, a specific phenomenon arises at the time of filtration. Specifically, the precipitated polyamide contains a large amount of solvent (inclusive of water, methanol, and calcium chloride methanol solution). Since the amount of impurities that can be removed through one washing is determined by the dilution ratio by which solvent contained in the precipitated polyamide is diluted using a washing liquid, the inclusion of a large amount of solvent in the precipitated polyamide means that the amount of the washing liquid (typically water) also needs to be increased in proportion thereto, resulting in significant reduction of impurity removal efficiency.

Moreover, heating and vacuum drying for removal of solution (particularly water) that is in a stable state impregnated inside of polyamide particles require substantial energy, and thus an increase of solution contained inside of polyamide particles imposes an extremely high burden on the process.

Accordingly, an object of aspect (II) of the present disclosure is to provide a method of producing recycled polyamide with a reduced amount of waste liquid.

In relation to aspect (III) of the present disclosure, examples of physical methods for removing foreign matter from polyamide that contains foreign matter so as to place the polyamide in a clean state include a method in which recovered material is pulverized and then subjected to gravity separation (PTL 1). Although this method enables separation with little energy, separation is difficult in the case of an airbag base fabric in which polyamide and foreign matter are strongly bound through mixing, bonding, adhesion, or the like.

Moreover, there is also a method that involves dissolving and removing some or all superfluous foreign matter such as silicone using a solvent (for example, PTL 6). However, silicone resin remains in recovered polyamide because silicone is present in a state in which it has permeated into fibers of the polyamide. Furthermore, the recovered polyamide is recovered in the form of a pulverized fabric. Used airbags and production offcuts have various shapes, and it is difficult to reuse airbags and production offcuts while in those shapes or in the shapes of fiber scraps obtained through cutting thereof. Moreover, even when such airbags and production scraps are to be melted and then reused, they do not have a shape that is suitable for charging to an extruder or the like.

Conversely to the method described above, a method that involves dissolving polyamide in a solvent, removing foreign matter as insoluble matter, and subsequently causing precipitation of and recovering the polyamide by an arbitrary method may be considered. However, examples of solvents that can dissolve polyamides include strong acids such as formic acid and sulfuric acid and also expensive solvents such as HFIP, and these solvents are often not suitable for industrial use. One example in which a solvent that is easy to use in industry is used is a dissolution and recovery method through ethylene glycol (PTL 2). However, polyamide glycolysis is a concern in this method because an extremely high temperature reaction is required, and it is also necessary to remove/dry all of the used solvent from a sherbet-like solid, and thus this method is considered to have high energy requirement when this is taken into account together with heating during the reaction.

Accordingly, a method involving dissolution using a calcium chloride solution of an alcohol has been established as a method using a low temperature and general purpose raw materials. For example, PTL 3 discloses a method that involves using a methanol solution of calcium chloride to treat a polyamide fabric coated with silicone and thereby dissolve polyamide, and subsequently diluting the solution with a large amount of water or methanol to obtain a target polyamide as a powder.

However, actual use of the method described in PTL 3 for dissolution of silicone-coated polyamide base fabrics has revealed that there is a problem with this method. PTL 3 discloses that it is preferable to use calcium chloride dihydrate having high polyamide solubility or to add a hydrate-equivalent amount of water in addition to anhydrous calcium chloride, and the reason for this is the high polyamide solubility with such a composition.

However, when we actually attempted dissolution using a polyamide base fabric, it became clear that there is an issue in terms of low recovery rate. Even when we attempted to dissolve approximately 23% of polyamide, which corresponds to the saturation solubility with the aforementioned solvent composition, it was not possible to completely dissolve and recover the polyamide because when a base fabric has a certain amount of area, sticking together of base fabric pieces or rolling up of the base fabric occurs. There was also supernatant clouding after dissolution, and thus although the supernatant had a fluid state, this state could not easily be referred to as “dissolved”. Although a method of pulverizing a base fabric in advance may be adopted with the aim of increasing the yield, fine silicone resin fragments are dispersed in liquid when such pulverization is performed and are extremely difficult to recover from the solution.

An object of aspect (III) of the present disclosure is to provide a method of producing recycled polyamide efficiently and with high yield from a polyamide base fabric coated with silicone.

In relation to aspect (IV) of the present disclosure, an object of aspect (IV) of the present disclosure is to provide a solvent having low metal corrosiveness and high polyamide solubility.

In relation to aspect (V) of the present disclosure, the techniques of PTL 2 to 4 leave room for further improvement with regards to a method of recovering polyamide with high efficiency and high yield as described above.

Moreover, in a case in which polyamide is dissolved using a calcium chloride solution of an alcohol such as in PTL 3, it is normally the case that after precipitation and recovery of polyamide, the recovered polyamide is washed.

However, in this washing of the recovered polyamide, it is preferable to avoid excessive washing from viewpoints such as production efficiency, cost, and environmental consciousness. Conversely, inadequate washing of the recovered polyamide has also resulted in a problem that some of the polyamide may melt and become stuck together during subsequent drying due to metal chloride that is attached to the polyamide after washing.

Accordingly, an object of aspect (V) of the present disclosure is to provide a method of producing polyamide that enables recovery of polyamide with high efficiency and high yield and that can also yield high quality polyamide without performing excessive washing.

In relation to aspect (VI) of the present disclosure, the techniques of PTL 1 to 3 and 6 leave room for further improvement with regards to a method of recovering polyamide with high efficiency and high yield as described above.

Moreover, in the case of a base fabric of an airbag that is a mixed material of polyamide and polyethylene terephthalate, difficulty of recovering polyamide and polyethylene terephthalate and low recovery rate have been issues because the base fabric has a certain amount of area and thus sticking together of base fabric pieces or rolling up of the base fabric occurs.

Although a method of pulverizing the base fabric in advance may be adopted with the aim of increasing the yield, this method is problematic in terms that operation becomes more complicated and also results in fragments of polyethylene terephthalate becoming dispersed in liquid and becoming extremely difficult to recover.

Accordingly, an object of aspect (VI) of the present disclosure is to provide a method of producing polyamide, a method of producing polyethylene terephthalate, and a method of producing polyamide and polyethylene terephthalate that enable the recovery of polyamide and/or polyethylene terephthalate from a mixed material of polyamide and polyethylene terephthalate with high efficiency and high yield.

In relation to aspect (VII) of the present disclosure, examples of physical methods for removing foreign matter from polyamide that contains foreign matter so as to place the polyamide in a clean state include a method in which recovered material is pulverized and then subjected to gravity separation (PTL 1). Although this method enables separation with little energy, separation is difficult in the case of an airbag base fabric in which polyamide and foreign matter are strongly bound through mixing, bonding, adhesion, or the like.

Moreover, there is also a method that involves dissolving and removing some or all superfluous foreign matter such as a coating resin using a solvent (for example, PTL 6). However, silicone resin remains in recovered polyamide because silicone is present in a state in which it has permeated into fibers of the polyamide. Furthermore, the recovered polyamide is recovered in the form of a pulverized fabric. Used airbags and production offcuts have various shapes, and it is difficult to reuse airbags and production offcuts while in those shapes or in the shapes of fiber scraps obtained through cutting thereof. Moreover, even when such airbags and production scraps are to be melted and then reused, they do not have a shape that is suitable for charging to an extruder or the like.

Conversely to the method described above, a method that involves dissolving polyamide in a solvent, removing foreign matter as insoluble matter, and subsequently causing precipitation of and recovering the polyamide by an arbitrary method may be considered. However, examples of solvents that can dissolve polyamides include strong acids such as formic acid and sulfuric acid and also expensive solvents such as HFIP, and these solvents are often not suitable for industrial use. One example in which a solvent that is easy to use in industry is used is a dissolution and recovery method through ethylene glycol (PTL 2). However, polyamide glycolysis is a concern in this method because an extremely high temperature reaction is required, and it is also necessary to remove/dry all of the used solvent from a sherbet-like solid, and thus this method is considered to have high energy requirement when this is taken into account together with heating during the reaction.

Accordingly, a method involving dissolution using a calcium chloride solution of an alcohol has been established as a method using a low temperature and general purpose raw materials. For example, PTL 3 discloses a method that involves using a methanol solution of calcium chloride to treat a polyamide fabric coated with a coating resin and thereby dissolve polyamide, and subsequently diluting the solution with a large amount of water or methanol to obtain a target polyamide as a powder.

However, actual use of the method described in PTL 3 for dissolution of resin-coated polyamide base fabrics has revealed that there is a problem with this method. PTL 3 discloses that it is preferable to use calcium chloride dihydrate having high polyamide solubility or to add a hydrate-equivalent amount of water in addition to anhydrous calcium chloride, and the reason for this is the high polyamide solubility with such a composition.

However, when we actually attempted dissolution using a polyamide base fabric, it became clear that there is an issue in terms of low recovery rate. Even when we attempted to dissolve approximately 23% of polyamide, which corresponds to the saturation solubility with the aforementioned solvent composition, it was not possible to completely dissolve and recover the polyamide because when a base fabric has a certain amount of area, sticking together of base fabric pieces or rolling up of the base fabric occurs. There was also supernatant clouding after dissolution, and thus although the supernatant had a fluid state, this state could not easily be referred to as “dissolved”. Although a method of pulverizing a base fabric in advance may be adopted with the aim of increasing the yield, fine coating resin fragments are dispersed in liquid when such pulverization is performed and are extremely difficult to recover from the solution.

An object of aspect (VII) of the present disclosure is to provide a method of producing recycled polyamide efficiently and with high yield from a polyamide base fabric coated with urethane.

### Solution to Problem

In relation to aspect (I) of the present disclosure, we conducted diligent studies through a different approach to the conventional techniques and unexpectedly found that the solution composition at the time of dissolution has at least as much influence on porosity as the composition at the time of precipitation. We discovered that by setting the solution composition at the time of dissolution within a prescribed range, it is possible to suppress porosity of polyamide powder and to remarkably reduce the amount of solvent that is contained during precipitation, thus leading to completion of the present disclosure.

Specifically, aspect (I) of the present disclosure provides the following.

[1]

A method of producing powdered polyamide comprising:
step 1: a step of heating and dissolving a polyamide resin composition in a metal chloride alcohol solution containing a metal chloride and an alcohol to obtain a polyamide thermal dissolution liquid;
step 2: a step of diluting the polyamide thermal dissolution liquid with an alcohol to obtain an alcohol dilution; and
step 3: a step of cooling the alcohol dilution to cause precipitation of powdered polyamide, wherein
a mass proportion of metal chloride relative to 100 mass % of the metal chloride alcohol solution in the step 1 is not less than 23 mass % and not more than 35 mass %, the polyamide thermal dissolution liquid contains not less than 0.2 mol and not more than 2.5 mol of water relative to 1 mol of metal chloride in the step 1, and the polyamide thermal dissolution liquid is diluted without dropping below a temperature of 50° C. in the step 2.
   [2]

A method of producing powdered polyamide comprising:
step 1: a step of heating and dissolving a polyamide resin composition in a metal chloride alcohol solution containing a metal chloride and an alcohol to obtain a polyamide thermal dissolution liquid;
step 2: a step of diluting the polyamide thermal dissolution liquid with an alcohol to obtain an alcohol dilution; and
step 3: a step of cooling the alcohol dilution to cause precipitation of powdered polyamide, wherein
a mass proportion of metal chloride relative to 100 mass % of the metal chloride alcohol solution in the step 1 is not less than 23 mass % and not more than 35 mass %, the polyamide thermal dissolution liquid contains not less than 0.2 mol and not more than 2.5 mol of water relative to 1 mol of metal chloride in the step 1, and mass of polyamide that precipitates in the step 2 is 1 mass % or less relative to total mass of polyamide contained in the polyamide thermal dissolution liquid.
   [3]

A method of producing recycled polyamide using a polyamide resin composition that contains polyamide coated with a silicone resin as a raw material, the method comprising a dissolution step of mixing a metal chloride alcohol solution containing a metal chloride and an alcohol with the polyamide resin composition to dissolve the polyamide and obtain a polyamide dissolution liquid, wherein
a mass proportion of polyamide in the polyamide dissolution liquid in the dissolution step is 5 mass % to 15 mass %.
   [4]

A methanol composition comprising: a metal chloride in a concentration of 5% to 25%; a hydroxide of the same metal as the metal chloride in a concentration of 0.001% to 1%; and water in a concentration of 0.001% to 5%.

[5]

A method of producing polyamide by recovering polyamide from a mixed material containing at least polyamide and polyethylene terephthalate, the method comprising:
a step of mixing the mixed material with a metal chloride alcohol solution containing a metal chloride and an alcohol to obtain a polyamide dissolution liquid in which the polyamide has dissolved; and
a step of separating and recovering the polyamide dissolution liquid.
   [6]

A method of producing recycled polyamide using a mixture that contains polyamide coated with a urethane resin as a raw material, the method comprising a dissolution step of mixing a metal chloride alcohol solution containing a metal chloride and an alcohol with the mixture to dissolve the polyamide and obtain a polyamide dissolution liquid, wherein
a mass proportion of polyamide in the polyamide dissolution liquid in the dissolution step is 5 mass % to 15 mass %.
   [7]

The method of producing powdered polyamide according to [1] or [2], further comprising
step 4: a step of washing the powdered polyamide obtained in the step 3 at least once using a solvent.
   [8]

The method of producing powdered polyamide according to [7], wherein a solvent used in a first washing in the step 4 is the same alcohol as the alcohol that is used in the step 1.

[9]

The method of producing powdered polyamide according to [1] or [2], wherein a temperature of the heating and dissolving of the step 1 is not lower than 60° C. and not higher than 80° C.

[10]

The method of producing powdered polyamide according to [1] or [2], further comprising
step 5: a step of heating the powdered polyamide that has precipitated in the step 3 to obtain a heated powdered polyamide.
   [11]

The method of producing powdered polyamide according to [10], further comprising, after the step 5,
step 6: a step of performing solid-liquid separation of the heated powdered polyamide obtained in the step 5 and washing a solid obtained thereby.
   [12]

The method of producing powdered polyamide according to [1] or [2], wherein the polyamide resin composition is a polyamide resin composition that contains polyamide coated with a silicone resin, and a concentration of polyamide in the polyamide thermal dissolution liquid in the step 1 is 5 mass % to 15 mass %.

[13]

The method of producing powdered polyamide according to [1] or [2], wherein the polyamide resin composition is a polyamide resin composition that contains polyamide coated with a silicone resin, and viscosity at 25° C. of the polyamide thermal dissolution liquid in the step 1 is 10 mPa·s to 20,000 mPa·s. [14]

A metal chloride alcohol solution comprising: a metal chloride in a concentration of not less than 23 mass % and not more than 35 mass %; a hydroxide of the same metal as a metal included in the metal chloride in a concentration of 0.001 mass % to 1 mass %; and water in a concentration of 0.001 mass % to 10 mass %.
[15]

The method of producing powdered polyamide according to [1] or [2], wherein the metal chloride alcohol solution is a metal chloride alcohol solution that contains a metal chloride in a concentration of not less than 23 mass % and not more than 35 mass %, a hydroxide of the same metal as a metal included in the metal chloride in a concentration of 0.001 mass % to 1 mass %, and water in a concentration of 0.001 mass % to 10 mass %.

[16]

The method of producing powdered polyamide according to [1] or [2], wherein the method is a method of producing powdered polyamide containing 0.001 ppm to 1,500 ppm of calcium atoms and having a halogen atom molar content of less than 1 relative to calcium atom molar content.

[17]

The method of producing powdered polyamide according to [1] or [2], wherein the polyamide resin composition contains at least polyamide and polyethylene terephthalate.

[18]

The method of producing powdered polyamide according to [1] or [2], wherein the polyamide resin composition contains polyamide coated with a urethane resin.

[19]

The method of producing powdered polyamide according to [1] or [2], comprising, after the steps 1 to 3:
step 7: a step of recovering powdered polyamide that has precipitated;
step 8: a washing step of washing the powdered polyamide that has been recovered; and
step 9: a drying step of thermally drying the powdered polyamide that is present after the washing, wherein
an amount of metal chloride that is attached to the powdered polyamide that is present after the thermal drying of the step 9 is 20 parts by mass or less relative to 100 parts by mass of the powdered polyamide.

Moreover, in relation to aspect (II) of the present disclosure, the inventors conducted various studies relating to methods of reducing the amount of solvent contained in precipitated polyamide with the aim of reducing the amount of washing liquid, and, as a result of this diligent research, discovered that by performing heat treatment of polyamide that has precipitated from a calcium chloride methanol solution, it is possible to modify the precipitated polyamide, and thus completed aspect (II) of the present disclosure. In aspect (II) of the present disclosure, the amount of liquid required for washing can be reduced due to the small amount of solvent that is contained in the precipitated polyamide at the time of washing.

Specifically, aspect (II) of the present disclosure provides the following.

[1]A method of producing recycled polyamide comprising:
(i) a step of dissolving polyamide in a calcium chloride methanol solution to obtain a solution containing dissolved polyamide;
(ii) a step of causing precipitation of the dissolved polyamide from the solution containing the dissolved polyamide to obtain precipitated polyamide;
(iii) a step of heating the precipitated polyamide to obtain heated polyamide; and
(iv) a step of washing the heated polyamide with a washing liquid to obtain recycled polyamide.

[2] The production method according to [1], wherein the precipitated polyamide is heated in the step (iii) while in the solution from precipitation in the step (ii).

[3] The production method according to [1], wherein heating of polyamide in the step (iii) is performed after the precipitated polyamide is separated from the solution in the precipitation to obtain solid content containing polyamide and the solid content that is obtained is washed with an additional washing liquid in the step (ii).

[4] The production method according to any one of [1] to [3], wherein the recycled polyamide has a powdered form.

[5] The production method according to [1], wherein the polyamide is poly(hexamethylene adipamide).

[6] The production method according to any one of [1] to [5], wherein, in the step (ii), a poor solvent is added to the solution containing the dissolved polyamide, and the dissolved polyamide is subsequently caused to precipitate from the solution to obtain the precipitated polyamide.

[7] The production method according to any one of [1] to [5], wherein, in the step (ii), the dissolved polyamide is caused to precipitate from the solution to obtain the precipitated polyamide without adding an additional solvent to the solution containing the dissolved polyamide.

[8] The production method according to any one of [1] to [7], wherein the washing liquid in the step (iv) is water.

[9] The production method according to any one of [3] to [8], wherein the additional washing liquid in the step (ii) is methanol.

Furthermore, in relation to aspect (III) of the present disclosure, the inventors diligently studied methods of recovering polyamide using a calcium chloride methanol solution, and, as a result of these studies, discovered that an increase of viscosity due to polyamide dissolution acts as a cause of reduced recovery efficiency. Consequently, the inventors found that treatment with a composition giving highest solubility does not necessarily correspond to a liquid composition resulting in high-yield recovery of polyamide (for example, nylon 66). Upon investigation of the dissolution composition, the inventors found metal chlorides that can be used other than calcium chloride and also found that the yield of recycled polyamide is increased by controlling the polyamide or solution viscosity of a polyamide solution present after dissolution, thus leading to completion of the present disclosure.

Specifically, aspect (III) of the present disclosure provides the following.

[1]

A method of producing recycled polyamide using a polyamide resin composition that contains polyamide coated with a silicone resin as a raw material, the method comprising a dissolution step of mixing a metal chloride alcohol solution containing a metal chloride and an alcohol with the polyamide resin composition to dissolve the polyamide and obtain a polyamide dissolution liquid, wherein
a mass proportion of polyamide in the polyamide dissolution liquid in the dissolution step is 5 mass % to 15 mass %.
   [2]

A method of producing recycled polyamide using a polyamide resin composition that contains polyamide coated with a silicone resin as a raw material, the method comprising a dissolution step of mixing a metal chloride alcohol solution containing a metal chloride and an alcohol with the polyamide resin composition to dissolve the polyamide and obtain a polyamide dissolution liquid, wherein
viscosity at 25° C. of the polyamide dissolution liquid in the dissolution step is 10 mPa·s to 20,000 mPa·s.
   [3]

The production method according to [1] or [2], wherein a temperature at which the polyamide resin composition and the metal chloride alcohol solution are mixed in the dissolution step is 30° C. to 90° C.

[4]

The production method according to any one of [1] to [3], wherein the polyamide is an aliphatic polyamide.

[5]

The production method according to any one of [1] to [4], wherein the metal chloride is zinc chloride or calcium chloride.

[6]

The production method according to [5], wherein the metal chloride is calcium chloride.

[7]

The production method according to any one of [1] to [6], wherein the alcohol is methanol.

[8]

The production method according to any one of [1] to [7], wherein the polyamide is nylon 66.

[9]

The production method according to any one of [1] to [8], wherein the metal chloride alcohol solution is a solution produced by separating polyamide from a metal chloride alcohol solution having polyamide dissolved therein from a polyamide base fabric.

[10]

The production method according to [9], wherein the metal chloride alcohol solution is a solution that has been concentrated after separation of polyamide.

Also, in relation to aspect (IV) of the present disclosure, the inventors diligently studied methods of suppressing corrosion of metal (for example, metal serving as a material of dissolution equipment) caused by a metal chloride alcohol solution such as a calcium chloride methanol solution. The mechanism of metal corrosion by a metal chloride such as calcium chloride is through destabilization of an inactive state by chloride ions, and this is typically suppressed by raising the pH. Although one might easily conceive of adding a basic compound that is soluble in methanol in order to raise the pH in light of the above, the addition of sodium hydroxide as a base that is soluble in methanol, for example, causes a reaction to occur between chloride ions and sodium hydroxide, resulting in sedimentation of produced sodium chloride since sodium chloride does not dissolve in methanol. Such sodium chloride particles should be avoided because their poor compatibility with the solvent means that they readily remain in crevices or the like of an apparatus, create a localized rise of chloride ion concentration, and readily cause crevice corrosion. Moreover, polyamide solubility also decreases because there is an overall decrease of the concentration of metal chloride such as calcium chloride. As a result of investigating various types of bases with such viewpoints in mind, the inventors discovered that corrosiveness can be significantly reduced without reduction of polyamide solubility in a situation in which a hydroxide of the same metal as a metal of the metal chloride such as calcium hydroxide (hereinafter, referred to as a “hydroxide of the same metal”) is added, and thus completed aspect (IV) of the present disclosure.

Specifically, aspect (IV) of the present disclosure provides the following.

[1]

A methanol composition comprising: a metal chloride in a concentration of 5% to 25%; a hydroxide of the same metal as the metal chloride in a concentration of 0.001% to 1%; and water in a concentration of 0.001% to 5%.

[2]

The methanol composition according to [1], further comprising polyamide dissolved in the methanol composition with the methanol composition as a solvent.

[3]

The methanol composition according to [1] or [2], wherein the metal chloride is zinc chloride, and the hydroxide of the same metal is zinc hydroxide.

[4]

The methanol composition according to [1] or [2], wherein the metal chloride is calcium chloride, and the hydroxide of the same metal is calcium hydroxide.

[5]

A method of producing a polyamide composition comprising: a step of dissolving a raw material polyamide composition in a solvent to obtain a polyamide solution; and a step of separating polyamide from the polyamide solution that is obtained, wherein the solvent in which the raw material polyamide composition is dissolved is the methanol composition according to [1] or [2].

[6]

The production method according to [5], wherein the polyamide composition contains poly(hexamethylene adipamide).

[7]

A polyamide composition obtained by the method according to [5], comprising 0.001 ppm to 1,000 ppm of metal atoms and having a halogen atom molar content of less than 2 relative to metal atom molar content.

[8]

The polyamide composition according to [7], comprising 0.001 ppm to 1,000 ppm of metal atoms and having a halogen atom molar content of less than 1 relative to metal atom molar content.

[9]

The polyamide composition according to [7], wherein the metal atoms are zinc atoms or calcium atoms.

[10]

The polyamide composition according to [7], further comprising poly(hexamethylene adipamide).

[11]

A powder comprising the polyamide composition according to [7].

Moreover, in relation to aspect (V) of the present disclosure, the inventors diligently conducted extensive studies and, as a result, discovered that in a process in which a polyamide resin composition is heated and dissolved in a metal chloride alcohol solution containing a metal chloride and an alcohol to obtain a polyamide thermal dissolution liquid, polyamide is subsequently caused to precipitate from the polyamide thermal dissolution liquid and is recovered, and the recovered polyamide is subsequently further subjected to washing and drying, controlling the amount of metal chloride that is attached to polyamide after thermal drying to 20 parts by mass or less relative to 100 parts by mass of the polyamide makes it possible to suppress sticking together of the recovered polyamide without performing excessive washing, thereby leading to completion of aspect (V) of the present disclosure.

Aspect (V) of the present disclosure is based on the finding described above and the essence thereof is as follows.

{1} A method of producing polyamide comprising:
step 1: a dissolution step of heating and dissolving a polyamide resin composition in a metal chloride alcohol solution containing a metal chloride and an alcohol to obtain a polyamide thermal dissolution liquid;
step 2: a recovery step of causing precipitation of polyamide from the polyamide thermal dissolution liquid and recovering the polyamide;
step 3: a washing step of washing the polyamide that has been recovered; and
step 4: a drying step of thermally drying the polyamide present after the washing, wherein
an amount of metal chloride attached to the polyamide present after the thermal drying of the step 4 is 20 parts by mass or less relative to 100 parts by mass of the polyamide.
{2} The method of producing polyamide according to the foregoing {1}, wherein the washing step is a control step of controlling an amount of metal chloride after the thermal drying.
{3} The method of producing polyamide according to the foregoing {1} or {2}, wherein a temperature of the heating and dissolving of the step 1 is 30° C. to 90° C.
{4} The method of producing polyamide according to any one of the foregoing {1} to {3}, wherein polyamide concentration in the polyamide thermal dissolution liquid is 5 mass % to 15 mass %.
{5} The method of producing polyamide according to any one of the foregoing {1} to {4}, wherein the metal chloride is zinc chloride or calcium chloride.
{6} The method of producing polyamide according to any one of the foregoing {1} to {5}, further comprising a confirmation step of measuring an amount of metal chloride that is attached to the polyamide and confirming whether or not the amount is within a range.
{7} The method of producing polyamide according to the foregoing {6}, wherein the confirmation step is implemented by sampling a portion of washed polyamide present after the washing of the step 3.
{8} The method of producing polyamide according to the foregoing {6}, wherein the step of confirming whether or not the amount of metal chloride that is attached to the polyamide is within a range is implemented by sampling a portion of the polyamide present after the thermal drying of the step 4.
{9} The method of producing polyamide according to any one of the foregoing {6} to {8}, wherein a second washing step of washing polyamide once again is implemented in a case in which the amount of metal chloride that is attached to the polyamide is more than 20 parts by mass relative to 100 parts by mass of the polyamide.

Furthermore, in relation to aspect (VI) of the present disclosure, the inventors discovered that by mixing a mixed material of polyamide and polyethylene terephthalate with a metal chloride alcohol solution containing a metal chloride and an alcohol, and by causing dissolution and separation of the polyamide, it is possible to recover the polyamide and/or polyethylene terephthalate from the mixed material, and it is also possible to increase the efficiency and yield during separation and recovery, thus leading to completion of aspect (VI) of the present disclosure.

Aspect (VI) of the present disclosure is based on the finding described above and the essence thereof is as follows.
{1} A method of producing polyamide by recovering polyamide from a mixed material containing at least polyamide and polyethylene terephthalate, the method comprising:
a step of mixing the mixed material with a metal chloride alcohol solution containing a metal chloride and an alcohol to obtain a polyamide dissolution liquid in which the polyamide has dissolved; and
a step of separating and recovering the polyamide dissolution liquid.
{2} A method of producing polyethylene terephthalate by recovering polyethylene terephthalate from a mixed material containing at least polyamide and polyethylene terephthalate, the method comprising:
a step of mixing the mixed material with a metal chloride alcohol solution containing a metal chloride and an alcohol to obtain a polyamide dissolution liquid in which at least the polyamide has dissolved; and
a step of separating and recovering the polyethylene terephthalate.
{3} A method of producing polyamide and polyethylene terephthalate by recovering polyamide and polyethylene terephthalate from a mixed material of polyamide and polyethylene terephthalate, the method comprising:
a step of mixing the mixed material with a metal chloride alcohol solution containing a metal chloride and an alcohol to obtain a polyamide dissolution liquid in which the polyamide has dissolved; and
a step of separating and recovering the polyamide dissolution liquid and the polyethylene terephthalate.
{4} The production method according to {1}, {2}, or {3}, wherein the mixed material is a woven fabric.
{5} The production method according to the foregoing {4}, wherein the woven fabric is an airbag member.
{6} The production method according to any one of the foregoing {1} to {5}, wherein a temperature during mixing of the mixed material and the metal chloride alcohol solution is 30° C. to 90° C.
{7} The production method according to any one of the foregoing {1} to {6}, wherein the metal chloride is zinc chloride or calcium chloride.

Also, in relation to aspect (VII) of the present disclosure, the inventors diligently studied methods of recovering polyamide using a calcium chloride methanol solution, and, as a result of these studies, discovered that an increase of viscosity due to polyamide dissolution acts as a cause of reduced recovery efficiency. Consequently, the inventors found that treatment with a composition giving highest solubility does not necessarily correspond to a liquid composition resulting in high-yield recovery of polyamide (for example, nylon 66). Upon investigation of the dissolution composition, the inventors found metal chlorides that can be used other than calcium chloride and also found that the yield of recycled polyamide is increased by controlling the polyamide or solution viscosity of a polyamide solution present after dissolution, thus leading to completion of aspect (VII) of the present disclosure.

Specifically, aspect (VII) of the present disclosure provides the following.

[1]

A method of producing recycled polyamide using a mixture that contains polyamide coated with a urethane resin as a raw material, the method comprising a dissolution step of mixing a metal chloride alcohol solution containing a metal chloride and an alcohol with the mixture to dissolve the polyamide and obtain a polyamide dissolution liquid, wherein
a mass proportion of polyamide in the polyamide dissolution liquid in the dissolution step is 5 mass % to 15 mass %.
   [2]

A method of producing recycled polyamide using a mixture that contains polyamide coated with a urethane resin as a raw material, the method comprising a dissolution step of mixing a metal chloride alcohol solution containing a metal chloride and an alcohol with the mixture to dissolve the polyamide and obtain a polyamide dissolution liquid, wherein
viscosity at 25° C. of the polyamide dissolution liquid in the dissolution step is 10 mPa·s to 20,000 mPa·s.
   [3]

The production method according to [1] or [2], wherein a temperature at which the mixture and the metal chloride alcohol solution are mixed in the dissolution step is 30° C. to 90° C.

[4]

The production method according to any one of [1] to [3], wherein the polyamide is an aliphatic polyamide.

[5]

The production method according to any one of [1] to [4], wherein the metal chloride is zinc chloride or calcium chloride.

[6]

The production method according to [5], wherein the metal chloride is calcium chloride.

[7]

The production method according to any one of [1] to [6], wherein the alcohol is methanol.

[8]

The production method according to any one of [1] to [7], wherein the polyamide is nylon 66.

[9]

The production method according to any one of [1] to [8], wherein the metal chloride alcohol solution is a solution produced by separating polyamide from a metal chloride alcohol solution having polyamide dissolved therein from a polyamide base fabric.

[10]

The production method according to [9], wherein the metal chloride alcohol solution is a solution that has been concentrated after separation of polyamide.

### Advantageous Effect

According to aspect (I) of the present disclosure, it is possible to efficiently produce powdered polyamide.

In relation to aspect (I) of the present disclosure, it is possible to provide a method of producing powdered polyamide that suppresses porosity and that also generates little waste liquid and has low energy requirement for drying as a result of reducing the amount of contained solvent. Moreover, it is preferably possible to provide a method of producing powdered polyamide having a large particle diameter and a small particle size distribution in a short time.

In relation to aspect (II) of the present disclosure, it is possible to provide a method of producing recycled polyamide with a reduced amount of waste liquid according to aspect (II) of the present disclosure.

In relation to aspect (III) of the present disclosure, it is possible to provide a method of producing recycled polyamide efficiently and with high yield from a polyamide base fabric that is coated with silicone according to aspect (III) of the present disclosure.

In relation to aspect (IV) of the present disclosure, it is possible to provide a solvent that has low corrosiveness and that is capable of dissolving polyamide according to aspect (IV) of the present disclosure.

In relation to aspect (V) of the present disclosure, it is possible to provide a method of producing polyamide that enables recovery of polyamide with high efficiency and high yield and that can also yield high quality polyamide without performing excessive washing according to aspect (V) of the present disclosure.

In relation to aspect (VI) of the present disclosure, it is possible to provide a method of producing polyamide, a method of producing polyethylene terephthalate, and a method of producing polyamide and polyethylene terephthalate that enable recovery of polyamide and/or polyethylene terephthalate from a mixed material of polyamide and polyethylene terephthalate with high efficiency and high yield according to aspect (VI) of the present disclosure.

In relation to aspect (VII) of the present disclosure, it is possible to provide a method of producing recycled polyamide efficiently and with high yield from a polyamide base fabric that is coated with urethane according to aspect (VII) of the present disclosure.

### DETAILED DESCRIPTION

The following provides a detailed description of embodiments of the present disclosure (hereinafter, also referred to simply as “present embodiments”).

### [Aspect (I)]

The following describes aspect (I) of the present disclosure. Conditions of aspects (II) to (VII) of the present disclosure may be incorporated into aspect (I) of the present disclosure as appropriate.

A method of producing powdered polyamide of a present embodiment (I) includes: a step (step 1) of heating and dissolving a polyamide resin composition in a metal chloride alcohol solution containing a metal chloride and an alcohol to obtain a polyamide thermal dissolution liquid; a step (step 2) of diluting the polyamide thermal dissolution liquid with an alcohol to obtain an alcohol dilution; and a step (step 3) of cooling the alcohol dilution to cause precipitation of powdered polyamide, wherein a mass proportion of metal chloride relative to 100 mass % of the metal chloride alcohol solution in step 1 is not less than 23 mass % and not more than 35 mass %, the polyamide thermal dissolution liquid contains not less than 0.2 mol and not more than 2.5 mol of water relative to 1 mol of metal chloride in step 1, and the polyamide thermal dissolution liquid is diluted without dropping below a temperature of 50° C. in step 2.

Moreover, a method of producing powdered polyamide of another present embodiment (I) includes: a step (step 1) of heating and dissolving a polyamide resin composition in a metal chloride alcohol solution containing a metal chloride and an alcohol to obtain a polyamide thermal dissolution liquid; a step (step 2) of diluting the polyamide thermal dissolution liquid with an alcohol to obtain an alcohol dilution; and a step (step 3) of cooling the alcohol dilution to cause precipitation of powdered polyamide, wherein a mass proportion of metal chloride relative to 100 mass % of the metal chloride alcohol solution in step 1 is not less than 23 mass % and not more than 35 mass %, the polyamide thermal dissolution liquid contains not less than 0.2 mol and not more than 2.5 mol of water relative to 1 mol of metal chloride in step 1, and mass of polyamide that precipitates in step 2 is 1 mass % or less relative to total mass of polyamide contained in the polyamide thermal dissolution liquid.

The production method of the present embodiment may be a method that is composed of just steps 1 to 3 or may further include other steps.

The following describes compounds, etc. that are used in the production method of the present embodiment.

### <Polyamide>

The polyamide can be a polymer that has been polymerized through amide bonds such as a polymer that has been obtained through polycondensation of a diamine compound and a dicarboxylic acid compound or a polymer that has been obtained through ring-opening polymerization of a cyclic lactam.

The diamine compound may be ethylenediamine, trimethylenediamine, tetramethylenediamine, pentamethylenediamine, hexamethylenediamine, nonanediamine, methylpentanediamine, p-phenylenediamine, or the like without any specific limitations.

The dicarboxylic acid compound may be oxalic acid, malonic acid, succinic acid, glutaric acid, adipic acid, sebacic acid, terephthalic acid, isophthalic acid, or the like without any specific limitations.

The cyclic lactam may be ε-caprolactam, undecanelactam, lauryl lactam, or the like without any specific limitations.

No specific limitations are placed on combinations of the diamine compound, the dicarboxylic acid compound, and the cyclic lactam compound described above, and each of these compounds may be a plurality of types of compounds that are used together. Poly(hexamethylene adipamide), which is formed from hexamethylenediamine and adipic acid, has high solubility and is suitable for a powder formation process.

No specific limitations are placed on the method by which the particle diameter and particle size distribution of powdered polyamide are measured, and methods such as laser diffraction, laser scattering, centrifugal sedimentation, particle tracking, and dynamic light scattering may be adopted.

### <Polyamide Resin Composition>

The polyamide resin composition may have additives added thereto with the aim of effects that are expressed during use in a final application or during processing. Examples of additives that may be used include heat stabilizers, pigments, dyes, and plasticizers, but are not limited thereto. Each of these additives may be an inorganic salt or may be an organic compound.

The polyamide resin composition may contain polyamide coated with a resin other than polyamide. The coating resin may be a polyolefin-based resin, polyurethane, an acrylic resin, a silicone resin, an RFL (resorcinol formalin latex) adhesive, or the like without any limitations. From a viewpoint of separability, the inclusion of polyamide coated with a silicone resin is preferable. The polyamide resin composition may be a composition that is composed of only polyamide coated with a silicone resin or may further contain other components.

In particular, from a viewpoint of production efficiency of powdered polyamide, the mass proportion of polyamide coated with a silicone resin is preferably 30 mass % to 100 mass %, more preferably 60 mass % or more, even more preferably 70 mass % or more, and particularly preferably 80 mass % or more relative to 100 mass % of the polyamide resin composition.

The silicone resin may be a methyl silicone or phenyl silicone resin, for example, without any specific limitations. Moreover, the silicone resin may be a mixture of these resins or may be a product obtained through mixing and curing of respective raw materials thereof.

The polyamide coated with the silicone resin may have another coating in addition to the silicone resin. The type of other coating may be polyethylene, polypropylene, polyester, fluororesin, or the like without any specific limitations. A coating that does not dissolve in the metal chloride alcohol solution used in dissolution is preferable.

The polyamide coated with the silicone resin may be a raw material for polyamide recycling. For example, the silicone resin-coated polyamide may be process offcuts or waste material of a shaped item such as an automotive component or an electrical product component or of fibers in which polyamide is used as a raw material. More specifically, the silicone resin-coated polyamide may be process offcuts or waste material of clothes, airbags, tire cords, components from inside an engine compartment, an intake system, or a fuel system, connectors, fishing nets, or UD tape.

No specific limitations are placed on the composition of the RFL adhesive, and it may be an RFL adhesive that is typically used to adhere polyamide fibers and rubber used in tire cords.

The polyamide coated with polyurethane or an acrylic resin may be a base fabric used in clothing or the like, and no specific limitations are placed on the type of polyurethane or acrylic resin.

The polyamide resin composition may contain sewing thread. Although no specific limitations are placed on the material of the sewing thread, it is preferable for the sewing thread to be the same polyamide as the base fabric because this enables recovery thereof as recycled polyamide.

The polyamide resin composition may be composed of just the polyamide or may contain the polyamide and other components. For example, an impurity such as another resin or a metal may be mixed, attached, or applied as another component with respect to the polyamide.

From a viewpoint of polyamide recovery rate, the mass proportion of the polyamide relative to 100 mass % of the polyamide resin composition is preferably 30 mass % to 100 mass %, more preferably 70 mass % or more, even more preferably 80 mass % or more, further preferably 85 mass % or more, and particularly preferably 100 mass %.

In a case in which impurities other than the polyamide are included, the method may include a step of separating the polyamide and these impurities. No specific limitations are placed on the method of separation, but in a situation in which the impurities are insoluble in a state in which the polyamide resin composition has dissolved, separation can be performed by a method such as filtration, centrifugation, or sedimentation. In a situation in which the impurities dissolve in a solvent together with the polyamide, separation may be performed in a dissolved state by extraction, membrane separation, electrodialysis, or the like, or separation may be performed by washing after precipitation of polyamide in the subsequently described precipitation step.

The polyamide resin composition may contain at least polyamide and polyethylene terephthalate. In addition, the polyamide resin composition may contain other components.

Examples of other components include a component that coats a mixed material of polyamide and polyethylene terephthalate and a component that is applied onto the mixed material. The coating component may be a resin, and examples thereof include a silicone resin and a urethane resin. The applied component may be a lubricant or the like.

With regards to the form of the above-described polyamide resin composition containing polyamide and polyethylene terephthalate, it is preferable that the polyamide resin composition is a woven fabric (from a water jet loom, an air jet loom, a rapier loom, a base fabric for an airbag, or the like), and more preferable that the polyamide resin composition is an airbag member in terms that the effects according to the present disclosure can be received to a greater extent. In the case of a high-density woven fabric such as a base fabric for an airbag, it is difficult to achieve adequate separation by a conventional separation method because fibers formed of polyamide and fibers formed of polyethylene terephthalate are entangled with one another. In contrast, dissolution and separation of polyamide in the present embodiment enable recovery of polyamide and/or polyethylene terephthalate from a mixed material containing polyamide and polyethylene terephthalate and enable recovery of polyamide and/or polyethylene terephthalate with high efficiency and high yield even in the case of a woven fabric.

The polyethylene terephthalate (PET) may be a resin having a structure illustrated below.

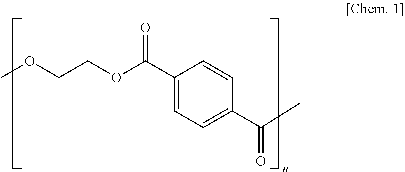

The polyethylene terephthalate may be composed of just polyethylene terephthalate or may be a polyethylene terephthalate resin composition that contains the polyethylene terephthalate and other components. For example, an impurity such as another resin or a metal may be mixed, attached, or applied as another component with respect to the polyethylene terephthalate.

The polyethylene terephthalate may be contained in the polyamide resin composition as fibrous PET. The fibrous PET can be obtained by further performing solid phase polymerization and spinning of a PET resin.

Note that since polyethylene terephthalate is insoluble in the subsequently described metal chloride alcohol solution, it is possible to melt and separate just the polyamide in step 1. Therefore, by simply mixing the polyamide resin composition containing the polyamide and the polyethylene terephthalate with a specific metal chloride alcohol solution, it is possible to separate the polyamide and the polyethylene terephthalate and to recover the polyamide efficiently and with high yield.

The polyethylene terephthalate can be recovered by separating polyethylene terephthalate that remains without dissolving. The method by which the polyethylene terephthalate is separated and recovered can be by removing polyethylene terephthalate that remains without dissolving in the polyamide thermal dissolution liquid by a means such as filtration.

It is preferable for the polyamide resin composition to contain polyamide coated with a urethane resin.

From a viewpoint of production efficiency of powdered polyamide, the mass proportion of polyamide coated with a urethane resin is preferably 30 mass % to 100 mass %, more preferably 60 mass % or more, even more preferably 70 mass % or more, and particularly preferably 80 mass % or more relative to 100 mass % of the polyamide resin composition.

The polyurethane resin is obtained through a reaction between a polyol component and a polyisocyanate component. The polyol component may be a polycarbonate polyol, a polyester polyol, a polyether polyol, or the like.

The urethane resin may be a polyester-based polyurethane resin, a polyether-based polyurethane resin, a polycarbonate-based polyurethane resin, or the like without any specific limitations. A crosslinker formed of an epoxy, melamine, polyfunctional isocyanate, or the like, a carbodiimide-based hydrolysis inhibitor, a phenol or aromatic amine antioxidant, an ultraviolet absorber such as a salicylic acid-based, benzophenone-based, or benzotriazole-based derivative, or a flame retardant such as thiourea may be added to the urethane resin.

The polyamide coated with the urethane resin may have another coating in addition to the urethane resin. The type of other coating may be polyethylene, polypropylene, polyester, fluororesin, silicone resin, or the like without any specific limitations. A coating that does not dissolve in the metal chloride alcohol solution used in dissolution is preferable. It is preferable that a silicone resin is not included in the coating resin.

The polyamide coated with the urethane resin may be a raw material for polyamide recycling. For example, the urethane resin-coated polyamide may be process offcuts or waste material of a shaped item such as an automotive component or an electrical product component or of fibers in which polyamide is used as a raw material. More specifically, the urethane resin-coated polyamide may be process offcuts or waste material of clothes, airbags, tire cords, components from inside an engine compartment, an intake system, or a fuel system, connectors, fishing nets, or UD tape.

Examples of methods by which the urethane resin may be separated include a method in which the urethane resin is scooped up from a dissolved layer and also methods such as filtration, centrifugation, and sedimentation.

These methods may be used in combination. Since fine fragments of the urethane resin may arise during heating and dissolving of the polyamide, it is preferable that the fine fragments are removed by filtration or a method in which filtration is incorporated.

Other coating material of the polyamide coated with the urethane resin is preferably removed at the same time as the urethane resin.

The urethane resin and other coating material that have been separated have polyamide-containing solution attached thereto. Therefore, it is preferable to wash the urethane resin and other coating material in order to recover the polyamide-containing solution. The solvent used in this washing is not specifically limited but is preferably a calcium chloride methanol solution. The washing method may be stirred washing inside of a tank-type reactor, flow washing in a filter, or the like without any specific limitations.

### <Metal Chloride Alcohol Solution>

The metal chloride alcohol solution contains a metal chloride and an alcohol, and may further contain a hydroxide of the same metal as the metal chloride and other components.

In particular, from a viewpoint of polyamide solubility, the total mass proportion of the metal chloride and the alcohol relative to 100 mass % of the metal chloride alcohol solution is preferably 80 mass % or more, and more preferably 90 mass % or more.

The alcohol may be methanol, ethanol, linear or branched propanol, linear or branched butanol, a combination of any of these alcohols, or the like. In particular, methanol, ethanol, or a combination thereof is preferable from a viewpoint of polyamide solubility, and methanol is more preferable.

The mass proportion of the metal chloride relative to 100 mass % of the metal chloride alcohol solution is preferably 23 mass % to 35 mass %, more preferably 25 mass % to 33 mass %, and particularly preferably 27 mass % to 31 mass %. When this mass proportion is less than 23 mass %, only a small amount of polyamide dissolves, and a large amount of solvent is necessary. Moreover, when this mass proportion is more than 35 mass %, it becomes more likely that metal chloride will remain without dissolving and become mixed in as an impurity.

The metal chloride may be zinc chloride, magnesium chloride, calcium chloride, or the like, is preferably zinc chloride or calcium chloride, and is most preferably calcium chloride.

The metal chloride may be added in an anhydrous form or as a hydrate.

The mass proportion of water in the metal chloride alcohol solution is preferably 30 mass % or less, more preferably 15 mass % or less, and even more preferably 10 mass % or less, and it is particularly preferable that the metal chloride alcohol solution does not contain water.

The metal chloride alcohol solution may be a solution that contains an alcohol, a metal chloride, a hydroxide of the same metal as the metal chloride (also referred to as a “hydroxide of the same metal” in the present specification), and water.

The constituent metal of the hydroxide of the same metal may be zinc (i.e., the metal chloride may be zinc chloride and the hydroxide of the same metal may be zinc hydroxide) or calcium (i.e., the metal chloride may be calcium chloride and the hydroxide of the same metal may be calcium hydroxide), for example, and is preferably calcium.

The concentration of the hydroxide of the same metal is preferably 0.001 mass % to 1 mass %, more preferably 0.001 mass % to 0.1 mass %, and even more preferably 0.001 mass % to 0.01 mass % relative to 100 mass % of the metal chloride alcohol solution. It is not essential for the hydroxide of the same metal to completely dissolve in the alcohol (for example, methanol), and it may be the case that some of the hydroxide of the same metal is not dissolved.

The mass proportion of water relative to 100 mass % of the metal chloride alcohol solution is preferably 0.001 mass % to 10 mass %, more preferably 0.001 mass % to 5 mass %, even more preferably 0.001 mass % to 1 mass %, and particularly preferably 0.01 mass % to 0.1 mass %.

The following describes steps in the production method of the present embodiment.

### <Step 1: Step of Obtaining Polyamide Thermal Dissolution Liquid>

The polyamide resin composition is subjected to dissolution treatment using the metal chloride alcohol solution.

In step 1, the polyamide resin composition and the metal chloride alcohol solution are mixed and also subjected to heating and dissolving.

The temperature in the heating and dissolving is not specifically limited but is preferably 30° C. to 90° C., and more preferably 60° C. to 80° C. Moreover, the temperature may be 40° C. to 60° C. A low temperature results in slow dissolution, whereas a temperature of higher than 90° C. exceeds the boiling point and is undesirable from viewpoints of corrosion and decomposition.

In step 1, the temperature may be constant or may be changed within any of the ranges set forth above.

The dissolution may be performed by a batch process or a continuous process.

In the case of a batch process, it is preferable that stirring is performed, though no specific limitations are placed on the stirring. Stirring improves the rate of dissolution of polyamide.

In the case of a continuous process, the solvent may be caused to continuously flow relative to a solid or the solution may be circulated. Circulation is preferable because the amount of solvent that is used can be reduced.

The shape of a vessel that is used in the heating and dissolving of the polyamide resin composition and the metal chloride alcohol solution is not specifically limited, and any shape of vessel such as a tank-type or circulation-type vessel may be used. Moreover, no specific limitations are placed on the material of such vessels and piping, and SUS316, SUS316L, SUS329J4L, SUS444, or the like may be adopted as the material. Furthermore, the surface of any of these materials may have been treated by lining, coating, or the like, examples of which include glass, fluororesin, rubber, and epoxy, with glass and fluororesin being preferable from a viewpoint of corrosion resistance. Note that in a case in which treatment such as lining or coating has been performed, the material of the vessel and piping itself can be selected without taking into account corrosion.

The heating and dissolving time is not specifically limited but is preferably 5 minutes to 100 hours.

The mass proportion of the polyamide resin composition relative to the metal chloride alcohol solution used in step 1 is not specifically limited but is preferably 5 mass % to 15 mass %, and more preferably 7 mass % to 13 mass %. A mass proportion of less than 5 mass % means that too much solvent is required, whereas a mass proportion of more than 15 mass % results in higher viscosity, longer dissolving time, and poorer operability.

Moreover, the mass proportion of polyamide in the polyamide thermal dissolution liquid is preferably 5 mass % to 15 mass %, and more preferably 7 mass % to 13 mass % for the same reasons as described above.

The molar ratio of water relative to 1 mol of metal chloride in the polyamide thermal dissolution liquid is preferably 0.2 mol to 2.5 mol, more preferably 0.5 mol to 2.0 mol, and even more preferably 1 mol to 1.5 mol from a viewpoint of limiting liquid content in a precipitate obtained through crystallization. Although the principle for this is not clear, the presence of water during dissolution is thought to influence the state of hydrogen bonds of the polyamide in the metal chloride alcohol solution and have a role in adjusting microscopic solubility/dispersibility that cannot be evaluated through the macroscopic dissolution state. A molar ratio of less than 0.2 mol is thought to reduce dispersibility of calcium chloride in the alcohol and make it harder to form interactions with the polyamide, whereas a molar ratio of more than 2.5 mol is thought to make uniform dispersion of the polyamide in the solution more difficult due to the polyamide having low solubility in water.

In a case in which the polyamide resin composition contains polyamide coated with a silicone resin, the mass proportion of polyamide in 100 mass % of the polyamide thermal dissolution liquid is preferably 5 mass % to 15 mass %, and more preferably 7 mass % to 13 mass %. A mass proportion of less than 5 mass % means that too much solvent is required, whereas a mass proportion of more than 15 mass % results in higher viscosity, longer dissolving time, and poorer operability.

In a case in which the polyamide resin composition contains polyamide coated with a silicone resin, the viscosity at 25° C. of the polyamide thermal dissolution liquid is preferably 10 mPa·s to 20,000 mPa·s, more preferably 10 mPa·s to 10,000 mPa·s, and even more preferably 10 mPa·s to 3,000 mPa·s. A higher viscosity means a higher polymer concentration, but reduces the efficiency of polyamide dissolution due to sticking together of base fabric, for example.

In a case in which the polyamide resin composition contains polyamide coated with a silicone resin, no specific limitations are placed on the method by which the silicone resin is separated from the polyamide thermal dissolution liquid, and a method in which the silicone resin is scooped up from a dissolved layer, a method such as filtration, centrifugation, or sedimentation, or a combination of any of these methods may be adopted. Since fine fragments of silicone may arise during heating and dissolving of the polyamide, it is preferable that the fine fragments are removed by filtration or a method in which filtration is incorporated.

Other coating material of the polyamide coated with the silicone resin is preferably removed at the same time as the silicone resin.

The silicone resin and other coating material that have been separated have polyamide-containing solution attached thereto. Therefore, it is preferable to wash the silicone resin and other coating material in order to recover the polyamide-containing solution. The solvent used in this washing is not specifically limited but is preferably a calcium chloride methanol solution. The washing method may be stirred washing inside of a tank-type reactor, flow washing in a filter, or the like without any specific limitations.

It is preferable that the polyamide thermal dissolution liquid obtained in step 1 is consecutively used in step 2.

### <Step 2: Step of Obtaining Alcohol Dilution>

Step 2 is a step of diluting the polyamide thermal dissolution liquid that has been obtained in step 1 with an alcohol.

The alcohol that is used in step 2 may be methanol, ethanol, linear or branched propanol, linear or branched butanol, a combination of any of these alcohols, or the like, and is preferably the same as the alcohol that is contained in the metal chloride alcohol solution from a viewpoint of ease of recovery in a situation in which the solvent is reused.

The method by which the polyamide thermal dissolution liquid is diluted is described in detail below.

The dilution ratio by the alcohol is preferably ×1.5 to ×5. The dilution ratio referred to in the present specification is defined as a value obtained when the mass of the alcohol dilution after dilution is divided by the mass of the polyamide thermal dissolution liquid at the time of dissolution. Note that in a case in which precipitation has occurred in the alcohol dilution present after dilution, the weight inclusive of the precipitate is taken to be the mass of the alcohol dilution after dilution. When the dilution ratio is less than ×1.5, the precipitated amount of polyamide is small, and the particle diameter thereof also decreases due to insufficient particle growth. A dilution ratio of more than ×5 means that precipitation occurs more readily during dilution and results in a wider particle size distribution.

In step 2, it is preferable that the polyamide thermal dissolution liquid is diluted without dropping below a temperature of 50° C. from a viewpoint of limiting liquid content in a precipitate obtained by crystallization. Although the principle for this is not clear, it is thought that by maintaining a high temperature state at the dilution stage, it is possible to avoid sudden precipitation and to maintain uniform precipitate properties from an initial stage of precipitation through to a final stage of precipitation.

The temperature during diluting with the alcohol is not specifically limited but is preferably 30° C. to 90° C. When the diluting is performed at a lower temperature than 30° C., the particle diameter is reduced due to precipitation during dilution. When the diluting is performed at a higher temperature than 90° C., volatilization/condensation of the alcohol near the liquid surface makes non-uniform precipitation more likely and makes it difficult to control the particle size distribution.

The temperature from production of the polyamide thermal dissolution liquid until the alcohol dilution is obtained is preferably within a range of ±10° C. of the previously described temperature of the heating and dissolving in step 1, and more preferably within a range of ±5° C. of that temperature from a viewpoint of obtaining powdered polyamide having an even larger particle diameter and an even small particle size distribution in a short time.

Although no specific limitations are placed on the rate of dilution using the alcohol, it is preferable that the alcohol is added at a rate that does not cause a sudden change of concentration and/or temperature and precipitation of polyamide during dilution.

The amount of polyamide that precipitates during dilution (i.e., the mass of polyamide that precipitates in step 2) is preferably 1 mass % or less, and more preferably less than 1 mass % relative to the total mass of polyamide that is contained in the polyamide thermal dissolution liquid obtained in step 1. Polyamide that has precipitated during dilution and polyamide that precipitates during cooling differ in terms of microscopic separation mechanism during precipitation from the solvent, and an increase of polyamide that precipitates during dilution results in higher liquid content in the precipitate. Moreover, polyamide that precipitates during dilution is particles that are formed in accompaniment to sudden compositional change, and thus the particle diameter thereof cannot be controlled, and particle diameter control in the subsequently described cooling and precipitation stage becomes difficult when a large amount of such particles are present.

The temperature of the alcohol used in the diluting is not specifically limited but is preferably 15° C. to 90° C. A temperature of lower than 15° C. makes localized precipitation during dilution more likely to occur, whereas a temperature of higher than 90° C. necessitates treatment in a pressurized state since the temperature is higher than or close to the boiling point of the alcohol.

The water content of the alcohol that is used in the diluting is not specifically limited but is preferably 0.005 mass % to 50 mass %, and more preferably 0.005 mass % to 1 mass %. A high water content causes sudden precipitation due to an aqueous solution having lower polyamide solubility. The amount of water can be altered within any of the ranges set forth above depending on the polyamide since precipitation properties differ depending on the type of polyamide.

No specific limitations are placed on the method of dilution. The diluting may be performed by a batch process or a continuous process.

In the case of a batch process, it is preferable that stirring is performed, though no specific limitations are placed on the stirring. Stirring results in more uniform temperature and concentration.

The shape of a vessel in which the polyamide thermal dissolution liquid is diluted with the alcohol is not specifically limited, and any shape of vessel such as a tank-type or circulation-type vessel may be used. The same vessel as in step 1 may be used. Moreover, no specific limitations are placed on the material of such vessels and piping, and SUS316, SUS316L, SUS329J4L, SUS444, or the like may be adopted as the material. Furthermore, the surface of any of these materials may have been treated by lining, coating, or the like, examples of which include glass, fluororesin, rubber, and epoxy, with glass and fluororesin being preferable from a viewpoint of corrosion resistance. Note that in a case in which treatment such as lining or coating has been performed, the material of the vessel and piping itself can be selected without taking into account corrosion.

### <Step 3: Step of Precipitating Powdered Polyamide>

Step 3 is a step of cooling the alcohol dilution that has been obtained in step 2 to cause precipitation of polyamide.

Stirring is preferably performed during cooling of the alcohol dilution. Stirring results in more uniform temperature and concentration and facilitates particle diameter control. According to the instrument and method by which stirring is performed, it is preferable that stirring is performed under conditions that tend not to cause fracturing and shearing of particles through stirring.

The cooling rate is not specifically limited but is preferably 10° C./hr to 100° C./hr, more preferably 20° C./hr to 70° C./hr, and even more preferably 40° C./hr to 68° C./hr. A cooling rate of less than 10° C./hr means that cooling takes a longer time, whereas a cooling rate of more than 100° C./hr reduces the particle diameter due to sudden precipitation. The particle diameter can be controlled by altering the cooling rate.

The temperature after cooling is not specifically limited but is preferably at least 10° C. lower than the temperature during dilution. When the temperature difference is less than 10° C., little precipitation occurs, and growth of particles is difficult.

The precipitated solid is preferably recovered by solid-liquid separation.

The method of solid-liquid separation is not specifically limited and may be filtration, centrifugation, sedimentation, or the like. Any of these methods may be performed by a batch process or a continuous process.

The solid obtained by solid-liquid separation is preferably washed using a solvent. Although no specific limitations are placed on the washing solvent, it is preferable to use a solution having a composition corresponding to the liquid portion at the time of precipitation, a good solvent, or a solvent that can dissolve a metal chloride or the like. Water and alcohols such as methanol and ethanol are preferable, and a combination thereof may be used.

The washing method is not specifically limited and may be a method in which batch washing is performed, a method in which continuous washing is performed by causing the washing solvent to flow in a state in which the solid has been loaded into a solid-liquid separation device such as a filter or a centrifuge, a combination of these methods, or the like.

By removing the washing solvent from polyamide present after washing under heating and/or reduced pressure to yield a dry solid, it is possible to obtain powdered polyamide.

The production method of the present embodiment preferably includes a step 4 of washing the powdered polyamide that has been obtained in step 3 at least once using a solvent. This washing may be performed once or may be performed multiple times.

Among such washings, it is preferable that the solvent used in a first washing is the same alcohol as the alcohol that was used in step 1 from a viewpoint of washing efficiency and raw material reuse. In other words, the solvent is preferably the same alcohol as the alcohol that is contained in the metal chloride alcohol solution in step 1. Since solvent contained in the crystallized polyamide contains the metal chloride that was used in the dissolving, the use of the same alcohol as the alcohol that was used in step 1 makes it possible to concentrate the washing liquid together with a filtrate from filtration after crystallization and then reuse the concentrate as a dissolution liquid and to reduce the amount of metal chloride waste. Moreover, the use of a different solvent results in a large change of affinity between the polyamide and solvent and reduces washing efficiency.

The production method of the present embodiment preferably includes a step 5 of heating the powdered polyamide that has been obtained in step 3 to obtain a heated powdered polyamide. By heating and modifying the powdered polyamide solid content that has precipitated, the content of a solvent (typically a metal chloride alcohol solution such as calcium chloride methanol solution) in the powdered polyamide solid content can be reduced.

Step 5 may involve heating the powdered polyamide that has been washed in step 4 (i.e., step 5 may be implemented after step 4). Alternatively, the heated powdered polyamide may be obtained in step 5, and then this heated powdered polyamide may be washed in step 4.

Note that step 5 may be step (iii) of aspect (II) of the present disclosure that is described further below.

The above-described heating in step 5 may be performed in air or in an inert gas. In the above-described heating, drying may be performed in addition to heating, or drying may be performed in accompaniment to heating. For example, after the powdered polyamide has been washed in step 4, the powdered polyamide may be heated and dried in step 5.

The following describes how the powdered polyamide is thought to be modified by heating but is not intended as a restriction to any particular theory. Specifically, at the time of precipitation, solvent (typically a metal chloride alcohol solution such as calcium chloride methanol solution) is presumed to swell while still in a state in which it has permeated into the powdered polyamide, and heating in this state is thought to cause drying of the metal chloride alcohol solution serving as a solvent and/or contraction of voids that were trapping the metal chloride alcohol solution. This is thought to enable reduction of the residual amount of the metal chloride alcohol solution and to also improve impurity removal efficiency during subsequent washing.

The heating temperature in step 5 is not specifically limited and may be 20° C. to 100° C., for example. An excessively low heating temperature results in a low modification effect, whereas an excessively high heating temperature leads to fusion of solid through the solution and makes handling more difficult.

Although no specific limitations are placed on stirring during the heating in step 5, it is preferable that stirring is performed in order to avoid localized heating.

The pressure during the heating in step 5 is not specifically limited, and the heating may be performed under raised pressure or may be performed under reduced pressure. It is preferable that the heating is performed with the pressure lowered to not higher than atmospheric pressure because this makes it possible to remove solvent (typically a metal chloride alcohol solution such as calcium chloride methanol solution) and reduce the residual amount of the metal chloride alcohol solution, and also improves impurity removal efficiency during subsequent washing.

The production method of the present embodiment preferably includes a step 6 of performing solid-liquid separation of the heated powdered polyamide that has been obtained in step 5 and washing a solid that is obtained through the solid-liquid separation.

The method of solid-liquid separation is not specifically limited and may be filtration, centrifugation, sedimentation, or the like. A washing liquid is added to solid content obtained through the solid-liquid separation in order to dissolve and remove impurities.

The washing liquid may be water, an alcohol such as ethanol, n-propanol, or isopropanol, or a combination of any thereof. Moreover, depending on the types of impurities, an acid such as hydrochloric acid, sulfuric acid, nitric acid, phosphoric acid, or acetic acid or a base such as sodium hydroxide, potassium hydroxide, sodium carbonate, or sodium hydrogen carbonate may be added to the washing liquid. In order to avoid residue after washing, it is preferable that a final washing is performed using water, and most preferable that all washings are performed using water.

The amount of the washing liquid that is used in step 6 is not specifically limited but is preferably an amount determined such that the residual amount of impurities after washing is reduced to a target amount.

The washing method in step 6 is not specifically limited and may be a method in which batch washing is performed just as many times as necessary, a method in which continuous washing is performed by causing the washing liquid to flow in a state in which the solid has been loaded into a filter or a centrifuge, a combination of these methods, or the like.

After the washing, drying may be performed as necessary. For example, in a case in which polyamide solid content has been obtained through water washing, water is removed from the solid content under heating and/or reduced pressure to obtain a dry solid.

The production method of the present embodiment is preferably a method that includes, after steps 1 to 3:
step 7: a step of recovering powdered polyamide that has precipitated;
step 8: a washing step of washing the powdered polyamide that has been recovered; and
step 9: a drying step of thermally drying the powdered polyamide that is present after the washing, wherein
an amount of metal chloride that is attached to the powdered polyamide that is present after the thermal drying of step 9 is 20 parts by mass or less relative to 100 parts by mass of the powdered polyamide recovered in step 7.

The method of producing polyamide of the present embodiment may further include a recovery step (step 7) of recovering powdered polyamide that has precipitated after step 3. For example, the powdered polyamide that has been washed in the previously described step 4 may be recovered, the powdered polyamide that has been heated in step 5 may be recovered, or the powdered polyamide present after washing of the solid obtained by solid-liquid separation in step 6 may be recovered.

The production method of the present embodiment preferably includes a washing step (step 8) of washing the powdered polyamide that has been recovered in step 7. This step makes it possible to remove impurities such as metal chloride from the polyamide that has been recovered in step 7.

No specific limitations are placed on the washing liquid that is used for washing in step 8. For example, a solution having a composition corresponding to the liquid portion at the time of precipitation, a good solvent, or a solvent that can dissolve calcium chloride or the like may be used. Additional washing liquid that is used here may be water or an alcohol such as methanol, ethanol, n-propanol, or isopropanol, for example. The additional washing liquid is preferably methanol. The washing may be performed multiple times as necessary.

The washing method is not specifically limited and may be a method in which batch washing is performed, a method in which continuous washing is performed by causing water to flow in a state in which a solid has been loaded into a solid-liquid separation device such as a filter or a centrifuge, a combination of these methods, or the like.

Note that step 8 is preferably a control step of controlling the amount of metal chloride after thermal drying in step 9 described below.

The amount of metal chloride after drying in step 9 can be controlled by adjusting the type or concentration of the washing liquid, the washing time, and so forth such that the amount of metal chloride after drying in step 9 is within a prescribed range.

The production method of the present embodiment may include a step (step 9) of thermally drying the polyamide that has been washed in step 8. By removing the washing solvent from the polyamide present after washing to yield a dry solid through step 9, it is possible to obtain the polyamide.

Moreover, in the method of producing polyamide of the present embodiment, the amount of metal chloride that is attached to the polyamide after thermal drying in step 9 is preferably 20 parts by mass or less relative to 100 parts by mass of the polyamide.

In washing of the recovered polyamide, it is preferable to avoid excessive washing from viewpoints such as production efficiency, cost, and environmental consciousness. Conversely, inadequate washing of the recovered polyamide has also resulted in a problem that some of the polyamide may melt and become stuck together during subsequent drying due to metal chloride that is attached to the polyamide after washing.

Therefore, by setting the amount of metal chloride that is attached to the polyamide after thermal drying in step 9 as 20 parts by mass or less relative to 100 parts by mass of the polyamide obtained in step 9, it is possible to limit metal chloride concentration to a range that makes it possible to inhibit melting of the polyamide. In addition, setting the amount of metal chloride that is attached to the polyamide after thermal drying in step 9 as 0.01 parts by mass or more relative to 100 parts by mass of the polyamide is preferable in terms that excessive washing can be avoided.

From similar viewpoints, the amount of metal chloride that is attached to the polyamide after thermal drying in step 9 is preferably 0.01 parts by mass to 10 parts by mass, and more preferably 0.01 parts by mass to 5 parts by mass relative to 100 parts by mass of the polyamide.

The measurement method of the amount of metal chloride that is attached to the polyamide after thermal drying in step 9 is not specifically limited and may, for example, be by sampling a portion and then adopting 1) a method in which measurement is performed by X-ray fluorescence analysis after drying, 2) a method in which measurement is performed by ICP-AES after thermal decomposition using nitric acid, or 3) a method in which metal chloride is extracted using water and then measured by an ion chromatograph.

Note that measurement of the amount of metal chloride that is attached to the polyamide after thermal drying in step 9 can be performed after thermal drying in step 9 or can be performed after washing of the polyamide in the previously described step 8.

A commonly known method can be used as appropriate in measurement of the amount of metal chloride.

The production method of the present embodiment may further include a step of concentrating a metal chloride alcohol solution from a viewpoint of reusing the metal chloride alcohol solution.

For example, a metal alcohol solution containing a metal chloride and an alcohol that is obtained in the polyamide recovery step may be concentrated and reused.

The method by which the concentrating is performed may be concentrating through heating, for example.

As set forth above, according to the production method of the present embodiment, in production of powdered polyamide through dissolution and precipitation of polyamide that is useful as an engineering plastic, setting the contents of a metal chloride and water within prescribed ranges in a metal chloride alcohol solution that is used to dissolve the polyamide and setting the temperature during dilution or the amount of precipitation during dilution within a prescribed range makes it possible to reduce liquid content in the precipitated polyamide and thus to provide a method of producing powdered polyamide with a reduced amount of washing solvent and reduced energy consumption in drying.

### <Powdered Polyamide>

Powdered polyamide obtained through the production method of the present embodiment has a large particle diameter and a small particle size distribution.

The median diameter of the powdered polyamide is preferably 20 μm or more, and more preferably 30 μm to 70 μm. The median diameter can be measured by a method subsequently described in the EXAMPLES section.

The span of the particle size distribution of the powdered polyamide, which is a value 10^{S} determined by using S expressed by the following formula (1) to raise 10 to the power S, is preferably 5 or less, more preferably 4 or less, and even more preferably 3 or less.

$$S = log ( d 90 / d 10 ) / log ( d 50 ) \qquad ( 1 )$$

(In formula (1), dn (where n represents 10, 50, or 90) indicates the particle diameter at which, in measurement of a particle size distribution of the powdered polyamide by laser diffraction/scattering, the number of particles having a particle diameter of smaller than dn is n % relative to the total number of particles.)

The particle size distribution can be measured by a method subsequently described in the EXAMPLES section.

The powdered polyamide may contain metal atoms and halogen atoms.

The metal atoms may be metal atoms that originate from the metal chloride and/or hydroxide of the same metal that are contained in the metal chloride alcohol solution. For example, the metal atoms may be zinc atoms or calcium atoms, and are preferably calcium atoms.

It is preferable that the powdered polyamide contains 0.001 ppm to 1,500 ppm of calcium atoms and that the molar content of halogen atoms is less than 1 relative to the molar content of calcium atoms.

The metal atom content in the powdered polyamide is preferably 0.001 ppm to 1,500 ppm, more preferably 0.001 ppm to 1,000 ppm, even more preferably 0.001 ppm to 700 ppm, and particularly preferably 0.001 ppm to 500 ppm.

The calcium atom content in the powdered polyamide is preferably 0.001 ppm to 1,500 ppm, more preferably 0.001 ppm to 1,000 ppm, even more preferably 0.001 ppm to 700 ppm, and particularly preferably 0.001 ppm to 500 ppm.

A ratio of the molar content (for example, mol/L) of halogen atoms relative to the molar content (for example, mol/L) of metal atoms in the powdered polyamide (halogen atom molar content/metal atom molar content) is preferably less than 2, more preferably less than 1, and even more preferably less than 0.5.

Examples of elements contained in the powdered polyamide that are not silicon and do not originate from the polyamide include, but are not specifically limited to, calcium and zinc (for example, in the form of a calcium compound and a zinc compound).

The amount of calcium that is contained in the powdered polyamide, in terms of the calcium atom content quantified by X-ray fluorescence analysis, is preferably 1,500 ppm or less, more preferably 1,000 ppm or less, even more preferably 700 ppm or less, and particularly preferably 500 ppm or less.

The amount of zinc that is contained in the powdered polyamide, in terms of the zinc atom content quantified by X-ray fluorescence analysis, is preferably 1,500 ppm or less, more preferably 1,000 ppm or less, even more preferably 700 ppm or less, and particularly preferably 500 ppm or less.

Although calcium and zinc have little influence on clogging during spinning, compounds of calcium and zinc tend to absorb water, and melting of the powdered polyamide while still in a state containing water causes hydrolysis, lowers the molecular weight of the powdered polyamide, and reduces the durability of a shaped product.

### (Spinning of Polyamide Fibers)

The spinning temperature in melt spinning is preferably not lower than 290° C. and not higher than 310° C. Setting the spinning temperature as 310° C. or lower is preferable in order to suppress thermal decomposition of the polyamide, and the spinning temperature is more preferably 300° C. or lower, and even more preferably 295° C. or lower. On the other hand, setting the spinning temperature as 290° C. or higher is preferable because the polyamide displays sufficient melt flowability, there is greater uniformity of the amount of discharge between discharge holes, and high ratio stretching becomes possible.

The residence time (time until polyamide resin melts and is discharged from a spinneret) in the melt spinning process is preferably short. The residence time is preferably 30 minutes or less, more preferably 15 minutes or less, and even more preferably not less than 0.5 minutes and not more than 7 minutes. A short time is preferable because cyclopentanone content in the polymer increases at the melting temperature.

In order to provide thermal stability in high temperature and high humidity environments, it is preferable that a copper compound is added such that the copper concentration is 1 ppm to 500 ppm, and more preferably 30 ppm to 500 ppm relative to the polyamide. Through the above, reduction of mechanical performance is extremely effectively suppressed even upon placement in a high temperature and high humidity environment for a long time or exposure to an environment containing a large amount of ozone for a long time. Heat resistance strength retention decreases with a copper content of less than 30 ppm, whereas strength decreases when the additive amount exceeds 500 ppm.

No specific limitations are placed on the type of copper compound. For example, an organic copper salt such as copper acetate or a copper halide such as cuprous chloride or cupric chloride can preferably be used. The copper compound is more preferably used together with a metal halide. The metal halide may be potassium iodide, potassium bromide, potassium chloride, or the like, for example. Preferable combinations in the present embodiment are cuprous iodide with potassium iodide and copper acetate with potassium iodide. Note that the copper content in the polyamide can be measured by atomic absorption spectroscopy, colorimetry, or the like.

Although no limitation is made to the following, an organic antioxidant such as a hindered phenol antioxidant, a sulfuric antioxidant, or a phosphoric antioxidant, a heat stabilizer, a light stabilizer based on a hindered amine, benzophenone, imidazole, or the like, an ultraviolet absorber, or the like may be added as a stabilizer. The additive amount should be selected as appropriate and can be 1 ppm to 1,000 ppm relative to the polyamide. Not only may one of these additives be used individually, but also a plurality of these additives may be used in combination.

Moreover, in the melt spinning process, it is preferable to use a uniaxial or biaxial extruder in the melt zone. The extruder makes it possible to apply suitable pressure to the polyamide resin while also guiding the polyamide resin to polymer piping, a gear pump, and a spinning pack.

Moreover, it is preferable that the polyamide resin is filtered using a metal fiber non-woven fabric filter, sand, or the like at a stage prior to discharge from a spinneret in order to stabilize spinning operation.

The nozzle shape of the spinneret should be selected according to the cross-sectional shape of monofilament(s) composing the filament that is to be produced. A spun yarn from the spinneret is solidified in cooling air, coated with process oil, and taken up, and is subsequently subjected to stretching and heat treatment to obtain polyamide fibers.

The oil attachment rate of the polyamide fibers is preferably 0.5 wt % to 1.5 wt %. When the oil attachment rate is 1.5 wt % or less, there is good weaving stability with almost no difficulty in terms of weft yarn running due to stickiness (tackiness) and no loss of weft yarn conveying force of air or water serving as a weft yarn conveying medium due to the reduction of apparent cross-sectional area when there is excessive single yarn bundling beyond single yarn bundling by entanglement. On the other hand, when the oil attachment rate is 0.5 wt % or more, a suitable friction reduction effect allows smooth supply of the weft yarn, thus resulting in excellent productivity without weaving downtime.

### (Polyamide Base Fabric)

In weaving, a water jet loom, an air jet loom, a rapier loom, or the like can be used as a loom. A base fabric for an airbag is a high-density woven fabric that is preferably produced with increased warp yarn tension in a warping process and a weaving process so as to provide good process throughput. By setting a high warp yarn tension in weaving and creating effective beating conditions, a high-density woven fabric is formed.

Process oil on polyamide fibers of the woven fabric obtained through weaving can be washed off through a scouring process.

In the scouring process, warm water, pressurized hot water, or the like can be selected to perform treatment as a single stage or as multistage treatment including two or more stages. Moreover, it is preferable that the scouring is performed with a commonly known scouring agent applied.

The woven fabric is preferably thermally fixed through a heat setting process. The heat setting temperature is preferably not lower than 110° C. and not higher than 200° C., and the heat setting time should be selected as appropriate from a range of not less than 0.1 minutes and not more than 30 minutes. In the heat setting process, drying is preferably performed while performing tensing such that woven fabric contraction force is maintained as a specific force. Thermal fixing of the woven fabric enables stabilization of processability in a subsequent resin application process.

The woven fabric that has undergone the scouring process may be subjected to drying treatment as necessary prior to the heat setting process. The drying temperature is preferably within a range of not lower than 80° C. and not higher than 130° C., and is more preferably not lower than 100° C. and not higher than 120° C. Moreover, the treatment time is preferably selected as appropriate as a time of not less than 0.1 minutes and not more than 30 minutes. Drying may be performed with the woven fabric in a relaxed state or may be performed with the woven fabric in a tense state.

The polyamide base fabric that has undergone the heat setting process can be used as a non-coated base fabric. Alternatively, a coating agent such as silicone or urethane may be applied or a thin film or the like may be thermally laminated onto the polyamide base fabric.

The method by which the surface of the woven fabric is coated may be a method in which the woven fabric is immersed in a resin solution tank and then a mangle, vacuum, coating knife, or the like is used to perform formation and equalization of excess resin, a method in which bar coating is performed using a comma coater or the like, or a method in which the resin is sprayed against the surface using a spraying device, a forming device, or the like. Of these methods, knife coating is preferable from a viewpoint of uniform application of a small amount of the resin.

The coating weight is not less than 5 g/m² and not more than 100 g/m², more preferably not less than 10 g/m² and not more than 70 g/m², and even more preferably not less than 15 g/m² and not more than 30 g/m². When the coating weight is 5 g/m² or more, the necessary air tightness is obtained. On the other hand, when the coating weight is 100 g/m² or less, the coated woven fabric has flexibility and good ease of storage, and the weight of the overall bag is restricted.

### <Airbag>

The airbag may be selected as appropriate from airbags that are typically used for a driver's seat, passenger's seat, side (inclusive of inflatable curtains), rear seat, or the like. The cut shape of a bag body of the airbag may be a circular shape, an oblong shape, an elliptical shape, a rectangular shape, a polygonal shape, or a combination thereof, for example, and should be a shape that satisfies the shape demanded upon deployment.

The shape of stitching may be a single straight line, a plurality of parallel straight lines, a zig-zag shape, a combination of a straight line and a zig-zag, straight and diagonal lines, or the like. The method of sewing may be a typically used method such as final stitch or double chain stitch, and the sewing pitch may be selected from a range of 20 stitches/10 cm to 60 stitches/10 cm. Moreover, the sewing thread thickness may be selected from 420 d to 3,000 d, and the thread material can be commercially available sewing thread of polyamide fibers, polyester fibers, vinylon-based fibers, aramid-based fibers, glass fibers, or the like.

### [Aspect (II)]

The following describes aspect (II) of the present disclosure. Conditions of aspects (I) and (III) to (VII) of the present disclosure may be incorporated into aspect (II) of the present disclosure as appropriate.

Aspect (II) of the present disclosure relates to a method of producing recycled polyamide through precipitation of polyamide that is dissolved in a solvent. A feature of this production method is the inclusion of a step of washing precipitated polyamide after the precipitated polyamide has been heated.

A method of producing recycled polyamide according to aspect (II) of the present disclosure includes:
(i) a step of dissolving polyamide in a calcium chloride methanol solution to obtain a solution containing dissolved polyamide;
(ii) a step of causing precipitation of the dissolved polyamide from the solution containing the dissolved polyamide to obtain precipitated polyamide;
(iii) a step of heating the precipitated polyamide to obtain heated polyamide; and
(iv) a step of washing the heated polyamide with a washing liquid to obtain recycled polyamide.

In the present specification, the term “method of producing recycled polyamide” has the same meaning as terms such as “method of recovering polyamide”, “method of isolating polyamide”, “method of purifying polyamide”, and “method of recycling polyamide”, and these terms can be used interchangeably. Herein, polyamide is recovered, isolated, and/or purified from a polyamide shaped item, and more specifically from a processed polyamide shaped item or a used polyamide shaped item with the aim of reuse. Accordingly, the term “recycled polyamide” as used in the present specification refers to polyamide that has been obtained through such treatment.

### <Polyamide>

In the present specification, the term polyamide is inclusive of polymers that have been polymerized through amide bonds such as a polymer that has been obtained through polycondensation of a diamine compound and a dicarboxylic acid compound and a polymer that has been obtained through ring-opening polymerization of a cyclic lactam. The term polyamide also encompasses polyamides that only have an aliphatic skeleton, polyamides that only have an aromatic skeleton, and polyamides that have an aliphatic skeleton and an aromatic skeleton. The polyamide in the presently disclosed production method preferably only has an aliphatic skeleton.

The diamine compound may be ethylenediamine, trimethylenediamine, tetramethylenediamine, pentamethylenediamine, hexamethylenediamine, nonanediamine, methylpentanediamine, p-phenylenediamine, or the like, for example, without any specific limitations.

The dicarboxylic acid compound may be oxalic acid, malonic acid, succinic acid, glutaric acid, adipic acid, sebacic acid, terephthalic acid, isophthalic acid, or the like, for example, without any specific limitations.

The cyclic lactam may be ε-caprolactam, undecanelactam, lauryl lactam, or the like, for example, without any specific limitations.

No specific limitations are placed on combinations of the diamine compound, the dicarboxylic acid compound, and the cyclic lactam compound, and each of these compounds may be a plurality of types of compounds that are used together.

The polyamide is preferably poly(hexamethylene adipamide). Poly(hexamethylene adipamide), which is formed from hexamethylenediamine and adipic acid, has high solubility and is suitable for a process according to the presently disclosed production method. Moreover, poly(hexamethylene adipamide) enables easy powder formation due to having high solubility.

### <Step (i): Polyamide Dissolution Step>

In this step, polyamide is dissolved in a calcium chloride methanol solution to obtain a solution containing dissolved polyamide. In this step, the polyamide is dissolved using the calcium chloride methanol solution to perform dissolution treatment of the polyamide.

The concentration of calcium chloride in the calcium chloride methanol solution is not specifically limited, but may be 10 weight % to 25 weight %, for example, preferably 12 weight % to 22 weight %, and more preferably 15 weight % to 20 weight %. When the concentration of calcium chloride in the calcium chloride methanol solution is too low, only a small amount of polyamide dissolves, and a large amount of solvent is required. On the other hand, when the concentration of calcium chloride in the calcium chloride methanol solution is too high, it becomes more likely that calcium chloride will remain without dissolving and be mixed in as an impurity.

The calcium chloride methanol solution may further contain a solvent other than methanol. The solvent other than methanol may be water or an alcohol such as ethanol, n-propanol, or isopropanol, for example, without any specific limitations. In a case in which the calcium chloride methanol solution contains such a solvent, the solution containing the dissolved polyamide also ends up containing the solvent.

The calcium chloride that is used as a raw material of the calcium chloride methanol solution is preferably anhydrous calcium chloride because the inclusion of water reduces polyamide solubility, though a dihydrate can be mixed into the calcium chloride to the extent that acceptable solubility is obtained.

Dissolution of the calcium chloride may be performed under heating or in the absence of heating. The heating temperature is not specifically limited, but may be 20° C. to 100° C., for example, and is preferably 25° C. to 80° C. A temperature of lower than 20° C. reduces the rate of dissolution, whereas a temperature of higher than 100° C. causes a decomposition reaction to proceed and reduces the yield.

Dissolution of the calcium chloride may be performed by a batch process or a continuous process. In the case of a batch process, the dissolution may be performed under stirring or in the absence of stirring, but it is preferable that stirring is performed. Stirring improves the rate of dissolution of polyamide solid. In the case of a continuous process, the solvent may be caused to continuously flow relative to a solid or the solution may be circulated. Circulation of the solution is preferable from a viewpoint of reducing the amount of solvent that is used.

The shape of a vessel that is used in dissolution of the calcium chloride is not specifically limited, and any shape of vessel such as a tank-type or circulation-type vessel may be used.

The dissolving time is not specifically limited and may be 5 minutes to 48 hours, for example.

The concentration of polyamide relative to solvent (specifically the calcium chloride methanol solution) in the present step is not specifically limited, but may be 1% to 20%, for example, and is preferably 5% to 15%. An excessively low concentration of polyamide relative to solvent means that an excessively large amount of solvent is required, whereas an excessively high concentration of polyamide relative to solvent results in higher viscosity and longer dissolving time.

A polyamide shaped item that is subjected to the dissolving (more specifically, a processed polyamide shaped item, a used polyamide shaped item, or the like) may be composed of just the polyamide or may contain impurities. Examples of such impurities include other resins and metals. The polyamide that is subjected to the dissolving may have such impurities in a mixed, attached, and/or applied state, but in a case in which impurities are present with the polyamide, the polyamide and the impurities are separated as necessary. No specific limitations are placed on the method of separation. In a case in which the impurities are insoluble in a state in which the polyamide has dissolved, the impurities can be separated by a method such as filtration, centrifugation, or sedimentation, for example. In a case in which the impurities dissolve in a solvent together with the polyamide, separation can be performed in a dissolved state by extraction, membrane separation, electrodialysis, or the like, for example, or separation can be performed by washing after precipitation of polyamide in the subsequently described precipitation step.

### <Step (ii): Precipitation Step>

In this step, the dissolved polyamide that has been obtained in step (i) is caused to precipitate from the solution containing the dissolved polyamide to obtain precipitated polyamide. Solid content of the precipitated polyamide may be separated from the solution in this step.

No specific limitations are placed on the method by which the dissolved polyamide is caused to precipitate from the solution, and a number of precipitation methods can be adopted depending on the dissolved state.

In a case in which the dissolving is performed through heating, precipitation may be performed through cooling by exploiting the temperature dependence of polyamide solubility. In this case, the dissolved polyamide is caused to precipitate from the solution to obtain precipitated polyamide without adding an additional solvent to the solution containing the dissolved polyamide.

In a case in which the temperature dependence of solubility during dissolution is small, the polyamide may be caused to precipitate by mixing the polyamide with a poor solvent for polyamide so as to lower solubility. In this case, the dissolved polyamide is caused to precipitate from the solution to obtain precipitated polyamide after the poor solvent has been added to the solution containing the dissolved polyamide. The poor solvent may be water or an alcohol such as ethanol, n-propanol, or isopropanol, for example, without any specific limitations. The method by which the poor solvent is added to the polyamide may be a method in which the polyamide solution is added into the poor solvent or a method in which the polyamide is added into the poor solvent. No specific limitations are placed on the addition rate, temperature, stirring speed, and so forth during addition.

In a case in which the temperature dependence of solubility during dissolution is small, polyamide solubility can alternatively be reduced by lowering the concentration of calcium chloride.

As previously described, solid content of the precipitated polyamide may be separated from the solution in this step prior to the subsequent heating step. The method of solid-liquid separation may be filtration, centrifugation, sedimentation, or the like, for example. A batch process or a continuous process may be adopted in any of these methods.

Solid content that has been obtained through the solid-liquid separation may be washed with an additional washing liquid. Specifically, the precipitated polyamide may be separated from the solution from during precipitation to obtain solid content containing polyamide, the obtained solid content may be washed using an additional washing liquid, and then the polyamide may be heated in step (iii). The additional washing liquid is not specifically limited and may, for example, be a solution having a composition corresponding to the liquid portion at the time of precipitation, a good solvent, or a solvent that can dissolve calcium chloride or the like. The additional washing liquid that is used here may be water or an alcohol such as methanol, ethanol, n-propanol, or isopropanol, for example. The additional washing liquid is preferably methanol. The washing may be performed multiple times as necessary. Moreover, in a case in which it is necessary to remove the additional washing liquid through pressure reduction in the subsequently described heating step, it is preferable that the additional washing liquid used in the washing has a boiling point of lower than 100° C. When the boiling point of the additional washing liquid is too high, removal of the washing liquid has high energy requirement.

<Step (iii): Heating Step>

In this step, the precipitated polyamide that has been obtained in step (ii) is heated to obtain heated polyamide. Solid content of the precipitated polyamide is heated and modified, and the amount of solvent (typically calcium chloride methanol solution) in the polyamide solid content is reduced.

In a case in which the solid content of the precipitated polyamide has not been separated from the solution in step (ii), the solid content is heated in the solution in this step. In other words, the polyamide that has precipitated in step (ii) is heated in the solution from during precipitation in step (ii).

Moreover, in a case in which the precipitated solid content has been separated from the solution in precipitation in step (ii), the heating may be performed in air or an inert gas, for example. In the heating of this step, drying may be performed in addition to heating, or drying may be performed in accompaniment to heating. For example, as previously described, the polyamide may be heated in this step after the precipitated polyamide has been separated from the solution from during precipitation to obtain solid content containing polyamide and the obtained solid content has been washed using an additional washing liquid in step (ii).

The following describes how the polyamide is thought to be modified by heating, but is not intended as a restriction to any particular theory. Specifically, at the time of precipitation, solvent (typically calcium chloride methanol solution) is presumed to swell while still in a state in which it has permeated into the polyamide, and heating in this state is thought to cause drying of the calcium chloride methanol solution serving as a solvent and/or contraction of voids that were trapping the calcium chloride methanol solution. This makes it difficult for liquid such as washing liquid to repermeate into the polyamide, can reduce the residual amount of the calcium chloride methanol solution, and is also thought to improve impurity removal efficiency during subsequent washing (step (iv)).

The heating temperature is not specifically limited and may be 20° C. to 100° C., for example. An excessively low heating temperature results in a low modification effect, whereas an excessively high heating temperature leads to fusion of solid through the solution and makes handling more difficult.

Although no specific limitations are placed on stirring during the heating, it is preferable that stirring is performed in order to avoid localized heating.

The pressure during the heating is not specifically limited, and the heating may be performed under raised pressure or may be performed under reduced pressure. In a case in which solid-liquid separation has been performed in step (ii), it is preferable that the heating is performed with the pressure lowered to not higher than atmospheric pressure because this causes removal of solvent (typically calcium chloride methanol solution) and increases the efficiency of subsequently described washing (step (iv)).

### <Step (iv): Washing Step>

In this step, the heated polyamide that has been obtained in step (iii) is washed using a washing liquid to obtain recycled polyamide. In other words, this step is a step of washing polyamide solid content that has been modified.

In a case in which solid-liquid separation has not been performed in step (ii) and in which the polyamide has undergone the heating step in the solution in which it precipitated, solid-liquid separation is first performed in this step. The method of solid-liquid separation is not specifically limited and may be a method such as filtration, centrifugation, or sedimentation, for example. A washing liquid is added to solid content obtained through the solid-liquid separation in order to dissolve and remove impurities.

The washing liquid that is used in this step may be water, an alcohol such as ethanol, n-propanol, or isopropanol, or a combination of any thereof. Moreover, depending on the types of impurities, an acid such as hydrochloric acid, sulfuric acid, nitric acid, phosphoric acid, or acetic acid or a base such as sodium hydroxide, potassium hydroxide, sodium carbonate, or sodium hydrogen carbonate may be added to the washing liquid. In order to avoid residue after washing, it is preferable that a final washing is performed using water, and most preferable that all washings are performed using water. In other words, in a preferred configuration, the washing liquid in step (iv) is water.

The amount of the washing liquid that is used in this step is not specifically limited but is preferably an amount determined such that the residual amount of impurities after washing is reduced to a target amount.

The washing method in this step is not specifically limited and may be a method in which batch washing is performed just as many times as necessary, a method in which continuous washing is performed by causing the washing liquid to flow in a state in which the solid has been loaded into a filter or a centrifuge, a combination of these methods, or the like.

After the washing, drying may be performed as necessary. For example, in a case in which solid content of the polyamide has been obtained through water washing, water is removed from the solid content under heating and/or reduced pressure to obtain a dry solid.

The recycled polyamide that is obtained in this step is a solid and is preferably in a powdered form.

As described above, according to the present disclosure, it is possible to reduce the amount of waste liquid generated in a washing step (for example, a water washing step) that is essential for impurity removal in recycling of polyamide that is useful as an engineering plastic. Moreover, reduction of the amount of waste liquid is also thought to enable suppression of energy consumption during drying. Therefore, it is anticipated that the amount of energy required in a polyamide recycling process can be suppressed and that the burden on this process can be mitigated.

### [Aspect (III)]

The following describes aspect (III) of the present disclosure. Conditions of aspects (I), (II), and (IV) to (VII) of the present disclosure may be incorporated into aspect (III) of the present disclosure as appropriate.

A method of producing recycled polyamide of a present embodiment (III) is a method of producing recycled polyamide using a polyamide resin composition that contains polyamide coated with a silicone resin as a raw material, the method comprising a dissolution step of mixing a metal chloride alcohol solution containing a metal chloride and an alcohol with the polyamide resin composition to dissolve the polyamide and obtain a polyamide dissolution liquid, wherein a mass proportion of polyamide in the polyamide dissolution liquid in the dissolution step is 5 mass % to 15 mass %.

Moreover, a method of producing recycled polyamide of another present embodiment (III) is a method of producing recycled polyamide using a polyamide resin composition that contains polyamide coated with a silicone resin as a raw material, the method comprising a dissolution step of mixing a metal chloride alcohol solution containing a metal chloride and an alcohol with the polyamide resin composition to dissolve the polyamide and obtain a polyamide dissolution liquid, wherein viscosity at 25° C. of the polyamide dissolution liquid in the dissolution step is 10 mPa·s to 20,000 mPa·s.

The production method of the present embodiment (III) may be a method of producing recycled polyamide through a step of dissolving and extracting polyamide from a polyamide base fabric that is coated with silicone using a metal chloride alcohol solution having a controlled water content, for example.

The following describes compounds, etc. that are used in the production method of the present embodiment (III).

### <Polyamide Resin Composition>

The polyamide in the present embodiment can be a polymer that has been polymerized through amide bonds such as a polymer that has been obtained through polycondensation of a diamine compound and a dicarboxylic acid compound or a polymer that has been obtained through ring-opening polymerization of a cyclic lactam.

The diamine compound may be ethylenediamine, trimethylenediamine, tetramethylenediamine, pentamethylenediamine, hexamethylenediamine, nonanediamine, methylpentanediamine, p-phenylenediamine, or the like without any specific limitations.

The dicarboxylic acid compound may be oxalic acid, glutaric acid, adipic acid, sebacic acid, terephthalic acid, isophthalic acid, or the like without any specific limitations.

The cyclic lactam may be ε-caprolactam, undecanelactam, lauryl lactam, or the like without any specific limitations.

No specific limitations are placed on combinations of the diamine compound, the dicarboxylic acid compound, and the cyclic lactam compound described above, and each of these compounds may be a plurality of types of compounds that are used together.

In particular, the polyamide is preferably an aliphatic polyamide from a viewpoint of high solubility in a metal chloride alcohol solution (for example, calcium chloride methanol solution), and is most preferably nylon 66.

The polyamide resin composition contains polyamide coated with a silicone resin. The polyamide resin composition may be a composition that is composed of just the polyamide coated with the silicone resin or may further contain other components.

In particular, from a viewpoint of production efficiency of recycled polyamide, the mass proportion of the polyamide coated with the silicone resin is preferably 30 mass % to 100 mass %, more preferably 60 mass % or more, even more preferably 70 mass % or more, and particularly preferably 80 mass % or more relative to 100 mass % of the polyamide resin composition.

The silicone resin may be a methyl silicone or phenyl silicone resin, for example, without any specific limitations. Moreover, the silicone resin may be a mixture of these resins or may be a product obtained through mixing and curing of respective raw materials thereof.

The polyamide coated with the silicone resin may have another coating in addition to the silicone resin. The type of other coating may be polyethylene, polypropylene, polyester, fluororesin, or the like without any specific limitations. A coating that does not dissolve in the metal chloride alcohol solution used in dissolution is preferable.

The polyamide coated with the silicone resin may be a raw material for polyamide recycling. For example, the silicone resin-coated polyamide may be process offcuts or waste material of a shaped item such as an automotive component or an electrical product component or of fibers in which polyamide is used as a raw material. More specifically, the silicone resin-coated polyamide may be process offcuts or waste material of clothes, airbags, tire cords, components from inside an engine compartment, an intake system, or a fuel system, connectors, fishing nets, or UD tape.

The polyamide resin composition may contain sewing thread. The material of the sewing thread is not specifically limited but is preferably the same polyamide as the base fabric because this enables recovery as recycled polyamide.

### <Metal Chloride Alcohol Solution>

A metal chloride alcohol solution is used as a solvent for dissolving the polyamide.

The metal chloride alcohol solution contains a metal chloride and an alcohol and may further contain other components. In particular, the total mass proportion of the metal chloride and the alcohol relative to 100 mass % of the metal chloride alcohol solution is preferably 80 mass % or more, more preferably 90 mass % or more, and even more preferably 100 mass %.

The metal chloride is not specifically limited and may be zinc chloride, magnesium chloride, calcium chloride, or the like, is preferably zinc chloride or calcium chloride, and is most preferably calcium chloride.

The metal chloride used in a raw material may be anhydrous or may be a hydrate.

The mass proportion of the metal chloride relative to 100 mass % of the metal chloride alcohol solution is preferably 10 mass % to 25 mass %. When this mass proportion is less than 10 mass %, only a small amount of polyamide dissolves, and a large amount of solvent is necessary. Moreover, when this mass proportion is more than 25 mass %, it becomes more likely that metal chloride will remain without dissolving and become mixed in as an impurity.

Although no specific limitations are placed on water in the metal chloride alcohol solution, there is preferably 4 mol or less of water relative to 1 mol of metal chloride in the solution.

The alcohol may be methanol, ethanol, n-propanol, 2-propanol, or the like. In particular, methanol is preferable from a viewpoint of polyamide solubility.

Although no specific limitations are placed on the method by which the metal chloride and the alcohol are mixed, it is preferable that stirring is performed in the case of a batch process. Calcium chloride dissolves even in the absence of stirring, but the dissolution takes time and localized non-uniformity of composition may arise.

The metal chloride alcohol solution that is used to dissolve the polyamide is preferably a solution that has been produced by separating polyamide from a metal chloride alcohol solution having polyamide dissolved therein from a polyamide base fabric. In a case in which variation of concentration or composition arises during separation and recovery of the polyamide, separation of superfluous components through extraction, distillation, or the like, concentration through distillation, concentration adjustment through supplemental addition of a metal chloride and/or alcohol, or the like may be performed. For example, a metal chloride alcohol solution from which polyamide has been separated may be concentrated and may then be used in the production method of the present embodiment. This reduces environmental impact because the alcohol and metal chloride are not treated as waste and improves the recovery rate because polyamide that has remained in a supernatant during polyamide separation and recovery can be recovered once again.

The following describes steps in the production method of the present embodiment.

### <Step 1: Dissolution Step>

The dissolution step is a step of mixing the polyamide resin composition containing polyamide coated with silicone (for example, a polyamide base fabric coated with silicone) with the metal chloride alcohol solution to dissolve the polyamide. Mixing of the polyamide resin composition and the metal chloride alcohol solution causes polyamide to dissolve from the silicone-coated polyamide in the polyamide resin composition.

In the present specification, a solution obtained by mixing the polyamide resin composition and the metal chloride alcohol solution is referred to as a “polyamide dissolution liquid”. The polyamide dissolution liquid contains dissolved polyamide, silicone that was coating the polyamide, and so forth. By separating a coating material such as silicone from the polyamide dissolution liquid, it is possible to obtain a “polyamide-containing solution”.

No specific limitations are placed on the shape of the polyamide base fabric that is used in dissolution. The polyamide base fabric may be added while still having the shape of base fabric production offcuts or used airbags or may be cut in accordance with the size of an apparatus that is used in dissolution.

The temperature during mixing of the polyamide resin composition and the metal chloride alcohol solution is not specifically limited but is preferably 30° C. to 90° C., more preferably 40° C. to 90° C., and even more preferably 40° C. to 60° C. A temperature of lower than 30° C. results in slow dissolution, whereas a temperature of higher than 90° C. exceeds the boiling point and is undesirable from viewpoints of corrosion and decomposition.

The dissolution may be a batch process or a continuous process.

In the case of a batch process, it is preferable that stirring is performed, though no specific limitations are placed on the stirring. Stirring improves the rate of dissolution of polyamide solid.

In the case of a continuous process, the solvent may be caused to continuously flow relative to a solid or the solution may be circulated. Circulation is preferable because the amount of solvent that is used can be reduced.

The shape of a vessel that is used in the dissolution step is not specifically limited, and any shape of vessel such as a tank-type or circulation-type vessel may be used.

The mixing time of the polyamide resin composition and the metal chloride alcohol solution is not specifically limited but is preferably 5 minutes to 100 hours.

The mass proportion of polyamide in 100 mass % of the polyamide dissolution liquid is preferably 5 mass % to 15 mass %, and more preferably 7 mass % to 13 mass %. A mass proportion of less than 5 mass % means that too much solvent is required, whereas a mass proportion of more than 15 mass % results in higher viscosity, longer dissolving time, and poorer operability.

Moreover, the mass proportion of polyamide in 100 mass % of the polyamide-containing solution is preferably 5 mass % to 15 mass %, and more preferably 7 mass % to 13 mass %. A mass proportion of less than 5 mass % means that too much solvent is required, whereas a mass proportion of more than 15 mass % results in higher viscosity, longer dissolving time, and poorer operability.

The viscosity at 25° C. of the polyamide dissolution liquid is preferably 10 mPa·s to 20,000 mPa·s, more preferably 10 mPa·s to 10,000 mPa·s, and even more preferably 10 mPa·s to 3,000 mPa·s. A higher viscosity means a higher polymer concentration, but reduces the efficiency of polyamide dissolution due to sticking together of base fabric, for example.

Moreover, the viscosity at 25° C. of the polyamide-containing solution is preferably 10 mPa·s to 20,000 mPa·s, more preferably 10 mPa·s to 10,000 mPa·s, and even more preferably 10 mPa·s to 3,000 mPa·s.

No specific limitations are placed on the method by which the silicone resin is separated from the polyamide dissolution liquid, and a method in which the silicone resin is scooped up from a dissolved layer, a method such as filtration, centrifugation, or sedimentation, or a combination of any of these methods may be adopted. Since fine fragments of silicone may arise during polyamide dissolution, it is preferable that the fine fragments are removed by filtration or a method in which filtration is incorporated.

Other coating material of the polyamide coated with the silicone resin is preferably removed at the same time as the silicone resin.

The silicone resin and other coating material that have been separated have polyamide-containing solution attached thereto. Therefore, it is preferable to wash the silicone resin and other coating material in order to recover the polyamide-containing solution. The solvent used in this washing is not specifically limited but is preferably a calcium chloride methanol solution. The washing method may be stirred washing inside of a tank-type reactor, flow washing in a filter, or the like without any specific limitations.

### <Polyamide Recovery Step>

The polyamide recovery step is a step of recovering polyamide from the polyamide-containing solution obtained in the dissolution step after the silicone resin has been removed.

Although polyamide may be recovered from the polyamide dissolution liquid, it is preferable from a viewpoint of further improving recovery efficiency that polyamide is recovered from the polyamide-containing solution after coating material such as the silicone resin has been removed.

The method by which polyamide is recovered from the polyamide-containing solution may be a method in which polyamide is caused to precipitate. No specific limitations are placed on the method by which polyamide is caused to precipitate from the polyamide-containing solution, and a number of precipitation methods can be adopted depending on the dissolved state.

In a case in which the dissolving is performed through heating, precipitation may be performed through cooling by exploiting the temperature dependence of polyamide solubility. In this case, the dissolved polyamide is caused to precipitate from the solution to obtain precipitated polyamide without adding an additional solvent to the solution containing the dissolved polyamide.

In a case in which the temperature dependence of solubility during dissolution is small, polyamide may be caused to precipitate by mixing the polyamide-containing solution with a poor solvent for polyamide so as to lower solubility. In this case, the dissolved polyamide is caused to precipitate from the solution to obtain precipitated polyamide after the poor solvent has been added to the solution containing the dissolved polyamide. The poor solvent may be water or an alcohol such as ethanol, n-propanol, or isopropanol, for example, without any specific limitations. The method by which the poor solvent is added to the polyamide may be a method in which the polyamide-containing solution is added into the poor solvent or a method in which the poor solvent is added into the polyamide-containing solution. No specific limitations are placed on the addition rate, temperature, stirring speed, and so forth during addition.

The additive amount of the poor solvent is not specifically limited but is preferably a mass that is 0.5 to 50 times the mass of the polyamide-containing solution, and more preferably a mass that is 1 to 10 times the mass of the polyamide-containing solution. A smaller additive amount results in a lower recovery rate, whereas a larger additive amount results in a larger amount of solution and necessitates greater time and energy for treatment.

In a case in which the temperature dependence of solubility during dissolution is small, polyamide solubility can also be reduced by lowering the concentration of calcium chloride. The method by which methanol is added so as to lower the concentration of calcium chloride is not specifically limited and may be a method in which the polyamide-containing solution is added into methanol or a method in which methanol is added into the polyamide-containing solution. No specific limitations are placed on the addition rate, temperature, stirring speed, and so forth during addition.

The vessel shape is not specifically limited, and any shape of vessel such as a tank-type or circulation-type vessel may be used.

The precipitated polyamide is preferably recovered by solid-liquid separation. The method of solid-liquid separation may be filtration, centrifugation, sedimentation, or the like, for example. A batch process or a continuous process may be adopted in any of these methods.

The polyamide obtained by solid-liquid separation is preferably washed using a solvent. The washing liquid is not specifically limited and may, for example, be a solution having a composition corresponding to the liquid portion at the time of precipitation, a good solvent, or a solvent that can dissolve calcium chloride or the like. Additional washing liquid that is used here may be water or an alcohol such as methanol, ethanol, n-propanol, or isopropanol, for example. The additional washing liquid is preferably methanol. The washing may be performed multiple times as necessary.

The washing method is not specifically limited and may be a method in which batch washing is performed, a method in which continuous washing is performed by causing water to flow in a state in which a solid has been loaded into a solid-liquid separation device such as a filter or a centrifuge, a combination of these methods, or the like.

By removing the washing solvent from polyamide present after washing under heating and/or reduced pressure to yield a dry solid, it is possible to obtain powdered polyamide.

As set forth above, according to the present embodiment, it is possible to provide a method of producing recycled polyamide with high yield from a composition in which polyamide that is useful as an engineering plastic is coated with silicone.

### <Step of Concentrating Metal Chloride Alcohol Solution>

The production method of the present embodiment may further include a step of concentrating a metal chloride alcohol solution from a viewpoint of reusing the metal chloride alcohol solution.

For example, a metal alcohol solution containing a metal chloride and an alcohol that has been obtained in the polyamide recovery step may be concentrated and reused.

The method by which the concentrating is performed may be concentrating through heating, for example.

### <Recycled Polyamide>

No specific limitations are placed on the form of the recycled polyamide that is produced by the production method of the present embodiment. For example, the recycled polyamide may have a pelletized form obtained through melting and pelletization of polyamide during recycling, may have a powdered form as a result of polyamide being dissolved in a solvent and then being caused to precipitate, or may have a tablet form resulting from aggregation of powder according to handling conditions.

The recycled polyamide can be used as a raw material for polyamide fibers, a polyamide base fabric, an airbag, or the like.

### (Spinning of Polyamide Fibers)

The spinning temperature in melt spinning is preferably not lower than 290° C. and not higher than 310° C. Setting the spinning temperature as 310° C. or lower is preferable in order to suppress thermal decomposition of the polyamide, and the spinning temperature is more preferably 300° C. or lower, and even more preferably 295° C. or lower. On the other hand, setting the spinning temperature as 290° C. or higher is preferable because the polyamide displays sufficient melt flowability, there is greater uniformity of the amount of discharge between discharge holes, and high ratio stretching becomes possible.

The residence time (time until polyamide resin melts and is discharged from a spinneret) in the melt spinning process is preferably short. The residence time is preferably 30 minutes or less, more preferably 15 minutes or less, and even more preferably not less than 0.5 minutes and not more than 7 minutes. A short time is preferable because cyclopentanone content in the polymer increases at the melting temperature.

In order to provide thermal stability in high temperature and high humidity environments, it is preferable that a copper compound is added such that the copper concentration is 1 ppm to 500 ppm, and more preferably 30 ppm to 500 ppm relative to the polyamide. Through the above, reduction of mechanical performance is extremely effectively suppressed even upon placement in a high temperature and high humidity environment for a long time or exposure to an environment containing a large amount of ozone for a long time. Heat resistance strength retention decreases with a copper content of less than 30 ppm, whereas strength decreases when the additive amount exceeds 500 ppm.

No specific limitations are placed on the type of copper compound. For example, an organic copper salt such as copper acetate or a copper halide such as cuprous chloride or cupric chloride can preferably be used. The copper compound is more preferably used together with a metal halide. The metal halide may be potassium iodide, potassium bromide, potassium chloride, or the like, for example. Preferable combinations in the present embodiment are cuprous iodide with potassium iodide and copper acetate with potassium iodide. Note that the copper content in the polyamide can be measured by atomic absorption spectroscopy, colorimetry, or the like.

Although no limitation is made to the following, an organic antioxidant such as a hindered phenol antioxidant, a sulfuric antioxidant, or a phosphoric antioxidant, a heat stabilizer, a light stabilizer based on a hindered amine, benzophenone, imidazole, or the like, an ultraviolet absorber, or the like may be added as a stabilizer. The additive amount should be selected as appropriate and can be 1 ppm to 1,000 ppm relative to the polyamide. Not only may one of these additives be used individually, but also a plurality of these additives may be used in combination.

Moreover, in the melt spinning process, it is preferable to use a uniaxial or biaxial extruder in the melt zone. The extruder makes it possible to apply suitable pressure to the polyamide resin while also guiding the polyamide resin to polymer piping, a gear pump, and a spinning pack.

Moreover, it is preferable that the polyamide resin is filtered using a metal fiber non-woven fabric filter, sand, or the like at a stage prior to discharge from a spinneret in order to stabilize spinning operation.

The nozzle shape of the spinneret should be selected according to the cross-sectional shape of monofilament(s) composing the filament that is to be produced. A spun yarn from the spinneret is solidified in cooling air, coated with process oil, and taken up, and is subsequently subjected to stretching and heat treatment to obtain polyamide fibers.

The oil attachment rate of the polyamide fibers is preferably 0.5 wt % to 1.5 wt %. When the oil attachment rate is 1.5 wt % or less, there is good weaving stability with almost no difficulty in terms of weft yarn running due to stickiness (tackiness) and no loss of weft yarn conveying force of air or water serving as a weft yarn conveying medium due to the reduction of apparent cross-sectional area when there is excessive single yarn bundling beyond single yarn bundling by entanglement. On the other hand, when the oil attachment rate is 0.5 wt % or more, a suitable friction reduction effect allows smooth supply of the weft yarn, thus resulting in excellent productivity without weaving downtime.

### (Polyamide Base Fabric)

In weaving, a water jet loom, an air jet loom, a rapier loom, or the like can be used as a loom. A base fabric for an airbag is a high-density woven fabric that is preferably produced with increased warp yarn tension in a warping process and a weaving process so as to provide good process throughput. By setting a high warp yarn tension in weaving and creating effective beating conditions, a high-density woven fabric is formed.

Process oil on polyamide fibers of the woven fabric obtained through weaving can be washed off through a scouring process.

In the scouring process, warm water, pressurized hot water, or the like can be selected to perform treatment as a single stage or as multistage treatment including two or more stages. Moreover, it is preferable that the scouring is performed with a commonly known scouring agent applied.

The woven fabric is preferably thermally fixed through a heat setting process. The heat setting temperature is preferably not lower than 110° C. and not higher than 200° C., and the heat setting time should be selected as appropriate from a range of not less than 0.1 minutes and not more than 30 minutes. In the heat setting process, drying is preferably performed while performing tensing such that woven fabric contraction force is maintained as a specific force. Thermal fixing of the woven fabric enables stabilization of processability in a subsequent resin application process.

The woven fabric that has undergone the scouring process may be subjected to drying treatment as necessary prior to the heat setting process. The drying temperature is preferably within a range of not lower than 80° C. and not higher than 130° C., and is more preferably not lower than 100° C. and not higher than 120° C. Moreover, the treatment time is preferably selected as appropriate as a time of not less than 0.1 minutes and not more than 30 minutes. Drying may be performed with the woven fabric in a relaxed state or may be performed with the woven fabric in a tense state.

The polyamide base fabric that has undergone the heat setting process can be used as a non-coated base fabric. Alternatively, a coating agent such as silicone or urethane may be applied or a thin film or the like may be thermally laminated onto the polyamide base fabric.

The method by which the surface of the woven fabric is coated may be a method in which the woven fabric is immersed in a resin solution tank and then a mangle, vacuum, coating knife, or the like is used to perform formation and equalization of excess resin, a method in which bar coating is performed using a comma coater or the like, or a method in which the resin is sprayed against the surface using a spraying device, a forming device, or the like. Of these methods, knife coating is preferable from a viewpoint of uniform application of a small amount of the resin.

The coating weight is not less than 5 g/m² and not more than 100 g/m², more preferably not less than 10 g/m² and not more than 70 g/m², and even more preferably not less than 15 g/m² and not more than 30 g/m². When the coating weight is 5 g/m² or more, the necessary air tightness is obtained. On the other hand, when the coating weight is 100 g/m² or less, the coated woven fabric has flexibility and good ease of storage, and the weight of the overall bag is restricted.

### <Airbag>

The airbag may be selected as appropriate from airbags that are typically used for a driver's seat, passenger's seat, side (inclusive of inflatable curtains), rear seat, or the like. The cut shape of a bag body of the airbag may be a circular shape, an oblong shape, an elliptical shape, a rectangular shape, a polygonal shape, or a combination thereof, for example, and should be a shape that satisfies the shape demanded upon deployment.

The shape of stitching may be a single straight line, a plurality of parallel straight lines, a zig-zag shape, a combination of a straight line and a zig-zag, straight and diagonal lines, or the like. The method of sewing may be a typically used method such as final stitch or double chain stitch, and the sewing pitch may be selected from a range of 20 stitches/10 cm to 60 stitches/10 cm. Moreover, the sewing thread thickness may be selected from 420 d to 3,000 d, and the thread material can be commercially available sewing thread of polyamide fibers, polyester fibers, vinylon-based fibers, aramid-based fibers, glass fibers, or the like.

### [Aspect (IV)]

The following describes aspect (IV) of the present disclosure. Conditions of aspects (I) to (III) and (V) to (VII) of the present disclosure may be incorporated into aspect (IV) of the present disclosure as appropriate.

Aspect (IV) of the present disclosure relates to a solvent that has low corrosiveness and can dissolve polyamide.

### <Low Corrosiveness Solvent (Methanol Composition)>

The solvent in aspect (IV) of the present disclosure is a methanol composition that contains a metal chloride, a hydroxide of the same metal, and water in specific concentrations.

The concentration of the metal chloride in the solvent is 5% to 25%, preferably 10% to 23%, and more preferably 15% to 22%. The concentration of the metal chloride is defined as the weight concentration relative to the overall methanol composition. A lower metal chloride concentration results in lower polyamide solubility. The solubility of the metal chloride in methanol is 25%, and excess metal chloride absorbs moisture and increases the water content in the methanol composition, thereby resulting in reduced polyamide solubility.

Moreover, the mass proportion of the metal chloride relative to 100 mass % of the solvent is preferably 23 mass % to 35 mass %, more preferably 25 mass % to 33 mass %, and particularly preferably 27 mass % to 31 mass %.

The constituent metal of the metal chloride and the hydroxide of the same metal is not specifically limited but may be zinc (i.e., the metal chloride may be zinc chloride and the hydroxide of the same metal may be zinc hydroxide) or calcium (i.e., the metal chloride may be calcium chloride and the hydroxide of the same metal may be calcium hydroxide), for example, and is preferably calcium.

The metal chloride that is used to produce the solvent is preferably anhydrous, though a hydrate of the metal chloride may be used to the extent that polyamide solubility can be maintained.

The presently disclosed solvent contains the hydroxide of the same metal as a base for reducing corrosion due to the metal chloride. As a result of the presently disclosed solvent containing the hydroxide of the same metal, metal corrosiveness can be reduced without reducing polyamide solubility of the metal chloride methanol solution.

The concentration of the hydroxide of the same metal is 0.001% to 1%, preferably 0.001% to 0.1%, and more preferably 0.001% to 0.01%. The concentration of the hydroxide of the same metal is defined as the weight concentration of the hydroxide of the same metal relative to the overall methanol composition. It is not essential for the hydroxide of the same metal to completely dissolve in the methanol and it may be the case that some of the hydroxide of the same metal is not dissolved.

The mass proportion of water relative to 100 mass % of the metal chloride alcohol solution is preferably 0.001 mass % to 10 mass %, more preferably 0.001 mass % to 5 mass %, even more preferably 0.001 mass % to 1 mass %, and particularly preferably 0.01 mass % to 0.1 mass %.

A metal chloride alcohol solution of a present embodiment preferably contains a metal chloride in a concentration of not less than 23 mass % and not more than 35 mass %, a hydroxide of the same metal as a metal included in the metal chloride in a concentration of 0.001% to 1%, and water in a concentration of 0.001% to 10%.

### <Polyamide-Containing Solution>

The methanol composition may be a polyamide-containing solution that further contains dissolved polyamide in a methanol composition serving as a solvent. Such a polyamide-containing solution can reduce corrosiveness.

### <Polyamide>

The term polyamide as used in the present disclosure refers to a polymer that has been polymerized through amide bonds such as a polymer that has been obtained through polycondensation of a diamine compound and a dicarboxylic acid compound or a polymer that has been obtained through ring-opening polymerization of a cyclic lactam.

The diamine compound may be hexamethylenediamine, nonanediamine, methylpentanediamine, p-phenylenediamine, or the like without any specific limitations.

The dicarboxylic acid compound may be adipic acid, sebacic acid, terephthalic acid, isophthalic acid, or the like without any specific limitations.

The cyclic lactam may be ε-caprolactam, undecanelactam, lauryl lactam, or the like without any specific limitations.

No specific limitations are placed on combinations of the diamine compound, the dicarboxylic acid compound, and the cyclic lactam compound, and each of these compounds may be a plurality of types of compounds that are used together. Poly(hexamethylene adipamide), which is formed from hexamethylenediamine and adipic acid, is suitable due to having high solubility.

The polyamide is not specifically limited and may include an aliphatic polyamide such as polyamide 66 (poly(hexamethylene adipamide)), polyamide 6, polyamide 610, polyamide 6T, or polyamide 6I, preferably includes an aliphatic polyamide, and most preferably includes polyamide 66 (poly(hexamethylene adipamide)).

### <Production Method of Polyamide Composition>

The following provides a detailed description of a method of producing a polyamide composition using the presently disclosed low corrosiveness solvent, but the following description does not limit the production method of the polyamide composition.

### <Step 1: Polyamide Dissolution Step>

Step 1 is a step of dissolving a raw material polyamide composition that serves as a polyamide raw material.

The low corrosiveness solvent described above is used as a solvent for dissolving the raw material polyamide composition.

The temperature during the dissolving is not specifically limited but is preferably 40° C. to 90° C., and more preferably 40° C. to 60° C. A temperature of lower than 40° C. results in slow dissolution, whereas a temperature of higher than 90° C. exceeds the boiling point and is undesirable from viewpoints of corrosion and decomposition.

The dissolution may be a batch process or a continuous process.

In the case of a batch process, it is preferable that stirring is performed, though no specific limitations are placed on the implementation or absence of stirring. Stirring improves the rate of dissolution of polyamide solid.

In the case of a continuous process, the solvent may be caused to continuously flow relative to a solid or the solution may be circulated. Circulation is preferable because the amount of solvent that is used can be reduced.

The vessel shape is not specifically limited, and any shape of vessel such as a tank-type or circulation-type vessel may be used.

The dissolving time is not specifically limited but is preferably 5 minutes to 100 hours.

The concentration of polyamide relative to the solvent is not specifically limited but is preferably 5% to 15%, and more preferably 7% to 13%. A concentration of less than 5 mass % means that too much solvent is required, whereas a concentration of more than 15 mass % results in higher viscosity, longer dissolving time, and poorer operability.

The raw material polyamide composition that serves as a raw material used in the dissolving may be composed of just the polyamide or may have an impurity such as another resin or a metal in a mixed, attached, or applied state. In a case in which impurities other than the polyamide are included, a step of separating the polyamide and these impurities is required. No specific limitations are placed on the method of separation, but in a situation in which the impurities are insoluble in a state in which the polyamide has dissolved, separation can be performed by a method such as filtration, centrifugation, or sedimentation. In a situation in which the impurities dissolve in a solvent together with the polyamide, separation may be performed in a dissolved state by extraction, membrane separation, electrodialysis, or the like, or separation may be performed by washing after precipitation of polyamide in the subsequently described precipitation step.

### <Step 2: Dilution Step>

Step 2 is an optionally performed step of diluting the polyamide that has been dissolved in the solvent in step 1 using methanol.

The method by which the polyamide solution is diluted is described in detail below.

The dilution ratio by the methanol is preferably ×1.5 to ×5. The dilution ratio referred to in the present specification is defined as a value obtained when the weight of the polyamide solution after dilution is divided by the weight of the polyamide solution at the time of dissolution. Note that in a case in which precipitation has occurred in the polyamide solution present after dilution, the weight inclusive of the precipitate is taken to be the weight of the polyamide solution after dilution. When the dilution ratio is less than ×1.5, the precipitated amount of polyamide is small, and the particle diameter thereof also decreases due to insufficient particle growth. A dilution ratio of more than ×5 means that precipitation occurs more readily during dilution and results in a wider particle size distribution.

The temperature during the diluting with methanol is not specifically limited but is preferably 40° C. to 90° C. When the diluting is performed at a lower temperature than 40° C., precipitation readily occurs during dilution. When the diluting is performed at a higher temperature than 90° C., volatilization/condensation of methanol near the liquid surface makes non-uniform precipitation more likely and makes it difficult to control the particle size distribution.

Although no specific limitations are placed on the rate of dilution using methanol, it is preferable that the methanol is added at a rate that does not cause a sudden change of concentration and/or temperature and precipitation of polyamide during dilution.

The temperature of the methanol used in the diluting is not specifically limited but is preferably 15° C. to 90° C. A temperature of lower than 15° C. makes localized precipitation during dilution more likely to occur, whereas a temperature of 90° C. or higher necessitates treatment in a pressurized state since the temperature is higher than the boiling point of methanol.

The water content of the methanol that is used in the diluting is not specifically limited but is preferably 0.005% to 1%. A high water content causes sudden precipitation due to an aqueous solution having lower polyamide solubility.

No specific limitations are placed on the method of dilution. The dilution may be a batch process or a continuous process.

In the case of a batch process, it is preferable that stirring is performed, though no specific limitations are placed on the stirring. Stirring results in more uniform temperature and concentration.

The vessel shape is not specifically limited, and any shape of vessel such as a tank-type or circulation-type vessel may be used.

### <Step 3: Separation Step (Cooling and Precipitation Step)>

Step 3 is a step of separating polyamide from the polyamide solution. The separating of polyamide may be performed through cooling of the polyamide solution to cause precipitation of polyamide and through solid-liquid separation of precipitated solid polyamide from the polyamide solution, for example.

No specific limitations are placed on the method of cooling. The cooling may be a batch process or a continuous process.

In the case of a batch process, it is preferable that stirring is performed, though no specific limitations are placed on the implementation or absence of stirring. Stirring results in more uniform temperature and concentration. According to the instrument and method by which stirring is performed, it is preferable that stirring is performed under conditions that tend not to cause fracturing and shearing of particles through stirring.

The cooling rate is not specifically limited but is preferably 10° C./hr to 100° C./hr, and more preferably 20° C./hr to 50° C./hr. A cooling rate of less than 10° C./hr is time consuming, whereas a cooling rate of more than 100° C./hr results in a smaller particle diameter due to sudden precipitation. The particle diameter can be controlled by altering the cooling rate.

The temperature after cooling is not specifically limited but is preferably at least 10° C. lower than the temperature at the time of dilution. When the temperature difference is less than 10° C., little precipitation occurs, and growth of particles is difficult.

The precipitated solid is preferably recovered by solid-liquid separation.

The method of solid-liquid separation is not specifically limited and may be filtration, centrifugation, sedimentation, or the like. Any of these methods may be a batch process or a continuous process.

The solid obtained by solid-liquid separation is preferably washed using a solvent. Although no specific limitations are placed on the washing solvent, it is preferable to use a solution having a composition corresponding to the liquid portion at the time of precipitation, a good solvent, or a solvent that can dissolve a metal chloride or the like.

The washing solvent is preferably water or an alcohol such as methanol or ethanol.

The washing method is not specifically limited and may be a method in which batch washing is performed, a method in which continuous washing is performed by causing water to flow in a state in which the solid has been loaded into a solid-liquid separation device such as a filter or a centrifuge, a combination of these methods, or the like.

By removing the washing solvent from the polyamide present after washing under heating and/or reduced pressure to yield a dry solid, it is possible to obtain a polyamide composition.

In the presently disclosed method of producing a polyamide composition, the polyamide composition may be obtained as a powder (powdered polyamide composition).

### <Polyamide Composition>

The polyamide composition obtained by the presently disclosed production method may contain an aliphatic polyamide such as polyamide 66 (poly(hexamethylene adipamide)), polyamide 6, polyamide 610, polyamide 6T, or polyamide 6I as the polyamide, preferably contains an aliphatic polyamide as the polyamide, and most preferably contains polyamide 66 (poly(hexamethylene adipamide)) as the polyamide. The polyamide composition obtained by the presently disclosed production method may contain metal atoms and halogen atoms. The metal atoms are metal atoms originating from the metal chloride and/or the hydroxide of the same metal that is contained in the low corrosiveness solvent (methanol composition) used in the presently disclosed production method. For example, the metal atoms may be zinc atoms or calcium atoms, and are preferably calcium atoms. The metal atom content of the polyamide composition obtained by the presently disclosed production method is preferably 0.001 ppm to 1,000 ppm, more preferably 0.001 ppm to 700 ppm, and even more preferably 0.001 ppm to 500 ppm. The molar content of halogen atoms in the polyamide composition obtained by the presently disclosed production method is preferably less than 2, more preferably less than 1, and even more preferably less than 0.5 relative to the molar content of metal atoms. The polyamide composition obtained by the presently disclosed production method may be in the form of a powder.

### <Application of Polyamide Composition>

The polyamide composition obtained by the presently disclosed production method can be used as a material of polyamide fibers. Through spinning of polyamide fibers, it is possible to obtain recycled fibers. Through weaving of the recycled fibers of the present embodiment, it is possible to obtain a recycled woven fabric. The recycled woven fabric of the present embodiment can be used as a polyamide base fabric for a recycled airbag.

### <Spinning of Polyamide Fibers>

The spinning temperature in melt spinning is preferably not lower than 290° C. and not higher than 310° C. Setting the spinning temperature as 310° C. or lower is preferable in order to suppress thermal decomposition of the polyamide, and the spinning temperature is more preferably 300° C. or lower, and even more preferably 295° C. or lower. On the other hand, setting the spinning temperature as 290° C. or higher is preferable because the polyamide displays sufficient melt flowability, there is greater uniformity of the amount of discharge between discharge holes, and high ratio stretching becomes possible.

The residence time (time until polyamide resin melts and is discharged from a spinneret) in the melt spinning process is preferably short. The residence time is preferably 30 minutes or less, more preferably 15 minutes or less, and even more preferably not less than 0.5 minutes and not more than 7 minutes. A short time is preferable because cyclopentanone content in the polymer increases at the melting temperature.

In order to provide thermal stability in high temperature and high humidity environments, it is preferable that a copper compound is added such that the copper concentration is 1 ppm to 500 ppm, and more preferably 30 ppm to 500 ppm relative to the polyamide. Through the above, reduction of mechanical performance is extremely effectively suppressed even upon an item according to the present disclosure being placed in a high temperature and high humidity environment for a long time or being exposed to an environment containing a large amount of ozone for a long time. Heat resistance strength retention decreases with a copper content of less than 30 ppm, whereas strength decreases when the additive amount exceeds 500 ppm.

No specific limitations are placed on the type of copper compound. For example, an organic copper salt such as copper acetate or a copper halide such as cuprous chloride or cupric chloride can preferably be used. The copper compound is more preferably used together with a metal halide. The metal halide may be potassium iodide, potassium bromide, potassium chloride, or the like, for example. Preferable combinations in the present embodiment are cuprous iodide with potassium iodide and copper acetate with potassium iodide. Note that the copper content in the polyamide can be measured by atomic absorption spectroscopy, colorimetry, or the like.

Although no limitation is made to the following, an organic antioxidant such as a hindered phenol antioxidant, a sulfuric antioxidant, or a phosphoric antioxidant, a heat stabilizer, a light stabilizer based on a hindered amine, benzophenone, imidazole, or the like, an ultraviolet absorber, or the like may be added as a stabilizer. The additive amount should be selected as appropriate and can be 1 ppm to 1,000 ppm relative to the polyamide. Not only may one of these additives be used individually, but also a plurality of these additives may be used in combination.

Moreover, in the melt spinning process, it is preferable to use a uniaxial or biaxial extruder in the melt zone. The extruder makes it possible to apply suitable pressure to the polyamide resin while also guiding the polyamide resin to polymer piping, a gear pump, and a spinning pack.

Moreover, it is preferable that the polyamide resin is filtered using a metal fiber non-woven fabric filter, sand, or the like at a stage prior to discharge from a spinneret in order to stabilize spinning operation.

The nozzle shape of the spinneret should be selected according to the cross-sectional shape of monofilament(s) composing the filament that is to be produced. A spun yarn from the spinneret is solidified in cooling air, coated with process oil, and taken up, and is subsequently subjected to stretching and heat treatment to obtain polyamide fibers used in the present disclosure.

The oil attachment rate of the polyamide fibers is preferably 0.5 wt % to 1.5 wt %. When the oil attachment rate is 1.5 wt % or less, there is good weaving stability with almost no difficulty in terms of weft yarn running due to stickiness (tackiness) and no loss of weft yarn conveying force of air or water serving as a weft yarn conveying medium due to the reduction of apparent cross-sectional area when there is excessive single yarn bundling beyond single yarn bundling by entanglement. On the other hand, when the oil attachment rate is 0.5 wt % or more, a suitable friction reduction effect allows smooth supply of the weft yarn, thus resulting in excellent productivity without weaving downtime.

### <Polyamide Base Fabric>

In weaving, a water jet loom, an air jet loom, a rapier loom, or the like can be used as a loom. A base fabric for an airbag is a high-density woven fabric that is preferably produced with increased warp yarn tension in a warping process and a weaving process so as to provide good process throughput. By setting a high warp yarn tension in weaving and creating effective beating conditions, a high-density woven fabric is formed.

Process oil on polyamide fibers of the woven fabric obtained through weaving can be washed off through a scouring process.

In the scouring process, warm water, pressurized hot water, or the like can be selected to perform treatment as a single stage or as multistage treatment including two or more stages. Moreover, it is preferable that the scouring is performed with a commonly known scouring agent applied.

The woven fabric is preferably thermally fixed through a heat setting process. The heat setting temperature is preferably not lower than 110° C. and not higher than 200° C., and the heat setting time should be selected as appropriate from a range of not less than 0.1 minutes and not more than 30 minutes. In the heat setting process, drying is preferably performed while performing tensing such that woven fabric contraction force is maintained as a specific force. Thermal fixing of the woven fabric enables stabilization of processability in a subsequent resin application process.

The woven fabric that has undergone the scouring process may be subjected to drying treatment as necessary prior to the heat setting process. The drying temperature is preferably within a range of not lower than 80° C. and not higher than 130° C., and is more preferably not lower than 100° C. and not higher than 120° C. Moreover, the treatment time is preferably selected as appropriate as a time of not less than 0.1 minutes and not more than 30 minutes. Drying may be performed with the woven fabric in a relaxed state or may be performed with the woven fabric in a tense state.

The polyamide base fabric that has undergone the heat setting process can be used as a non-coated base fabric. Alternatively, a coating agent such as silicon or urethane may be applied or a thin film or the like may be thermally laminated onto the polyamide base fabric.

The method by which the surface of the woven fabric is coated may be a method in which the woven fabric is immersed in a resin solution tank and then a mangle, vacuum, coating knife, or the like is used to perform formation and equalization of excess resin, a method in which bar coating is performed using a comma coater or the like, or a method in which the resin is sprayed against the surface using a spraying device, a forming device, or the like. Of these methods, knife coating is preferable from a viewpoint of uniform application of a small amount of the resin.

The coating weight is not less than 5 g/m² and not more than 100 g/m², more preferably not less than 10 g/m² and not more than 70 g/m², and even more preferably not less than 15 g/m² and not more than 30 g/m². When the coating weight is 5 g/m² or more, the necessary air tightness is obtained. On the other hand, when the coating weight is 100 g/m² or less, the coated woven fabric has flexibility and good ease of storage, and the weight of the overall bag is restricted.

### <Airbag>

The airbag may be selected as appropriate from airbags that are typically used for a driver's seat, passenger's seat, side (inclusive of inflatable curtains), rear seat, or the like. The cut shape of a bag body of the airbag may be a circular shape, an oblong shape, an elliptical shape, a rectangular shape, a polygonal shape, or a combination thereof, for example, and should be a shape that satisfies the shape demanded upon deployment.

The shape of stitching may be a single straight line, a plurality of parallel straight lines, a zig-zag shape, a combination of a straight line and a zig-zag, straight and diagonal lines, or the like. The method of sewing may be a typically used method such as final stitch or double chain stitch, and the sewing pitch may be selected from a range of 20 stitches/10 cm to 60 stitches/10 cm. Moreover, the sewing thread thickness may be selected from 420 d to 3,000 d, and the thread material can be commercially available sewing thread of polyamide fibers, polyester fibers, vinylon-based fibers, aramid-based fibers, glass fibers, or the like.

As set forth above, the present disclosure can provide a solvent that has low corrosiveness and can dissolve polyamide, and this solvent can be used in production of powdered polyamide through dissolution and precipitation of polyamide that is useful as an engineering plastic.

### [Aspect (V)]

The following describes aspect (V) of the present disclosure. Conditions of aspects (I) to (IV), (VI), and (VII) of the present disclosure may be incorporated into aspect (V) of the present disclosure as appropriate.

### <Method of Producing Polyamide>

A method of producing polyamide according to a present embodiment (V) (hereinafter, also referred to as the “method of producing polyamide of the present embodiment” or the “production method of the present embodiment”) includes:
step 1: a dissolution step of heating and dissolving a polyamide resin composition in a metal chloride alcohol solution containing a metal chloride and an alcohol to obtain a polyamide thermal dissolution liquid;
step 2: a recovery step of causing precipitation of polyamide from the polyamide thermal dissolution liquid and recovering the polyamide;
step 3: a washing step of washing the polyamide that has been recovered; and
step 4: a drying step of thermally drying the polyamide present after the washing.

Note that the production method of the present embodiment may be composed of just steps 1 to 4 or may further include other steps.

### (Polyamide)

First, the following describes the polyamide and polyamide resin composition that are used in the production method of the present embodiment.

The polyamide can be a polymer that has been polymerized through amide bonds such as a polymer that has been obtained through polycondensation of a diamine compound and a dicarboxylic acid compound or a polymer that has been obtained through ring-opening polymerization of a cyclic lactam.

The diamine compound may be ethylenediamine, trimethylenediamine, tetramethylenediamine, pentamethylenediamine, hexamethylenediamine, nonanediamine, methylpentanediamine, p-phenylenediamine, or the like without any specific limitations.

The dicarboxylic acid compound may be oxalic acid, malonic acid, succinic acid, glutaric acid, adipic acid, sebacic acid, terephthalic acid, isophthalic acid, or the like without any specific limitations.

The cyclic lactam may be ε-caprolactam, undecanelactam, lauryl lactam, or the like without any specific limitations.

No specific limitations are placed on combinations of the diamine compound, the dicarboxylic acid compound, and the cyclic lactam compound described above, and each of these compounds may be a plurality of types of compounds that are used together. Poly(hexamethylene adipamide) (for example, poly(hexamethylene adipamide) formed from hexamethylenediamine and adipic acid) has high solubility and is suitable for the method of producing polyamide of the present embodiment.

Moreover, the polyamide may be polycaproamide (nylon 6), poly(hexamethylene adipamide) (nylon 66), poly(tetramethylene adipamide) (nylon 46), poly(tetramethylene sebacamide) (nylon 410), poly(pentamethylene adipamide) (nylon 56), poly(pentamethylene sebacamide) (nylon 510), poly(hexamethylene sebacamide) (nylon 610), poly(hexamethylene dodecanamide) (nylon 612), poly(decamethylene adipamide) (nylon 106), poly(decamethylene sebacamide) (nylon 1010), poly(decamethylene dodecanamide) (nylon 1012), polyundecanamide (nylon 11), polydodecanamide (nylon 12), polycaproamide/poly(hexamethylene adipamide) copolymer (nylon 6/66), polycaproamide/poly(hexamethylene terephthalamide) copolymer (nylon 6/6T), poly(hexamethylene adipamide)/poly(hexamethylene terephthalamide) copolymer (nylon 66/6T), poly(hexamethylene adipamide)/poly(hexamethylene isophthalamide) copolymer (nylon 66/6I), poly(hexamethylene terephthalamide)/poly(hexamethylene isophthalamide) copolymer (nylon 6T/6I), poly(hexamethylene terephthalamide)/polyundecanamide copolymer (nylon 6T/11), poly(hexamethylene terephthalamide)/polydodecanamide copolymer (nylon 6T/12), poly(hexamethylene adipamide)/poly(hexamethylene terephthalamide)/poly(hexamethylene isophthalamide) copolymer (nylon 66/6T/6I), poly(xylylene adipamide) (nylon XD6), poly(xylylene sebacamide) (nylon XD10), poly(hexamethylene terephthalamide)/poly(pentamethylene terephthalamide) copolymer (nylon 6T/5T), poly(hexamethylene terephthalamide)/poly(2-methylpentamethylene terephthalamide) copolymer (nylon 6T/M5T), poly(pentamethylene terephthalamide)/poly(decamethylene terephthalamide) copolymer (nylon 5T/10T), poly(nonamethylene terephthalamide) (nylon 9T), poly(decamethylene terephthalamide) (nylon 10T), poly(dodecamethylene terephthalamide) (nylon 12T), or the like, for example. Note that “/” in this description indicates a copolymer. One of these polyamides may be used individually, or two or more of these polyamides may be used in combination.

Of these examples, it is preferable that one selected from the group consisting of polyamide 6, polyamide 66, polyamide 46, polyamide 610, and polyamide 612 is used as the aforementioned polyamide, and particularly preferable that polyamide 66 is used as the aforementioned polyamide. Polyamide 66 itself is a polyamide resin that is already commonly known and is normally produced through polycondensation of hexamethylenediamine and adipic acid. Alternatively, the polyamide 66 may be a copolymer that, relative to the total mass of all monomer units, includes less than 30 mass % of one or more types of monomer units selected from the group consisting of lactams, aminocarboxylic acids, and other combinations of a diamine and a dicarboxylic acid.

Moreover, a commercially available product may be used as any of these polyamides, or a commonly known method may be adopted to produce any of these polyamides. Specific examples of polyamide production methods include, but are not specifically limited to, a method in which ring-opening polymerization of a lactam is performed, a method in which self-condensation of an ω-aminocarboxylic acid is performed, and a method in which condensation of a diamine and a dicarboxylic acid is performed.

Furthermore, a value [NH₂]/[COOH] that is determined by dividing amino terminal group content of the polyamide by carboxy terminal group content of the polyamide is preferably not less than 0.5 and not more than 0.9. When [NH₂]/[COOH] is within the range set forth above, this more sufficiently increases interactions between the surfaces of glass fibers and the terminals of the polyamide during melt kneading and results in the obtained composition having sufficiently high physical properties. The amino terminal group content and the carboxy terminal group content can be measured by ¹H-NMR, for example.

The polyamide may be composed of just the polyamide or may be a polyamide resin composition that contains the polyamide and other components.

For example, an impurity such as another resin or a metal may be mixed, attached, or applied with respect to the polyamide.

The mass proportion of the polyamide relative to 100 mass % of the polyamide resin composition is preferably 30 mass % to 100 mass %, more preferably 70 mass % or more, even more preferably 80 mass % or more, further preferably 85 mass % or more, and particularly preferably 100 mass % from a viewpoint of obtaining powdered polyamide having an even larger particle diameter and an even smaller particle size distribution in a short time.

Note that in a case in which impurities other than the polyamide are included, the method may include a step of separating the polyamide and these impurities. No specific limitations are placed on the method of separation, but in a situation in which the impurities are insoluble in a state in which the polyamide resin composition has dissolved, separation can be performed by a method such as filtration, centrifugation, or sedimentation. In a situation in which the impurities dissolve in a solvent together with the polyamide, separation may be performed in a dissolved state by extraction, membrane separation, electrodialysis, or the like, or separation may be performed by washing after precipitation of polyamide in the subsequently described precipitation step.

### (Step 1: Polyamide Thermal Dissolution Liquid Acquisition Step)

A recovery method of the present embodiment includes a dissolution step (step 1) of heating and dissolving a polyamide resin composition in a metal chloride alcohol solution containing a metal chloride and an alcohol to obtain a polyamide thermal dissolution liquid.

Since melt separation of just the polyamide from the polyamide resin composition is possible through this step, subsequent recovery of the polyamide is simple.

Moreover, since melt separation of just the polyamide is possible by merely mixing the polyamide resin composition with a specific metal chloride alcohol solution, the polyamide can be recovered efficiently and with high yield.

The metal chloride alcohol solution that is used in the heating and dissolving of the polyamide contains a metal chloride and an alcohol. Note that the metal chloride alcohol solution can further contain components other than the metal chloride and the alcohol as necessary.

In particular, from a viewpoint of solubility of the polyamide, the total mass proportion of the metal chloride and the alcohol relative to 100 mass % of the metal chloride alcohol solution is preferably 80 mass % or more, more preferably 90 mass % or more, and even more preferably 100 mass %.

The alcohol may be methanol, ethanol, linear or branched propanol, linear or branched butanol, a combination of any of these alcohols, or the like. Of these alcohols, methanol, ethanol, or a combination thereof is preferable from a viewpoint of polyamide solubility, and methanol is more preferable. Moreover, various types of diols can also be included as the alcohol as necessary.

The mass proportion of the metal chloride relative to 100 mass % of the metal chloride alcohol solution is preferably 10 mass % to 50 mass %, and more preferably 15 mass % to 25 mass %. When this mass proportion is less than 10 mass %, only a small amount of polyamide dissolves, and a large amount of solvent is required. Moreover, when this mass proportion is more than 50 mass %, it becomes more likely that metal chloride will remain without dissolving and become mixed in as an impurity.

The metal chloride may be zinc chloride, magnesium chloride, calcium chloride, or the like, is preferably zinc chloride or calcium chloride, and is most preferably calcium chloride.

The metal chloride is preferably anhydrous. The inclusion of water reduces polyamide solubility. However, a hydrate (for example, a dihydrate in the case of calcium chloride) may be mixed into the metal chloride to the extent that acceptable solubility is obtained.

The mass proportion of water in the metal chloride is preferably 30 mass % or less, more preferably 1 mass % or less, and even more preferably 0.1 mass % or less, and it is particularly preferable that the metal chloride does not contain water.

The temperature during the heating and dissolving is not specifically limited but is preferably 30° C. to 90° C. from viewpoint of solubility, etc., and more preferably 40° C. to 60° C. Note that a low temperature results in slow dissolution, whereas a temperature of higher than 90° C. exceeds the boiling point and is undesirable from viewpoints of corrosion and decomposition.

Also note that the temperature may be constant or may be changed within any of the ranges set forth above.

Dissolution of the polyamide may be a batch process or a continuous process.

In the case of a batch process, it is preferable that stirring is performed, though no specific limitations are placed on the stirring. Stirring improves the rate of dissolution of the polyamide.

In the case of a continuous process, the solvent may be caused to continuously flow relative to a solid or the solution may be caused to circulate. Circulation is preferable because the amount of solvent that is used can be reduced.

The shape of a vessel that is used in the heating and dissolving of the polyamide is not specifically limited, and any shape of vessel such as a tank-type or circulation-type vessel may be used.

The dissolving time of the polyamide is not specifically limited but is preferably 5 minutes to 100 hours.

The mass proportion of the polyamide resin composition relative to the metal chloride alcohol solution in step 1 is not specifically limited but is preferably 3 mass % to 15 mass %, and more preferably 5 mass % to 13 mass %. A mass proportion of less than 3 mass % means that too much solvent is required, whereas a mass proportion of more than 15 mass % results in higher viscosity of the polyamide thermal dissolution liquid, longer dissolving time, and poorer operability.

### (Step 2: Polyamide Precipitation and Recovery Step)

The method of producing polyamide of the present embodiment further includes a recovery step (step 2) of causing polyamide to precipitate from the polyamide thermal dissolution liquid and recovering the polyamide after step 1.

Through this step, it is possible to separate and recover polyamide that is contained in the polyamide thermal dissolution liquid.

No specific limitations are placed on the method by which the polyamide thermal dissolution liquid is caused to precipitate. For example, the polyamide can be caused to precipitate through cooling of the polyamide thermal dissolution liquid.

Note that the step of separating and recovering the polyamide thermal dissolution liquid should be performed after the dissolution step in which the polyamide thermal dissolution liquid is obtained, and may be performed after a step of obtaining an alcohol dilution that is described further below.

No specific limitations are placed on the method of cooling. The cooling may be a batch process or a continuous process.

In the case of a batch process, it is preferable that stirring is performed, though no specific limitations are placed on the implementation or absence of stirring. Stirring results in more uniform temperature and concentration. According to the instrument and method by which stirring is performed, it is preferable that stirring is performed under conditions that tend not to cause fracturing and shearing of particles through stirring.

The cooling rate is not specifically limited but is preferably 10° C./hr to 100° C./hr, and more preferably 20° C./hr to 50° C./hr. A cooling rate of less than 10° C./hr is time consuming, whereas a cooling rate of more than 100° C./hr results in a smaller particle diameter due to sudden precipitation. The particle diameter can be controlled by altering the cooling rate.

The temperature after cooling is not specifically limited but is preferably at least 10° C. lower than the temperature at the time of dilution. When the temperature difference is less than 10° C., little precipitation occurs, and growth of particles is difficult.

The precipitated solid is preferably recovered by solid-liquid separation.

The method of solid-liquid separation is not specifically limited and may be filtration, centrifugation, sedimentation, or the like. Any of these methods may be a batch process or a continuous process.

The solid obtained by solid-liquid separation is preferably washed using a solvent. Although no specific limitations are placed on the washing solvent, it is preferable to use a solution having a composition corresponding to the liquid portion at the time of precipitation, a good solvent, or a solvent that can dissolve a metal chloride or the like.

In a case in which the temperature dependence of solubility during dissolution is small, solubility can also be reduced to cause precipitation by mixing the polyamide thermal dissolution liquid with a poor solvent for polyamide. In this case, the dissolved polyamide is caused to precipitate from the solution to obtain precipitated polyamide after the poor solvent has been added to the solution containing the dissolved polyamide.

The poor solvent may be water or an alcohol such as ethanol, n-propanol, or isopropanol, for example, without any specific limitations. The method by which the poor solvent is added to the polyamide may be a method in which the polyamide-containing solution is added into the poor solvent or a method in which the poor solvent is added into the polyamide-containing solution. No specific limitations are placed on the addition rate, temperature, stirring speed, and so forth during addition.

The additive amount of the poor solvent is not specifically limited but is preferably a mass that is 0.5 to 50 times the mass of the polyamide-containing solution, and more preferably a mass that is 1 to 10 times the mass of the polyamide-containing solution. A smaller additive amount results in a lower recovery rate, whereas a larger additive amount results in a larger amount of solution and necessitates greater time and energy for treatment.

Moreover, in a case in which the temperature dependence of solubility during dissolution is small, polyamide solubility can also be reduced by lowering the concentration of calcium chloride. The method by which methanol is added so as to lower the concentration of calcium chloride is not specifically limited and may be a method in which the polyamide-containing solution is added into methanol or a method in which methanol is added into the polyamide-containing solution. No specific limitations are placed on the addition rate, temperature, stirring speed, and so forth during addition.

The vessel shape is not specifically limited, and any shape of vessel such as a tank-type or circulation-type vessel may be used.

### (Step 3: Polyamide Washing Step)

The method of producing polyamide of the present embodiment further includes a washing step (step 3) of washing the polyamide that has been recovered in step 2.

Through this step, it is possible to remove impurities such as metal chloride from the recovered polyamide.

No specific limitations are placed on the washing liquid used in the washing. For example, a solution having a composition corresponding to the liquid portion at the time of precipitation, a good solvent, or a solvent that can dissolve calcium chloride or the like may be used. Additional washing liquid that is used here may be water or an alcohol such as methanol, ethanol, n-propanol, or isopropanol, for example. The additional washing liquid is preferably methanol. The washing may be performed multiple times as necessary.

The washing method is not specifically limited and may be a method in which batch washing is performed, a method in which continuous washing is performed by causing water to flow in a state in which a solid has been loaded into a solid-liquid separation device such as a filter or a centrifuge, a combination of these methods, or the like.

Note that step 3 is preferably a control step of controlling the amount of metal chloride after drying in the subsequently described step 4.

The amount of metal chloride after drying in the subsequently described step 4 can be controlled by adjusting the type and concentration of the washing liquid, the washing time, and so forth such that the amount of metal chloride after drying in step 4 is within a prescribed range.

### (Step 4: Polyamide Thermal Drying Step)

The method of producing polyamide of the present embodiment further includes a drying step of thermally drying the polyamide present after the washing.

By removing the washing solvent from the polyamide present after washing to yield a dry solid in this step, it is possible to obtain the polyamide.

In the method of producing polyamide of the present embodiment, the amount of metal chloride attached to the polyamide present after the thermal drying of step 4 is set as 20 parts by mass or less relative to 100 parts by mass of the polyamide.

It is preferable to avoid excessive washing in washing of the recovered polyamide from viewpoints such as production efficiency, cost, and environmental consciousness, but, conversely, inadequate washing of the recovered polyamide has also resulted in a problem that some of the polyamide may melt and become stuck together during subsequent drying due to metal chloride that is attached to the polyamide after washing.

Therefore, by setting the amount of metal chloride that is attached to the polyamide after the thermal drying of step 4 as 20 parts by mass or less relative to 100 parts by mass of the polyamide, it is possible to restrict the metal chloride concentration to within a range in which melting of polyamide can be inhibited. In addition, it is preferable for the amount of metal chloride that is attached to the polyamide after the thermal drying of step 4 to be set as 0.01 parts by mass or more relative to 100 parts by mass of the polyamide because this means that excessive washing can be avoided.

From similar viewpoints, the amount of metal chloride that is attached to the polyamide after the thermal drying of step 4 is preferably 0.01 parts by mass to 10 parts by mass, and more preferably 0.01 parts by mass to 5 parts by mass relative to 100 parts by mass of the polyamide.

The measurement method of the amount of metal chloride that is attached to the polyamide after the thermal drying of step 4 is not specifically limited and may, for example, be by sampling a portion and then adopting 1) a method in which measurement is performed by X-ray fluorescence analysis after drying, 2) a method in which measurement is performed by ICP-AES after thermal decomposition using nitric acid, or 3) a method in which metal chloride is extracted using water and then measured by an ion chromatograph.

Note that measurement of the amount of metal chloride that is attached to the polyamide after the thermal drying of step 4 can be performed after the thermal drying of step 4 or can be performed after the washing of the polyamide in the previously described step 3.

A commonly known method can be used as appropriate in measurement of the amount of metal chloride.

### (Step of Measuring and Confirming Amount of Metal Chloride and Second Washing Step)

The method of producing polyamide of the present embodiment preferably further includes a confirmation step of measuring the amount of metal chloride that is attached to the polyamide after the thermal drying of step 4 and confirming whether or not the amount is within a specific range (20 parts by mass or less relative to 100 parts by mass of the polyamide).

This is because through this step, it is possible to confirm the amount of metal chloride that is attached to the polyamide after the thermal drying and to appropriately adjust conditions in the previously described washing, for example.

For example, in a situation in which the amount of metal chloride attached to the polyamide after the washing of step 3 or after the thermal drying of step 4 is confirmed and is less than 0.01 parts by mass relative to 100 parts by mass of the polyamide, this may mean that the washing of step 3 is excessive, and thus the washing conditions (washing time, washing liquid concentration, etc.) can be relaxed.

On the other hand, in a situation in which the amount of metal chloride attached to the polyamide after the washing of step 3 or after the thermal drying of step 4 is confirmed and is more than 20 parts by mass relative to 100 parts by mass of the polyamide, a second washing step of performing washing once again can be implemented because there is considered to be a large amount of metal chloride attached to the polyamide after washing, which can lead to sticking together after thermal drying.

Note that confirmation of whether or not the amount of metal chloride attached to the polyamide is within a range can be performed by sampling a portion of the washed polyamide after the washing of step 3 or a portion of the polyamide present after the thermal drying of step 4, and then measuring the amount of metal chloride that is attached to the polyamide.

### (Recovered Polyamide)

No specific limitations are placed on the form of the recovered polyamide. For example, the recovered polyamide may have a pelletized form obtained through melting and pelletization of polyamide, may have a powdered form as a result of polyamide being dissolved in a solvent and then being caused to precipitate, or may have a tablet form resulting from aggregation of powder according to handling conditions.

Powdered polyamide that is obtained by the production method of the present embodiment has a large particle diameter and a small particle size distribution.

The median diameter of the powdered polyamide is preferably 20 μm or more, and more preferably 30 μm to 70 μm. The median diameter can be measured by a method subsequently described in the EXAMPLES section.

The span of the particle size distribution of the powdered polyamide, which is a value 10^{S} determined by using S expressed by the following formula (1) to raise 10 to the power S, is preferably 5 or less, more preferably 4 or less, and even more preferably 3 or less.

$$S = log ( d 90 / d 10 ) / log ( d 50 ) \qquad ( 1 )$$

(In formula (1), dn (where n represents 10, 50, or 90) indicates the particle diameter at which, in measurement of a particle size distribution of the powdered polyamide by laser diffraction/scattering, the number of particles having a particle diameter of smaller than dn is n % relative to the total number of particles.)

The particle size distribution can be measured by a method subsequently described in the EXAMPLES section.

Moreover, polyamide fibers can be produced through melt spinning of the obtained polyamide.

The spinning temperature in the melt spinning is preferably not lower than 290° C. and not higher than 310° C. Setting the spinning temperature as 310° C. or lower is preferable in order to suppress thermal decomposition of the polyamide, and the spinning temperature is more preferably 300° C. or lower, and even more preferably 295° C. or lower. On the other hand, setting the spinning temperature as 290° C. or higher is preferable because the polyamide displays sufficient melt flowability, there is greater uniformity of the amount of discharge between discharge holes, and high ratio stretching becomes possible.

The residence time (time until polyamide resin melts and is discharged from a spinneret) in the melt spinning process is preferably short. The residence time is preferably 30 minutes or less, more preferably 15 minutes or less, and even more preferably not less than 0.5 minutes and not more than 7 minutes. A short time is preferable because cyclopentanone content in the polymer increases at the melting temperature.

In order to provide thermal stability in high temperature and high humidity environments, it is preferable that a copper compound is added such that the copper concentration is 1 ppm to 500 ppm, and more preferably 30 ppm to 500 ppm relative to the polyamide. Through the above, reduction of mechanical performance is extremely effectively suppressed even upon placement in a high temperature and high humidity environment for a long time or exposure to an environment containing a large amount of ozone for a long time. Heat resistance strength retention decreases with a copper content of less than 30 ppm, whereas strength decreases when the additive amount exceeds 500 ppm.

No specific limitations are placed on the type of copper compound. For example, an organic copper salt such as copper acetate or a copper halide such as cuprous chloride or cupric chloride can preferably be used. The copper compound is more preferably used together with a metal halide. The metal halide may be potassium iodide, potassium bromide, potassium chloride, or the like, for example. Preferable combinations in the present embodiment are cuprous iodide with potassium iodide and copper acetate with potassium iodide. Note that the copper content in the polyamide can be measured by atomic absorption spectroscopy, colorimetry, or the like.

Although no limitation is made to the following, an organic antioxidant such as a hindered phenol antioxidant, a sulfuric antioxidant, or a phosphoric antioxidant, a heat stabilizer, a light stabilizer based on a hindered amine, benzophenone, imidazole, or the like, an ultraviolet absorber, or the like may be added as a stabilizer. The additive amount should be selected as appropriate and can be 1 ppm to 1,000 ppm relative to the polyamide. Not only may one of these additives be used individually, but also a plurality of these additives may be used in combination.

Moreover, in the melt spinning process, it is preferable to use a uniaxial or biaxial extruder in the melt zone. The extruder makes it possible to apply suitable pressure to the polyamide resin while also guiding the polyamide resin to polymer piping, a gear pump, and a spinning pack.

Moreover, it is preferable that the polyamide resin is filtered using a metal fiber non-woven fabric filter, sand, or the like at a stage prior to discharge from a spinneret in order to stabilize spinning operation.

The nozzle shape of the spinneret should be selected according to the cross-sectional shape of monofilament(s) composing the filament that is to be produced. A spun yarn from the spinneret is solidified in cooling air, coated with process oil, and taken up, and is subsequently subjected to stretching and heat treatment to obtain polyamide fibers.

Moreover, it is preferable that the polyamide resin is filtered using a metal fiber non-woven fabric filter, sand, or the like at a stage prior to discharge from the spinneret in order to stabilize spinning operation.

The nozzle shape of the spinneret should be selected according to the cross-sectional shape of monofilament(s) composing the filament that is to be produced. A spun yarn from the spinneret is solidified in cooling air, coated with process oil, and taken up, and is subsequently subjected to stretching and heat treatment to obtain polyamide fibers.

Note that the oil attachment rate of the polyamide fibers is preferably 0.5 wt % to 1.5 wt %. When the oil attachment rate is 1.5 wt % or less, there is good weaving stability with almost no difficulty in terms of weft yarn running due to stickiness (tackiness) and no loss of weft yarn conveying force of air or water serving as a weft yarn conveying medium due to the reduction of apparent cross-sectional area when there is excessive single yarn bundling beyond single yarn bundling by entanglement. On the other hand, when the oil attachment rate is 0.5 wt % or more, a suitable friction reduction effect allows smooth supply of the weft yarn, thus resulting in excellent productivity without weaving downtime.

### (Polyamide Base Fabric)

Polyamide obtained through the production method of the present embodiment can be subjected to melt spinning and then be used to obtain a polyamide base fabric.

In weaving, a water jet loom, an air jet loom, a rapier loom, or the like can be used as a loom. A base fabric for an airbag is a high-density woven fabric that is preferably produced with increased warp yarn tension in a warping process and a weaving process so as to provide good process throughput. By setting a high warp yarn tension in weaving and creating effective beating conditions, a high-density woven fabric is formed.

Process oil on polyamide fibers of the woven fabric obtained through weaving can be washed off through a scouring process.

In the scouring process, warm water, pressurized hot water, or the like can be selected to perform treatment as a single stage or as multistage treatment including two or more stages. Moreover, it is preferable that the scouring is performed with a commonly known scouring agent applied.

The woven fabric is preferably thermally fixed through a heat setting process. The heat setting temperature is preferably not lower than 110° C. and not higher than 200° C., and the heat setting time should be selected as appropriate from a range of not less than 0.1 minutes and not more than 30 minutes. In the heat setting process, drying is preferably performed while performing tensing such that woven fabric contraction force is maintained as a specific force. Thermal fixing of the woven fabric enables stabilization of processability in a subsequent resin application process.

The woven fabric that has undergone the scouring process may be subjected to drying treatment as necessary prior to the heat setting process. The drying temperature is preferably within a range of not lower than 80° C. and not higher than 130° C., and is more preferably not lower than 100° C. and not higher than 120° C. Moreover, the treatment time is preferably selected as appropriate as a time of not less than 0.1 minutes and not more than 30 minutes. Drying may be performed with the woven fabric in a relaxed state or may be performed with the woven fabric in a tense state.

The polyamide base fabric that has undergone the heat setting process can be used as a non-coated base fabric. Alternatively, a coating agent such as silicone or urethane may be applied or a thin film or the like may be thermally laminated onto the polyamide base fabric.

The method by which the surface of the woven fabric is coated may be a method in which the woven fabric is immersed in a resin solution tank and then a mangle, vacuum, coating knife, or the like is used to perform formation and equalization of excess resin, a method in which bar coating is performed using a comma coater or the like, or a method in which the resin is sprayed against the surface using a spraying device, a forming device, or the like. Of these methods, knife coating is preferable from a viewpoint of uniform application of a small amount of the resin.

The coating weight is not less than 5 g/m² and not more than 100 g/m², more preferably not less than 10 g/m² and not more than 70 g/m², and even more preferably not less than 15 g/m² and not more than 30 g/m². When the coating weight is 5 g/m² or more, the necessary air tightness is obtained. On the other hand, when the coating weight is 100 g/m² or less, the coated woven fabric has flexibility and good ease of storage, and the weight of the overall bag is restricted.

### [Aspect (VI)]

The following describes aspect (VI) of the present disclosure. Conditions of aspects (I) to (V) and (VII) of the present disclosure may be incorporated into aspect (VI) of the present disclosure as appropriate.

<Method of Producing Polyamide and/or Polyethylene Terephthalate>

A method of producing polyamide, a method of producing polyethylene terephthalate, and a method of producing polyamide and polyethylene terephthalate according to a present embodiment (VI) (hereinafter, also referred to simply as the “production method of the present embodiment”) are each a method of producing polyamide and/or polyethylene terephthalate by recovering polyamide and/or polyethylene terephthalate from a mixed material of polyamide and polyethylene terephthalate, wherein the method includes: a step of mixing the mixed material with a metal chloride alcohol solution containing a metal chloride and an alcohol to obtain a polyamide dissolution liquid in which the polyamide has dissolved; and a step of separating and recovering the polyamide dissolution liquid and/or the polyethylene terephthalate.

### (Mixed Material of Polyamide and Polyethylene Terephthalate)

First, the following describes the mixed material that is used in the production method of the present embodiment.

The mixed material that is used as a material in the production method of the present embodiment is a mixed material of polyamide and polyethylene terephthalate. Note that the mixed material should contain at least polyamide and polyethylene terephthalate and can contain other components as necessary.

Examples of other components include, but are not specifically limited to, a component that coats a mixed material of polyamide and polyethylene terephthalate and a component that is applied onto the mixed material. The coating component may be a resin, and examples thereof include, but are not limited to, a silicone resin, a urethane resin, and so forth. The applied component may be a lubricant or the like.

Although no specific limitations are placed on the shape, etc. of the mixed material, the mixed material is preferably a woven fabric (from a water jet loom, an air jet loom, a rapier loom, a base fabric for an airbag, or the like), and is more preferably an airbag member in terms that the effects according to the present disclosure can be received to a greater extent.

In a case in which the mixed material is a high-density woven fabric such as a base fabric for an airbag, fibers formed of the polyamide and fibers formed of the polyethylene terephthalate are entangled with one another, which makes it difficult to achieve adequate separation by conventional separation methods. In contrast, dissolution and separation of polyamide in the present embodiment enable recovery of polyamide and/or polyethylene terephthalate from the mixed material and thus enable recovery of polyamide and/or polyethylene terephthalate with high efficiency and high yield even in a case in which the mixed material is a woven fabric.

### Polyamide

The polyamide can be a polymer that has been polymerized through amide bonds such as a polymer that has been obtained through polycondensation of a diamine compound and a dicarboxylic acid compound or a polymer that has been obtained through ring-opening polymerization of a cyclic lactam.

The diamine compound may be ethylenediamine, trimethylenediamine, tetramethylenediamine, pentamethylenediamine, hexamethylenediamine, nonanediamine, methylpentanediamine, p-phenylenediamine, or the like without any specific limitations.

The dicarboxylic acid compound may be oxalic acid, malonic acid, succinic acid, glutaric acid, adipic acid, sebacic acid, terephthalic acid, isophthalic acid, or the like without any specific limitations.

The cyclic lactam may be ε-caprolactam, undecanelactam, lauryl lactam, or the like without any specific limitations.

No specific limitations are placed on combinations of the diamine compound, the dicarboxylic acid compound, and the cyclic lactam compound described above, and each of these compounds may be a plurality of types of compounds that are used together. Poly(hexamethylene adipamide) (for example, poly(hexamethylene adipamide) formed from hexamethylenediamine and adipic acid) has high solubility and is suitable for the method of producing polyamide of the present embodiment.

No specific limitations are placed on the method by which the particle diameter and particle size distribution of powdered polyamide are measured, and methods such as laser diffraction, laser scattering, centrifugal sedimentation, particle tracking, and dynamic light scattering may be adopted.

Moreover, the polyamide may be polycaproamide (nylon 6), poly(hexamethylene adipamide) (nylon 66), poly(tetramethylene adipamide) (nylon 46), poly(tetramethylene sebacamide) (nylon 410), poly(pentamethylene adipamide) (nylon 56), poly(pentamethylene sebacamide) (nylon 510), poly(hexamethylene sebacamide) (nylon 610), poly(hexamethylene dodecanamide) (nylon 612), poly(decamethylene adipamide) (nylon 106), poly(decamethylene sebacamide) (nylon 1010), poly(decamethylene dodecanamide) (nylon 1012), polyundecanamide (nylon 11), polydodecanamide (nylon 12), polycaproamide/poly(hexamethylene adipamide) copolymer (nylon 6/66), polycaproamide/poly(hexamethylene terephthalamide) copolymer (nylon 6/6T), poly(hexamethylene adipamide)/poly(hexamethylene terephthalamide) copolymer (nylon 66/6T), poly(hexamethylene adipamide)/poly(hexamethylene isophthalamide) copolymer (nylon 66/6I), poly(hexamethylene terephthalamide)/poly(hexamethylene isophthalamide) copolymer (nylon 6T/6I), poly(hexamethylene terephthalamide)/polyundecanamide copolymer (nylon 6T/11), poly(hexamethylene terephthalamide)/polydodecanamide copolymer (nylon 6T/12), poly(hexamethylene adipamide)/poly(hexamethylene terephthalamide)/poly(hexamethylene isophthalamide) copolymer (nylon 66/6T/6I), poly(xylylene adipamide) (nylon XD6), poly(xylylene sebacamide) (nylon XD10), poly(hexamethylene terephthalamide)/poly(pentamethylene terephthalamide) copolymer (nylon 6T/5T), poly(hexamethylene terephthalamide)/poly(2-methylpentamethylene terephthalamide) copolymer (nylon 6T/M5T), poly(pentamethylene terephthalamide)/poly(decamethylene terephthalamide) copolymer (nylon 5T/10T), poly(nonamethylene terephthalamide) (nylon 9T), poly(decamethylene terephthalamide) (nylon 10T), poly(dodecamethylene terephthalamide) (nylon 12T), or the like, for example. Note that “/” in this description indicates a copolymer. One of these polyamides may be used individually, or two or more of these polyamides may be used in combination.

Of these examples, it is preferable that one selected from the group consisting of polyamide 6, polyamide 66, polyamide 46, polyamide 610, and polyamide 612 is used as the aforementioned polyamide, and particularly preferable that polyamide 66 is used as the aforementioned polyamide. Polyamide 66 itself is a polyamide resin that is already commonly known and is normally produced through polycondensation of hexamethylenediamine and adipic acid. Alternatively, the polyamide 66 may be a copolymer that, relative to the total mass of all monomer units, includes less than 30 mass % of one or more types of monomer units selected from the group consisting of lactams, aminocarboxylic acids, and other combinations of a diamine and a dicarboxylic acid.

Moreover, a commercially available product may be used as any of these polyamides, or a commonly known method may be adopted to produce any of these polyamides. Specific examples of polyamide production methods include, but are not specifically limited to, a method in which ring-opening polymerization of a lactam is performed, a method in which self-condensation of an ω-aminocarboxylic acid is performed, and a method in which condensation of a diamine and a dicarboxylic acid is performed.

Furthermore, a value [NH₂]/[COOH] that is determined by dividing amino terminal group content of the polyamide by carboxy terminal group content of the polyamide is preferably not less than 0.5 and not more than 0.9. When [NH₂]/[COOH] is within the range set forth above, this more sufficiently increases interactions between the surfaces of glass fibers and the terminals of the polyamide during melt kneading and results in the obtained composition having sufficiently high physical properties. The amino terminal group content and the carboxy terminal group content can be measured by ¹H-NMR, for example.

The polyamide may be composed of just the polyamide or may be a polyamide resin composition that contains the polyamide and other components. For example, an impurity such as another resin or a metal may be mixed, attached, or applied as another component with respect to the polyamide.

The mass proportion of polyamide relative to 100 mass % of the polyamide is preferably 30 mass % to 100 mass %, more preferably 70 mass % or more, even more preferably 80 mass % or more, further preferably 85 mass % or more, and particularly preferably 100 mass % from a viewpoint of obtaining powdered polyamide having an even larger particle diameter and an even smaller particle size distribution in a short time.

Note that in a case in which impurities other than the polyamide are included, the method may include a step of separating the polyamide and these impurities. No specific limitations are placed on the method of separation, but in a situation in which the impurities are insoluble in a state in which the polyamide resin composition has dissolved, separation can be performed by a method such as filtration, centrifugation, or sedimentation. In a situation in which the impurities dissolve in a solvent together with the polyamide, separation may be performed in a dissolved state by extraction, membrane separation, electrodialysis, or the like, or separation may be performed by washing after precipitation of polyamide in the subsequently described precipitation step.

### Polyethylene Terephthalate

The polyethylene terephthalate (PET) that is a constituent of the mixed material normally has the structure illustrated below.

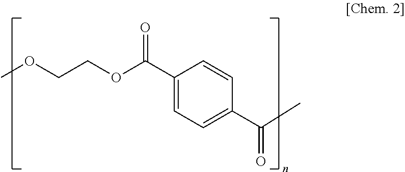

Note that the polyethylene terephthalate can be present as fibrous PET in the mixed material. The fibrous PET can be obtained by further performing solid phase polymerization and spinning of a PET resin to obtain fibrous polyethylene terephthalate.

The polyethylene terephthalate may be composed of just polyethylene terephthalate or may be a polyethylene terephthalate resin composition that contains the polyethylene terephthalate and other components. For example, an impurity such as another resin or a metal may be mixed, attached, or applied as another component with respect to the polyethylene terephthalate.

### (Step of Obtaining Polyamide Dissolution Liquid)

The production method of the present embodiment includes a step of mixing the mixed material with a metal chloride alcohol solution containing a metal chloride and an alcohol to obtain a polyamide dissolution liquid in which the polyamide has dissolved.

Through this step, melt separation of just the polyamide from the mixed material of the polyamide and the polyethylene terephthalate is possible, thus making subsequent recovery of the polyamide and/or the polyethylene terephthalate simple. Moreover, since melt separation of just the polyamide is possible by merely mixing the mixed material with a specific metal chloride alcohol solution, the polyamide and/or the polyethylene terephthalate can be recovered efficiently and with high yield.

The metal chloride alcohol solution that is used to dissolve the polyamide contains a metal chloride and an alcohol. Note that the metal chloride alcohol solution can contain components other than the metal chloride and the alcohol as necessary.

In particular, from a viewpoint of solubility of the polyamide, the total mass proportion of the metal chloride and the alcohol relative to 100 mass % of the metal chloride alcohol solution is preferably 80 mass % or more, more preferably 90 mass % or more, and even more preferably 100 mass %.

The alcohol may be methanol, ethanol, linear or branched propanol, linear or branched butanol, a combination of any thereof, or the like. Of these alcohols, methanol, ethanol, or a combination thereof is preferable from a viewpoint of polyamide solubility, and methanol is more preferable. Moreover, various types of diols can also be included as the alcohol as necessary.

The mass proportion of the metal chloride relative to 100 mass % of the metal chloride alcohol solution is preferably 10 mass % to 50 mass %, and more preferably 15 mass % to 25 mass %. When this mass proportion is less than 10 mass %, only a small amount of polyamide dissolves, and a large amount of solvent is required. Moreover, when this mass proportion is more than 50 mass %, it becomes more likely that metal chloride will remain without dissolving and become mixed in as an impurity.

The metal chloride may be zinc chloride, magnesium chloride, calcium chloride, or the like, is preferably zinc chloride or calcium chloride, and is most preferably calcium chloride.

The metal chloride is preferably anhydrous. The inclusion of water reduces polyamide solubility. However, a hydrate (for example, a dihydrate in the case of calcium chloride) may be mixed into the metal chloride to the extent that acceptable solubility is obtained.

The mass proportion of water in the metal chloride is preferably 30 mass % or less, more preferably 1 mass % or less, and even more preferably 0.1 mass % or less, and it is particularly preferable that the metal chloride does not contain water.

The temperature during mixing of the mixed material and the metal chloride alcohol solution in the step of obtaining the polyamide dissolution liquid is preferably 30° C. to 90° C., and more preferably 40° C. to 60° C. Note that a low temperature results in slow dissolution, whereas a temperature of higher than 90° C. exceeds the boiling point and is undesirable from viewpoints of corrosion and decomposition.

Also note that the temperature may be constant or may be changed within any of the ranges set forth above.

Dissolution of the polyamide may be a batch process or a continuous process.

In the case of a batch process, it is preferable that stirring is performed, though no specific limitations are placed on the stirring. Stirring improves the rate of dissolution of the polyamide.

In the case of a continuous process, the solvent may be caused to continuously flow relative to a solid or the solution may be caused to circulate. Circulation is preferable because the amount of solvent that is used can be reduced.

The shape of a vessel that is used in the mixing of the mixed material of the polyamide and the polyethylene terephthalate with the metal chloride alcohol solution and in the dissolving of the polyamide is not specifically limited, and any shape of vessel such as a tank-type or circulation-type vessel may be used.

The dissolving time of the polyamide is not specifically limited but is preferably 5 minutes to 100 hours.

In the step of obtaining the polyamide dissolution liquid, the mass proportion of the polyamide in the mixed material relative to the metal chloride alcohol solution is not specifically limited but is preferably 3 mass % to 15 mass %, and more preferably 5 mass % to 13 mass %. A mass proportion of less than 3 mass % means that too much solvent is required, whereas a mass proportion of more than 15 mass % results in higher viscosity of the polyamide dissolution liquid, longer dissolving time, and poorer operability.

### (Step of Separating and Recovering Polyamide Dissolution Liquid)

In the method of producing polyamide and the method of producing polyamide and polyethylene terephthalate of the present embodiment, a step of separating and recovering the polyamide dissolution liquid is further included after the step of obtaining the polyamide dissolution liquid.

Through this step, it is possible to separate polyamide contained in the polyamide dissolution liquid from polyethylene terephthalate that remains without dissolving and to recover the polyamide.

Although no specific limitations are placed on the method by which the polyamide dissolution liquid is separated and recovered, it is possible to separate and recover just the polyamide by removing the polyethylene terephthalate that remains without dissolving in the polyamide dissolution liquid through filtration or the like.

Note that the step of separating and recovering the polyamide dissolution liquid should be performed after the step of obtaining the polyamide dissolution liquid, and may be performed after the subsequently described step of obtaining an alcohol dilution. For example, dilution may be performed in a high temperature state, separation may be performed in a state in which polyamide does not precipitate, and then cooling may be performed in order to recover polyamide.

Note that in the production method of the present embodiment, concentrating of a metal chloride alcohol solution can be further performed from a viewpoint of reusing the metal chloride alcohol solution.

For example, a metal alcohol solution containing a metal chloride and an alcohol that has been obtained through the polyamide recovery step may be concentrated and reused. The method by which the concentrating is performed may be concentrating through heating, for example.

### (Step of Separating and Recovering Polyethylene Terephthalate)

In the method of producing polyethylene terephthalate and the method of producing polyamide and polyethylene terephthalate of the present embodiment, a step of separating and recovering the polyethylene terephthalate is further included after the step of obtaining the polyamide dissolution liquid.

Through this step, it is possible to separate polyethylene terephthalate that remains without dissolving from the polyamide contained in the polyamide dissolution liquid and to recover the polyethylene terephthalate.

The method by which the polyethylene terephthalate is separated and recovered can be by removing polyethylene terephthalate that remains without dissolving in the polyamide dissolution liquid by a means such as filtration so as to separate and recover the polyethylene terephthalate, but is not specifically limited thereto.

Note that the step of separating and recovering the polyethylene terephthalate should be performed after the step of obtaining the polyamide dissolution liquid, and may be performed after the subsequently described step of obtaining an alcohol dilution.

### (Step of Precipitating and Recovering Polyamide)

The production method of the present embodiment preferably further includes a step of precipitating and recovering polyamide after the step of obtaining the polyamide dissolution liquid or after the step of separating and recovering the polyamide dissolution liquid and/or the polyethylene terephthalate.

Although polyamide may be recovered from the polyamide dissolution liquid, it is preferable that polyamide is caused to precipitate from the polyamide dissolution liquid and is subsequently recovered from a viewpoint of further improving recovery efficiency.

The method by which polyamide is recovered from the polyamide-containing solution may be a method in which polyamide is caused to precipitate. No specific limitations are placed on the method by which polyamide is caused to precipitate from the polyamide-containing solution, and a number of precipitation methods can be adopted depending on the dissolved state.

In a case in which the dissolving is performed through heating, precipitation may be performed through cooling by exploiting the temperature dependence of polyamide solubility. In this case, the dissolved polyamide is caused to precipitate from the solution to obtain precipitated polyamide without adding an additional solvent to the solution containing the dissolved polyamide.

In a case in which the temperature dependence of solubility during dissolution is small, the solubility can alternatively be reduced to cause precipitation through mixing of the polyamide-containing solution with a poor solvent for polyamide. In this case, the dissolved polyamide is caused to precipitate from the solution to obtain precipitated polyamide after the poor solvent has been added to the solution containing the dissolved polyamide. The poor solvent may be water or an alcohol such as ethanol, n-propanol, or isopropanol, for example, without any specific limitations. The method by which the poor solvent is added to the polyamide may be a method in which the polyamide-containing solution is added into the poor solvent or a method in which the poor solvent is added into the polyamide-containing solution. No specific limitations are placed on the addition rate, temperature, stirring speed, and so forth during addition.

The additive amount of the poor solvent is not specifically limited but is preferably a mass that is 0.5 to 50 times the mass of the polyamide-containing solution, and more preferably a mass that is 1 to 10 times the mass of the polyamide-containing solution. A smaller additive amount results in a lower recovery rate, whereas a larger additive amount results in a larger amount of solution and necessitates greater time and energy for treatment.

In a case in which the temperature dependence of solubility during dissolution is small, polyamide solubility can also be reduced by lowering the concentration of calcium chloride. The method by which methanol is added so as to lower the concentration of calcium chloride is not specifically limited and may be a method in which the polyamide-containing solution is added into methanol or a method in which methanol is added into the polyamide-containing solution. No specific limitations are placed on the addition rate, temperature, stirring speed, and so forth during addition.

The vessel shape is not specifically limited, and any shape of vessel such as a tank-type or circulation-type vessel may be used.

Note that the precipitated polyamide is preferably recovered by solid-liquid separation. The method of solid-liquid separation may be filtration, centrifugation, sedimentation, or the like, for example. A batch process or a continuous process may be adopted in any of these methods.

The polyamide obtained by solid-liquid separation is preferably washed using a solvent. No specific limitations are placed on the washing liquid. For example, a solution having a composition corresponding to the liquid portion at the time of precipitation, a good solvent, or a solvent that can dissolve calcium chloride or the like can be used as the washing liquid. Additional washing liquid that is used here may be water or an alcohol such as methanol, ethanol, n-propanol, or isopropanol, for example. The additional washing liquid is preferably methanol. The washing may be performed multiple times as necessary.

The washing method is not specifically limited and may be a method in which batch washing is performed, a method in which continuous washing is performed by causing water to flow in a state in which a solid has been loaded into a solid-liquid separation device such as a filter or a centrifuge, a combination of these methods, or the like.

By removing the washing solvent from the polyamide present after washing under heating and/or reduced pressure to yield a dry solid, it is possible to obtain powdered polyamide.

No specific limitations are placed on the form of the recovered polyamide. For example, the recovered polyamide may have a pelletized form obtained through melting and pelletization of polyamide, may have a powdered form as a result of polyamide being dissolved in a solvent and then being caused to precipitate, or may have a tablet form resulting from aggregation of powder according to handling conditions.

### (Spinning of Polyamide Fibers)

Polyamide fibers can be produced through melt spinning of the obtained polyamide.

The spinning temperature in melt spinning is preferably not lower than 290° C. and not higher than 310° C. Setting the spinning temperature as 310° C. or lower is preferable in order to suppress thermal decomposition of the polyamide, and the spinning temperature is more preferably 300° C. or lower, and even more preferably 295° C. or lower. On the other hand, setting the spinning temperature as 290° C. or higher is preferable because the polyamide displays sufficient melt flowability, there is greater uniformity of the amount of discharge between discharge holes, and high ratio stretching becomes possible.

The residence time (time until polyamide resin melts and is discharged from a spinneret) in the melt spinning process is preferably short. The residence time is preferably 30 minutes or less, more preferably 15 minutes or less, and even more preferably not less than 0.5 minutes and not more than 7 minutes. A short time is preferable because cyclopentanone content in the polymer increases at the melting temperature.

In order to provide thermal stability in high temperature and high humidity environments, it is preferable that a copper compound is added such that the copper concentration is 1 ppm to 500 ppm, and more preferably 30 ppm to 500 ppm relative to the polyamide. Through the above, reduction of mechanical performance is extremely effectively suppressed even upon placement in a high temperature and high humidity environment for a long time or exposure to an environment containing a large amount of ozone for a long time. Heat resistance strength retention decreases with a copper content of less than 30 ppm, whereas strength decreases when the additive amount exceeds 500 ppm.

No specific limitations are placed on the type of copper compound. For example, an organic copper salt such as copper acetate or a copper halide such as cuprous chloride or cupric chloride can preferably be used. The copper compound is more preferably used together with a metal halide. The metal halide may be potassium iodide, potassium bromide, potassium chloride, or the like, for example. Preferable combinations in the present embodiment are cuprous iodide with potassium iodide and copper acetate with potassium iodide. Note that the copper content in the polyamide can be measured by atomic absorption spectroscopy, colorimetry, or the like.

Although no limitation is made to the following, an organic antioxidant such as a hindered phenol antioxidant, a sulfuric antioxidant, or a phosphoric antioxidant, a heat stabilizer, a light stabilizer based on a hindered amine, benzophenone, imidazole, or the like, an ultraviolet absorber, or the like may be added as a stabilizer. The additive amount should be selected as appropriate and can be 1 ppm to 1,000 ppm relative to the polyamide. Not only may one of these additives be used individually, but also a plurality of these additives may be used in combination.

Moreover, in the melt spinning process, it is preferable to use a uniaxial or biaxial extruder in the melt zone. The extruder makes it possible to apply suitable pressure to the polyamide resin while also guiding the polyamide resin to polymer piping, a gear pump, and a spinning pack.

Moreover, it is preferable that the polyamide resin is filtered using a metal fiber non-woven fabric filter, sand, or the like at a stage prior to discharge from the spinneret in order to stabilize spinning operation.

The nozzle shape of the spinneret should be selected according to the cross-sectional shape of monofilament(s) composing the filament that is to be produced. A spun yarn from the spinneret is solidified in cooling air, coated with process oil, and taken up, and is subsequently subjected to stretching and heat treatment to obtain polyamide fibers.

Moreover, it is preferable that the polyamide resin is filtered using a metal fiber non-woven fabric filter, sand, or the like at a stage prior to discharge from the spinneret in order to stabilize spinning operation.

The nozzle shape of the spinneret should be selected according to the cross-sectional shape of monofilament(s) composing the filament that is to be produced. A spun yarn from the spinneret is solidified in cooling air, coated with process oil, and taken up, and is subsequently subjected to stretching and heat treatment to obtain polyamide fibers.

### [Aspect (VII)]

The following describes aspect (VII) of the present disclosure. Conditions of aspects (I) to (VI) of the present disclosure may be incorporated into aspect (VII) of the present disclosure as appropriate.

A method of producing recycled polyamide of a present embodiment (VII) is a method of producing recycled polyamide using a mixture containing polyamide coated with a urethane resin as a raw material, wherein the method includes a dissolution step of mixing a metal chloride alcohol solution containing a metal chloride and an alcohol with the mixture to dissolve the polyamide and obtain a polyamide dissolution liquid, and a mass proportion of polyamide in the polyamide dissolution liquid in the dissolution step is 5 mass % to 15 mass %.

Moreover, a method of producing recycled polyamide of another present embodiment (VII) is a method of producing recycled polyamide using a mixture containing polyamide coated with a urethane resin as a raw material, wherein the method includes a dissolution step of mixing a metal chloride alcohol solution containing a metal chloride and an alcohol with the mixture to dissolve the polyamide and obtain a polyamide dissolution liquid, and viscosity at 25° C. of the polyamide dissolution liquid in the dissolution step is 10 mPa·s to 20,000 mPa·s.

The production method of the present embodiment (VII) may be a method of producing recycled polyamide through a step of dissolving and extracting polyamide from a polyamide base fabric that is coated with urethane using a metal chloride alcohol solution having a controlled water content, for example.

The following describes compounds, etc. that are used in the production method of the present embodiment (VII).

### <Mixture>

### (Polyamide)

The polyamide can be a polymer that has been polymerized through amide bonds such as a polymer that has been obtained through polycondensation of a diamine compound and a dicarboxylic acid compound or a polymer that has been obtained through ring-opening polymerization of a cyclic lactam.

The diamine compound may be ethylenediamine, trimethylenediamine, tetramethylenediamine, pentamethylenediamine, hexamethylenediamine, nonanediamine, methylpentanediamine, p-phenylenediamine, or the like without any specific limitations.

The dicarboxylic acid compound may be oxalic acid, malonic acid, succinic acid, glutaric acid, adipic acid, sebacic acid, terephthalic acid, isophthalic acid, or the like without any specific limitations.

The cyclic lactam may be ε-caprolactam, undecanelactam, lauryl lactam, or the like without any specific limitations.

No specific limitations are placed on combinations of the diamine compound, the dicarboxylic acid compound, and the cyclic lactam compound described above, and each of these compounds may be a plurality of types of compounds that are used together. Poly(hexamethylene adipamide) (for example, poly(hexamethylene adipamide) formed from hexamethylenediamine and adipic acid) has high solubility and is suitable for the method of producing polyamide of the present embodiment.

The mixture contains polyamide coated with a urethane resin. The mixture may be composed of just the polyamide coated with the urethane resin or may further contain other components.

In particular, from a viewpoint of production efficiency of recycled polyamide, the mass proportion of the polyamide coated with the urethane resin is preferably 30 mass % to 100 mass %, more preferably 60 mass % or more, even more preferably 70 mass % or more, and particularly preferably 80 mass % or more relative to 100 mass % of the mixture.

The polyurethane resin is obtained through a reaction of a polyol component and a polyisocyanate component. The polyol component may be a polycarbonate polyol, a polyester polyol, a polyether polyol, or the like.

The urethane resin may be a polyester-based polyurethane resin, a polyether-based polyurethane resin, a polycarbonate-based polyurethane resin, or the like without any specific limitations. A crosslinker formed of an epoxy, melamine, polyfunctional isocyanate, or the like, a carbodiimide-based hydrolysis inhibitor, a phenol or aromatic amine antioxidant, an ultraviolet absorber such as a salicylic acid-based, benzophenone-based, or benzotriazole-based derivative, or a flame retardant such as thiourea may be added to the urethane resin.

The polyamide coated with the urethane resin may have another coating in addition to the urethane resin. The type of other coating may be polyethylene, polypropylene, polyester, fluororesin, or the like without any specific limitations. A coating that does not dissolve in the metal chloride alcohol solution used in dissolution is preferable. It is preferable that a silicone resin is not included in the coating resin.

The polyamide coated with the urethane resin may be a raw material for polyamide recycling. For example, the urethane resin-coated polyamide may be process offcuts or waste material of a shaped item such as an automotive component or an electrical product component or of fibers in which polyamide is used as a raw material. More specifically, the urethane resin-coated polyamide may be process offcuts or waste material of clothes, airbags, tire cords, components from inside an engine compartment, an intake system, or a fuel system, connectors, fishing nets, or UD tape.

The mixture may contain sewing thread. Although no specific limitations are placed on the material of the sewing thread, it is preferable for the sewing thread to be the same polyamide as the base fabric because this enables recovery thereof as recycled polyamide.

### <Metal Chloride Alcohol Solution>

A metal chloride alcohol solution is used as a solvent for dissolving the polyamide.

The metal chloride alcohol solution contains a metal chloride and an alcohol and may further contain other components. In particular, the total mass proportion of the metal chloride and the alcohol relative to 100 mass % of the metal chloride alcohol solution is preferably 80 mass % or more, more preferably 90 mass % or more, and even more preferably 100 mass %.

The metal chloride may be zinc chloride, magnesium chloride, calcium chloride, or the like without any specific limitations, is preferably zinc chloride or calcium chloride, and is most preferably calcium chloride.

The metal chloride used as a raw material may be anhydrous or may be a hydrate.

The mass proportion of the metal chloride relative to 100 mass % of the metal chloride alcohol solution is preferably 10 mass % to 25 mass %. When this mass proportion is less than 10 mass %, only a small amount of polyamide dissolves, and a large amount of solvent is required. Moreover, when this mass proportion is more than 25 mass %, it becomes more likely that metal chloride will remain without dissolving and become mixed in as an impurity.

Although no specific limitations are placed on water in the metal chloride alcohol solution, there is preferably 4 mol or less of water relative to 1 mol of metal chloride in the solution.

The alcohol may be methanol, ethanol, n-propanol, 2-propanol, or the like. Of these alcohols, methanol is preferable from a viewpoint of polyamide solubility.

Although no specific limitations are placed on the method by which the metal chloride and the alcohol are mixed, it is preferable that stirring is performed in the case of a batch process. Calcium chloride dissolves even in the absence of stirring, but the dissolution takes time and localized non-uniformity of composition may arise.

The metal chloride alcohol solution that is used to dissolve the polyamide is preferably a solution that has been produced by separating polyamide from a metal chloride alcohol solution having polyamide dissolved therein from a polyamide base fabric. In a case in which variation of concentration or composition arises during separation and recovery of the polyamide, separation of superfluous components through extraction, distillation, or the like, concentration through distillation, concentration adjustment through supplemental addition of a metal chloride and/or alcohol, or the like may be performed. For example, a metal chloride alcohol solution from which polyamide has been separated may be concentrated and may then be used in the production method of the present embodiment. This reduces environmental impact because the alcohol and metal chloride are not treated as waste and improves the recovery rate because polyamide that has remained in a supernatant during polyamide separation and recovery can be recovered once again.

The following describes steps in the production method of the present embodiment.

### <Step 1: Dissolution Step>

The dissolution step is a step of mixing the mixture containing polyamide coated with urethane (for example, a polyamide base fabric coated with urethane) with the metal chloride alcohol solution to dissolve the polyamide. Mixing of the mixture and the metal chloride alcohol solution causes polyamide to dissolve from the polyamide coated with urethane in the mixture.

In the present specification, a solution obtained by mixing the mixture and the metal chloride alcohol solution is referred to as a “polyamide dissolution liquid”. The polyamide dissolution liquid contains dissolved polyamide, urethane that was coating the polyamide, and so forth. By separating a coating material such as urethane from the polyamide dissolution liquid, it is possible to obtain a “polyamide-containing solution”.

No specific limitations are placed on the shape of the polyamide base fabric that is used in dissolution. The polyamide base fabric may be added while still having the shape of base fabric production offcuts or used airbags or may be cut in accordance with the size of an apparatus that is used in dissolution.

The temperature during mixing of the mixture and the metal chloride alcohol solution is not specifically limited but is preferably 30° C. to 90° C., more preferably 40° C. to 90° C., and even more preferably 40° C. to 60° C. Note that a temperature of lower than 30° C. results in slow dissolution, whereas a temperature of higher than 90° C. exceeds the boiling point and is undesirable from viewpoints of corrosion and decomposition.

The dissolution may be a batch process or a continuous process.

In the case of a batch process, it is preferable that stirring is performed, though no specific limitations are placed on the stirring. Stirring improves the rate of dissolution of polyamide solid.

In the case of a continuous process, the solvent may be caused to continuously flow relative to a solid or the solution may be caused to circulate. Circulation is preferable because the amount of solvent that is used can be reduced.

The shape of a vessel used in the dissolution step is not specifically limited, and any shape of vessel such as a tank-type or circulation-type vessel may be used.

The time for which the mixture and the metal chloride alcohol solution are mixed is not specifically limited but is preferably 5 minutes to 100 hours.

The mass proportion of polyamide in 100 mass % of the polyamide dissolution liquid is preferably 5 mass % to 15 mass %, and more preferably 7 mass % to 13 mass %. A mass proportion of less than 5 mass % means that too much solvent is required, whereas a mass proportion of more than 15 mass % results in higher viscosity, longer dissolving time, and poorer operability.

Moreover, the mass proportion of polyamide in 100 mass % of the polyamide-containing solution is preferably 5 mass % to 15 mass %, and more preferably 7 mass % to 13 mass %. A mass proportion of less than 5 mass % means that too much solvent is required, whereas a mass proportion of more than 15 mass % results in higher viscosity, longer mixing time, and poorer operability.

The viscosity at 25° C. of the polyamide dissolution liquid is preferably 10 mPa·s to 20,000 mPa·s, more preferably 10 mPa·s to 10,000 mPa·s, and even more preferably 10 mPa·s to 3,000 mPa·s. A higher viscosity means a higher polymer concentration but reduces the efficiency of polyamide dissolution due to sticking together of base fabric, for example.

Moreover, the viscosity at 25° C. of the polyamide-containing solution is preferably 10 mPa·s to 20,000 mPa·s, more preferably 10 mPa·s to 10,000 mPa·s, and even more preferably 10 mPa·s to 3,000 mPa·s.

Examples of methods by which the urethane resin may be separated from the polyamide dissolution liquid include, but are not specifically limited to, a method in which the urethane resin is scooped up from a dissolved layer and also methods such as filtration, centrifugation, and sedimentation. These methods may be used in combination. Since fine fragments of the urethane resin may arise during dissolution of the polyamide, it is preferable that the fine fragments are removed by filtration or a method in which filtration is incorporated.

Other coating material of the polyamide coated with the urethane resin is preferably removed at the same time as the urethane resin.

The urethane resin and other coating material that have been separated have polyamide-containing solution attached thereto. Therefore, it is preferable to wash the urethane resin and other coating material in order to recover the polyamide-containing solution. The solvent used in this washing is not specifically limited but is preferably a calcium chloride methanol solution. The washing method may be stirred washing inside of a tank-type reactor, flow washing in a filter, or the like without any specific limitations.

### <Polyamide Recovery Step>

The polyamide recovery step is a step of recovering polyamide from the polyamide-containing solution obtained in the dissolution step after the urethane resin has been removed.

Although polyamide may be recovered from the polyamide dissolution liquid, it is preferable that polyamide is recovered from the polyamide-containing solution after removal of coating material such as the urethane resin from a viewpoint of further improving recovery efficiency.

The method by which polyamide is recovered from the polyamide-containing solution may be a method in which polyamide is caused to precipitate. No specific limitations are placed on the method by which polyamide is caused to precipitate from the polyamide-containing solution, and a number of precipitation methods can be adopted depending on the dissolved state.

In a case in which the dissolving is performed through heating, precipitation may be performed through cooling by exploiting the temperature dependence of polyamide solubility. In this case, the dissolved polyamide is caused to precipitate from the solution to obtain precipitated polyamide without adding an additional solvent to the solution containing the dissolved polyamide.

In a case in which the temperature dependence of solubility during dissolution is small, the solubility can alternatively be reduced to cause precipitation through mixing of the polyamide-containing solution with a poor solvent for polyamide. In this case, the dissolved polyamide is caused to precipitate from the solution to obtain precipitated polyamide after the poor solvent has been added to the solution containing the dissolved polyamide. The poor solvent may be water or an alcohol such as ethanol, n-propanol, or isopropanol, for example, without any specific limitations. The method by which the poor solvent is added to the polyamide may be a method in which the polyamide-containing solution is added into the poor solvent or a method in which the poor solvent is added into the polyamide-containing solution. No specific limitations are placed on the addition rate, temperature, stirring speed, and so forth during addition.

The additive amount of the poor solvent is not specifically limited but is preferably a mass that is 0.5 to 50 times the mass of the polyamide-containing solution, and more preferably a mass that is 1 to 10 times the mass of the polyamide-containing solution. A smaller additive amount results in a lower recovery rate, whereas a larger additive amount results in a larger amount of solution and necessitates greater time and energy for treatment.

In a case in which the temperature dependence of solubility during dissolution is small, polyamide solubility can also be reduced by lowering the concentration of calcium chloride. The method by which methanol is added so as to lower the concentration of calcium chloride is not specifically limited and may be a method in which the polyamide-containing solution is added into methanol or a method in which methanol is added into the polyamide-containing solution. No specific limitations are placed on the addition rate, temperature, stirring speed, and so forth during addition.

The vessel shape is not specifically limited, and any shape of vessel such as a tank-type or circulation-type vessel may be used.

The precipitated polyamide is preferably recovered by solid-liquid separation. The method of solid-liquid separation may be filtration, centrifugation, sedimentation, or the like, for example. A batch process or a continuous process may be adopted in any of these methods.

The polyamide obtained by solid-liquid separation is preferably washed using a solvent. No specific limitations are placed on the washing liquid. For example, a solution having a composition corresponding to the liquid portion at the time of precipitation, a good solvent, or a solvent that can dissolve calcium chloride or the like can be used as the washing liquid. Additional washing liquid that is used here may be water or an alcohol such as methanol, ethanol, n-propanol, or isopropanol, for example. The additional washing liquid is preferably methanol. The washing may be performed multiple times as necessary.

The washing method is not specifically limited and may be a method in which batch washing is performed, a method in which continuous washing is performed by causing water to flow in a state in which a solid has been loaded into a solid-liquid separation device such as a filter or a centrifuge, a combination of these methods, or the like.

By removing the washing solvent from polyamide present after washing under heating and/or reduced pressure to yield a dry solid, it is possible to obtain powdered polyamide.

As set forth above, according to the present embodiment, it is possible to provide a method of producing recycled polyamide with high yield from a mixture in which polyamide that is useful as an engineering plastic is coated with urethane.

### <Step of Concentrating Metal Chloride Alcohol Solution>

The production method of the present embodiment may further include a step of concentrating a metal chloride alcohol solution from a viewpoint of reusing the metal chloride alcohol solution.

For example, a metal alcohol solution containing a metal chloride and an alcohol that has been obtained through the polyamide recovery step may be concentrated and reused.

The method by which the concentrating is performed may be concentrating through heating, for example.

### <Recycled Polyamide>

No specific limitations are placed on the form of the recycled polyamide that is produced by the production method of the present embodiment. For example, the recycled polyamide may have a pelletized form obtained through melting and pelletization of polyamide during recycling, may have a powdered form as a result of polyamide being dissolved in a solvent and then being caused to precipitate, or may have a tablet form resulting from aggregation of powder according to handling conditions.

The recycled polyamide can be used as a raw material of polyamide fibers, a polyamide base fabric, an airbag, or the like.

### (Spinning of Polyamide Fibers)

Fibers of the recycled polyamide can be spun and used to obtain a polyamide base fabric.

The spinning temperature in melt spinning is preferably not lower than 290° C. and not higher than 310° C. Setting the spinning temperature as 310° C. or lower is preferable in order to suppress thermal decomposition of the polyamide, and the spinning temperature is more preferably 300° C. or lower, and even more preferably 295° C. or lower. On the other hand, setting the spinning temperature as 290° C. or higher is preferable because the polyamide displays sufficient melt flowability, there is greater uniformity of the amount of discharge between discharge holes, and high ratio stretching becomes possible.

The residence time (time until polyamide resin melts and is discharged from a spinneret) in the melt spinning process is preferably short. The residence time is preferably 30 minutes or less, more preferably 15 minutes or less, and even more preferably not less than 0.5 minutes and not more than 7 minutes. A short time is preferable because cyclopentanone content in the polymer increases at the melting temperature.

In order to provide thermal stability in high temperature and high humidity environments, it is preferable that a copper compound is added such that the copper concentration is 1 ppm to 500 ppm, and more preferably 30 ppm to 500 ppm relative to the polyamide. Through the above, reduction of mechanical performance is extremely effectively suppressed even upon placement in a high temperature and high humidity environment for a long time or exposure to an environment containing a large amount of ozone for a long time. Heat resistance strength retention decreases with a copper content of less than 30 ppm, whereas strength decreases when the additive amount exceeds 500 ppm.

No specific limitations are placed on the type of copper compound. For example, an organic copper salt such as copper acetate or a copper halide such as cuprous chloride or cupric chloride can preferably be used. The copper compound is more preferably used together with a metal halide. The metal halide may be potassium iodide, potassium bromide, potassium chloride, or the like, for example. Preferable combinations in the present embodiment are cuprous iodide with potassium iodide and copper acetate with potassium iodide. Note that the copper content in the polyamide can be measured by atomic absorption spectroscopy, colorimetry, or the like.

Although no limitation is made to the following, an organic antioxidant such as a hindered phenol antioxidant, a sulfuric antioxidant, or a phosphoric antioxidant, a heat stabilizer, a light stabilizer based on a hindered amine, benzophenone, imidazole, or the like, an ultraviolet absorber, or the like may be added as a stabilizer. The additive amount should be selected as appropriate and can be 1 ppm to 1,000 ppm relative to the polyamide. Not only may one of these additives be used individually, but also a plurality of these additives may be used in combination.

Moreover, in the melt spinning process, it is preferable to use a uniaxial or biaxial extruder in the melt zone. The extruder makes it possible to apply suitable pressure to the polyamide resin while also guiding the polyamide resin to polymer piping, a gear pump, and a spinning pack.

Moreover, it is preferable that the polyamide resin is filtered using a metal fiber non-woven fabric filter, sand, or the like at a stage prior to discharge from the spinneret in order to stabilize spinning operation.

The nozzle shape of the spinneret should be selected according to the cross-sectional shape of monofilament(s) composing the filament that is to be produced. A spun yarn from the spinneret is solidified in cooling air, coated with process oil, and taken up, and is subsequently subjected to stretching and heat treatment to obtain polyamide fibers.

The oil attachment rate of the polyamide fibers is preferably 0.5 wt % to 1.5 wt %. When the oil attachment rate is 1.5 wt % or less, there is good weaving stability with almost no difficulty in terms of weft yarn running due to stickiness (tackiness) and no loss of weft yarn conveying force of air or water serving as a weft yarn conveying medium due to the reduction of apparent cross-sectional area when there is excessive single yarn bundling beyond single yarn bundling by entanglement. On the other hand, when the oil attachment rate is 0.5 wt % or more, a suitable friction reduction effect allows smooth supply of the weft yarn, thus resulting in excellent productivity without weaving downtime.

### (Polyamide Base Fabric)

In weaving, a water jet loom, an air jet loom, a rapier loom, or the like can be used as a loom. A base fabric for an airbag is a high-density woven fabric that is preferably produced with increased warp yarn tension in a warping process and a weaving process so as to provide good process throughput. By setting a high warp yarn tension in weaving and creating effective beating conditions, a high-density woven fabric is formed.

Process oil on polyamide fibers of the woven fabric obtained through weaving can be washed off through a scouring process.

In the scouring process, warm water, pressurized hot water, or the like can be selected to perform treatment as a single stage or as multistage treatment including two or more stages. Moreover, it is preferable that the scouring is performed with a commonly known scouring agent applied.

The woven fabric is preferably thermally fixed through a heat setting process. The heat setting temperature is preferably not lower than 110° C. and not higher than 200° C., and the heat setting time should be selected as appropriate from a range of not less than 0.1 minutes and not more than 30 minutes. In the heat setting process, drying is preferably performed while performing tensing such that woven fabric contraction force is maintained as a specific force. Thermal fixing of the woven fabric enables stabilization of processability in a subsequent resin application process.

The woven fabric that has undergone the scouring process may be subjected to drying treatment as necessary prior to the heat setting process. The drying temperature is preferably within a range of not lower than 80° C. and not higher than 130° C., and is more preferably not lower than 100° C. and not higher than 120° C. Moreover, the treatment time is preferably selected as appropriate as a time of not less than 0.1 minutes and not more than 30 minutes. Drying may be performed with the woven fabric in a relaxed state or may be performed with the woven fabric in a tense state.

The polyamide base fabric that has undergone the heat setting process can be used as a non-coated base fabric. Alternatively, a coating agent such as silicon or urethane may be applied or a thin film or the like may be thermally laminated onto the polyamide base fabric.

The method by which the surface of the woven fabric is coated may be a method in which the woven fabric is immersed in a resin solution tank and then a mangle, vacuum, coating knife, or the like is used to perform formation and equalization of excess resin, a method in which bar coating is performed using a comma coater or the like, or a method in which the resin is sprayed against the surface using a spraying device, a forming device, or the like. Of these methods, knife coating is preferable from a viewpoint of uniform application of a small amount of the resin.

The coating weight is not less than 5 g/m² and not more than 100 g/m², more preferably not less than 10 g/m² and not more than 70 g/m², and even more preferably not less than 15 g/m² and not more than 30 g/m². When the coating weight is 5 g/m² or more, the necessary air tightness is obtained. On the other hand, when the coating weight is 100 g/m² or less, the coated woven fabric has flexibility and good ease of storage, and the weight of the overall bag is restricted.

### <Airbag>

The airbag may be selected as appropriate from airbags that are typically used for a driver's seat, passenger's seat, side (inclusive of inflatable curtains), rear seat, or the like. The cut shape of a bag body of the airbag may be a circular shape, an oblong shape, an elliptical shape, a rectangular shape, a polygonal shape, or a combination thereof, for example, and should be a shape that satisfies the shape demanded upon deployment.

The shape of stitching may be a single straight line, a plurality of parallel straight lines, a zig-zag shape, a combination of a straight line and a zig-zag, straight and diagonal lines, or the like. The method of sewing may be a typically used method such as final stitch or double chain stitch, and the sewing pitch may be selected from a range of 20 stitches/10 cm to 60 stitches/10 cm. Moreover, the sewing thread thickness may be selected from 420 d to 3,000 d, and the thread material can be commercially available sewing thread of polyamide fibers, polyester fibers, vinylon-based fibers, aramid-based fibers, glass fibers, or the like.

### EXAMPLES

A more detailed description of the present disclosure is provided below using examples. However, the present disclosure is not limited to these examples.

The following describes examples of aspect (I) of the present disclosure.

An analysis method used in the examples and comparative examples is as follows.

### <Particle Size Distribution>

### (1) Particle Size Analyzer

Analyzer: MT3300EX (Microtrac MRB)
Transparency: Transparent
Solvent: Water
Distribution: Volume

The median diameter was indicated as a particle diameter based on the analysis results. The median diameter indicates the particle diameter at which, for a given powder, the number of particles that are larger than that particle diameter is equal to the number of particles that are smaller than that particle diameter. Moreover, a value calculated through the following general formula (1) was taken to be S, a value expressed by 10^{S} was taken to be the span, and the span was taken as an indicator of the particle size distribution. A value of closer to 1 indicates a narrower particle size distribution.

$$S = log ( d 90 / d 10 ) / log ( d 50 ) \qquad ( 1 )$$

(In formula (1), dn (where n represents 10, 50, or 90) indicates the particle diameter at which, in measurement of a particle size distribution of obtained powdered polyamide by laser diffraction/scattering, the number of particles having a particle diameter of smaller than dn is n % relative to the total number of particles.)

Note that d50 is the median diameter.

### Example 1

A 300 mL three-necked flask in which a stirring bar had been placed was charged with 10 g of pellets of polyamide 66 and 100 g of a 25 wt % calcium chloride methanol solution (calcium chloride: 25.0 g; water content: 8.1 g (molar amount of water/molar amount of calcium chloride=2)) as a metal chloride alcohol solution, was immersed in an 80° C. oil bath, and was stirred by a magnetic stirrer for 12 hours while causing dissolution of the polyamide 66 to obtain a polyamide thermal dissolution liquid. The viscosity at 25° C. of the obtained polyamide thermal dissolution liquid was 4,200 mPa·s. The polyamide thermal dissolution liquid was stirred while being diluted through addition of 220.0 g of methanol. During the addition, the internal temperature was held at 65° C. or higher. After methanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 43 g. After adding 50 g of methanol to the filter, pressurized filtration was performed once again. The amount of calcium chloride in the filtrate was analyzed by ion chromatography, and the residual amount of calcium chloride in the polyamide was calculated. Operations from addition of methanol to calculation of the residual amount of calcium chloride were repeated, and washing was ended at the point at which the residual amount reached 1,000 ppm or less. The number of washes was 7 and the amount of washing liquid was 350 g. The mass (g) of washing liquid relative to the mass (g) of pellets of polyamide 66 used as a raw material was 35. A solid precipitate present after washing was thermally dried in an 80° C. vacuum dryer to yield 9.8 g (yield: 98.0%) of powdered polyamide 66. The amount of energy required in drying, calculated from the solvent content, was 3.6 kJ per 1 g of polyamide 66. The mass (g) of solution contained in the obtained powdered polyamide 66 per 1 g of the powdered polyamide was 3.3.

### [Examples 2 to 8] [Comparative Examples 1 to 4]

Operations were performed in the same way as in Example 1 with the exception that the metal chloride alcohol solution was set as a composition indicated in Table 1. The results thereof are shown in Table 1.

TABLE 1

| | | | | | | | | | | | Com- | Com- | Com- | Com- |
|---|---|---|---|---|---|---|---|---|---|---|---|---|---|---|
| | | | | | | | | | | | para- | para- | para- | para- |
| | | | | | | | | | | | tive | tive | tive | tive |
| | | | Exam- | Exam- | Exam- | Exam- | Exam- | Exam- | Exam- | Exam- | Exam- | Exam- | Exam- | Exam- |
| | | | ple 1 | ple 2 | ple 3 | ple 4 | ple 5 | ple 6 | ple 7 | ple 8 | ple 1 | ple 2 | ple 3 | ple 4 |
| Poly- | PA66 | g | 10.0 | 10.0 | 10.0 | 10.0 | 10.0 | 10.0 | 10.0 | 10.0 | 10.0 | 10.0 | 10.0 | 10.0 |
| amide | | | | | | | | | | | | | | |
| resin | | | | | | | | | | | | | | |
| compo- | | | | | | | | | | | | | | |
| sition | | | | | | | | | | | | | | |
| Metal | Meth- | g | 66.9 | 67.6 | 74.2 | 73.3 | 69.0 | 74.2 | 68.9 | 67.6 | 74.6 | 73.5 | 69.5 | 74.4 |
| chloride | anol | | | | | | | | | | | | | |
| alcohol | Calcium | g | 25.0 | 30.0 | 25.0 | 23.0 | 30.0 | 25.0 | 25.0 | 30.0 | 25.0 | 20.0 | 30.0 | 22.0 |
| solution | chloride | | | | | | | | | | | | | |
| | Water | g | 8.1 | 2.4 | 0.8 | 3.7 | 1.0 | 0.8 | 6.1 | 2.4 | 0.4 | 6.5 | 0.5 | 3.6 |
| Total | | g | 110.0 | 110.0 | 110.0 | 110.0 | 110.0 | 110.0 | 110.0 | 110.0 | 110.0 | 110.0 | 110.0 | 110.0 |
| Results | Liquid | — | 3.3 | 2.2 | 3.4 | 3.5 | 2.5 | 2.2 | 3.1 | 2.2 | 5.4 | 5.8 | 4.9 | 4.7 |
| | content | | | | | | | | | | | | | |
| | g/g | | | | | | | | | | | | | |
| | PA66 | | | | | | | | | | | | | |
| | Yield | % | 98 | 98 | 98 | 98 | 98 | 98 | 98 | 98 | 98 | 98 | 98 | 98 |
| | Number | Washes | 7 | 5 | 7 | 7 | 6 | 5 | 7 | 5 | 10 | 10 | 9 | 8 |
| | of | | | | | | | | | | | | | |
| | washes | | | | | | | | | | | | | |
| | Amount | — | 35 | 25 | 35 | 35 | 30 | 25 | 35 | 25 | 50 | 50 | 45 | 40 |
| | of | | | | | | | | | | | | | |
| | washing | | | | | | | | | | | | | |
| | liquid | | | | | | | | | | | | | |
| | g/g | | | | | | | | | | | | | |
| | PA66 | | | | | | | | | | | | | |
| | Drying | — | 3.6 | 2.4 | 3.8 | 3.9 | 2.8 | 2.4 | 3.4 | 2.4 | 6.0 | 6.4 | 5.4 | 5.2 |
| | heat | | | | | | | | | | | | | |
| | kJ/g | | | | | | | | | | | | | |
| | PA66 | | | | | | | | | | | | | |
| | Viscos- | mPa · s | 4200 | 4700 | 4300 | 4100 | 4600 | 4200 | 4200 | 4600 | 4300 | 3300 | 4800 | 3900 |
| | ity of | | | | | | | | | | | | | |
| | poly- | | | | | | | | | | | | | |
| | amide | | | | | | | | | | | | | |
| | thermal | | | | | | | | | | | | | |
| | disso- | | | | | | | | | | | | | |
| | lution | | | | | | | | | | | | | |
| | liquid | | | | | | | | | | | | | |

### Example 9

A 300 mL three-necked flask in which a stirring bar had been placed was charged with 10 g of pellets of polyamide 66 and 100 g of a 25 wt % calcium chloride methanol solution (calcium chloride: 25.0 g; water content: 8.1 g (molar amount of water/molar amount of calcium chloride=2)) as a metal chloride alcohol solution, was immersed in an 80° C. oil bath, and was stirred by a magnetic stirrer for 12 hours while causing dissolution of the polyamide 66 to obtain a polyamide thermal dissolution liquid. The viscosity at 25° C. of the obtained polyamide thermal dissolution liquid was 4,200 mPa·s. The polyamide thermal dissolution liquid was stirred while being diluted through addition of 220.0 g of methanol. During the addition, the internal temperature was lowered to 45° C. At this time, the supernatant was sampled in order to calculate the content of precipitated polyamide. The precipitated amount at this point was 0.7 weight % of the polyamide 66 used as a raw material. After methanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 43 g. After adding 50 g of methanol to the filter, pressurized filtration was performed once again. The amount of calcium chloride in the filtrate was analyzed by ion chromatography, and the residual amount of calcium chloride in the polyamide was calculated. Operations from addition of methanol to calculation of the residual amount of calcium chloride were repeated, and washing was ended at the point at which the residual amount reached 1,000 ppm or less. The number of washes was 6 and the amount of washing liquid was 300 g. A solid precipitate present after washing was thermally dried in an 80° C. vacuum dryer to yield 9.8 g (yield: 98.0%) of powdered polyamide 66. The amount of energy required in drying, calculated from the solvent content, was 3.6 kJ per 1 g of polyamide 66.

### Example 10

A 300 mL three-necked flask in which a stirring bar had been placed was charged with 10 g of pellets of polyamide 6 and 100 g of a 25 wt % calcium chloride methanol solution (calcium chloride: 25.0 g; water content: 8.1 g (molar amount of water/molar amount of calcium chloride=2)) as a metal chloride alcohol solution, was immersed in an 80° C. oil bath, and was stirred by a magnetic stirrer for 12 hours while causing dissolution of the polyamide 6 to obtain a polyamide thermal dissolution liquid. The viscosity at 25° C. of the obtained polyamide thermal dissolution liquid was 2,500 mPa·s. The polyamide thermal dissolution liquid was stirred while being diluted through addition of methanol aqueous solution (methanol: 150.0 g; water: 60.0 g). During the addition, the internal temperature was held at 65° C. or higher. After methanol aqueous solution addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 41 g. After adding 50 g of methanol to the filter, pressurized filtration was performed once again. The amount of calcium chloride in the filtrate was analyzed by ion chromatography, and the residual amount of calcium chloride in the polyamide was calculated. Operations from addition of methanol to calculation of the residual amount of calcium chloride were repeated, and washing was ended at the point at which the residual amount reached 1,000 ppm or less. The number of washes was 6 and the amount of washing liquid was 300 g. A solid precipitate present after washing was thermally dried in an 80° C. vacuum dryer to yield 9.8 g (yield: 98.0%) of powdered polyamide 66. The amount of energy required in drying, calculated from the solvent content, was 3.4 kJ per 1 g of polyamide 66.

### Example 11

A 300 mL three-necked flask in which a stirring bar had been placed was charged with 10 g of pellets of polyamide 66 and 100 g of a 25 wt % calcium chloride ethanol solution (calcium chloride: 25.0 g; water content: 8.1 g (molar amount of water/molar amount of calcium chloride=2)) as a metal chloride alcohol solution, was immersed in an 80° C. oil bath, and was stirred by a magnetic stirrer for 12 hours while causing dissolution of the polyamide 66 to obtain a polyamide thermal dissolution liquid. The viscosity at 25° C. of the obtained polyamide thermal dissolution liquid was 4,100 mPa·s. The polyamide thermal dissolution liquid was stirred while being diluted through addition of 220.0 g of ethanol. During the addition, the internal temperature was held at 65° C. or higher. After ethanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 44 g. After adding 50 g of methanol to the filter, pressurized filtration was performed once again. The amount of calcium chloride in the filtrate was analyzed by ion chromatography, and the residual amount of calcium chloride in the polyamide was calculated. Operations from addition of ethanol to calculation of the residual amount of calcium chloride were repeated, and washing was ended at the point at which the residual amount reached 1,000 ppm or less. The number of washes was 6 and the amount of washing liquid was 300 g. A solid precipitate present after washing was thermally dried in an 80° C. vacuum dryer to yield 9.8 g (yield: 98.0%) of powdered polyamide 66. The amount of energy required in drying, calculated from the solvent content, was 3.6 kJ per 1 g of polyamide 66.

### Example 12

A 300 mL three-necked flask in which a stirring bar had been placed was charged with 10 g of pellets of polyamide 66 and 100 g of a 25 wt % calcium chloride methanol solution (calcium chloride: 25.0 g; water content: 8.1 g (molar amount of water/molar amount of calcium chloride=2)) as a metal chloride alcohol solution, was immersed in an 80° C. oil bath, and was stirred by a magnetic stirrer for 12 hours while causing dissolution of the polyamide 66 to obtain a polyamide thermal dissolution liquid. The viscosity at 25° C. of the obtained polyamide thermal dissolution liquid was 4,200 mPa·s. The polyamide thermal dissolution liquid was stirred while being diluted through addition of 220.0 g of methanol. During the addition, the internal temperature was held at 65° C. or higher. After methanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 43 g. After adding 50 g of water to the filter, pressurized filtration was performed once again. The amount of calcium chloride in the filtrate was analyzed by ion chromatography, and the residual amount of calcium chloride in the polyamide was calculated. Operations from addition of water to calculation of the residual amount of calcium chloride were repeated, and washing was ended at the point at which the residual amount reached 1,000 ppm or less. The number of washes was 7 and the amount of washing liquid was 350 g. After performing solvent exchange with methanol in order to facilitate drying, a solid precipitate was thermally dried in an 80° C. vacuum dryer to yield 9.8 g (yield: 98.0%) of powdered polyamide 66. The amount of energy required in drying, calculated from the solvent content, was 3.6 kJ per 1 g of polyamide 66.

### Reference Example 1

A calcium chloride methanol solution obtained by mixing together all filtrates and washing liquids obtained in Example 1 was weighed into a 1 L pear-shaped flask in an amount of 400 g and was concentrated using a rotary evaporator to obtain 100 g of a concentrate. The obtained solution contains 24.9 g of calcium chloride and 8.7 g of water (molar amount of water/molar amount of calcium chloride=2.1) and can be used as a calcium chloride methanol solution that is used for dissolving polyamide.

### Reference Example 2

A calcium chloride methanol solution obtained by mixing together all filtrates and washing liquids obtained in Example 12 was weighed into a 1 L pear-shaped flask in an amount of 450 g and was concentrated using a rotary evaporator to obtain 100 g of a concentrate. The obtained solution was an aqueous solution containing 24.9 g of calcium chloride and having a methanol content of 1.2%. Since water used in washing has a higher boiling point than methanol, the concentrate could not be used for dissolving polyamide.

### Example 13

A 300 mL three-necked flask in which a stirring bar had been placed was charged with 10 g of pellets of polyamide 66 and 100 g of a 25 wt % calcium chloride methanol solution (calcium chloride: 25.0 g; water content: 8.1 g (molar amount of water/molar amount of calcium chloride=2)) as a metal chloride alcohol solution, was immersed in an 80° C. oil bath, and was stirred by a magnetic stirrer for 12 hours while causing dissolution of the polyamide 66 to obtain a polyamide thermal dissolution liquid. The viscosity at 25° C. of the obtained polyamide thermal dissolution liquid was 4,200 mPa·s. The polyamide thermal dissolution liquid was stirred while being diluted through addition of 220.0 g of methanol. During the addition, the internal temperature was held at 65° C. or higher. After methanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 43 g. After adding 50 g of methanol to the filter, pressurized filtration was performed once again. The amount of calcium chloride in the filtrate was analyzed by ion chromatography, and the residual amount of calcium chloride in the polyamide was calculated. The residual amount of calcium chloride was 10 mass %. A solid precipitate present after washing was thermally dried in an 80° C. vacuum dryer to yield 9.8 g (yield: 98.0%) of powdered polyamide 66. The amount of energy required in drying, calculated from the solvent content, was 3.6 kJ per 1 g of polyamide 66.

### Example 14

A 300 mL three-necked flask in which a stirring bar had been placed was charged with 10 g of pellets of polyamide 66 and 100 g of a 25 wt % calcium chloride methanol solution (calcium chloride: 25.0 g; water content: 8.1 g (molar amount of water/molar amount of calcium chloride=2)) as a metal chloride alcohol solution, was immersed in an 80° C. oil bath, and was stirred by a magnetic stirrer for 12 hours while causing dissolution of the polyamide 66 to obtain a polyamide thermal dissolution liquid. The viscosity at 25° C. of the obtained polyamide thermal dissolution liquid was 4,200 mPa·s. The polyamide thermal dissolution liquid was stirred while adding 220.0 g of methanol. During the addition, the internal temperature was held at 65° C. or higher. After methanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 43 g. The calcium chloride content after filtration was 25.8 mass %. When a solid precipitate present after washing was thermally dried in an 80° C. vacuum dryer, the dried solid was in the form of lumps of hardened powder. The amount of energy required in drying, calculated from the solvent content, was 3.6 kJ per 1 g of polyamide 66.

### Example 15

A 300 mL three-necked flask in which a stirring bar had been placed was charged with 11 g of an airbag base fabric (10 g of polyamide 66 and 1 g of silicone coating) and 100 g of a 25 wt % calcium chloride methanol solution (calcium chloride: 25.0 g; water content: 8.1 g (molar amount of water/molar amount of calcium chloride=2)) as a metal chloride alcohol solution, was immersed in an 80° C. oil bath, and was stirred by a magnetic stirrer for 12 hours while causing dissolution of the polyamide 66 to obtain a polyamide thermal dissolution liquid. The obtained polyamide thermal dissolution liquid was passed through a 200-mesh stainless steel mesh in order to separate insoluble matter, and was then subjected to pressurized filtration using a membrane filter having a pore diameter of 10 μm. The viscosity at 25° C. of the obtained solution was 4,100 mPa·s. The polyamide thermal dissolution liquid was stirred while being diluted through addition of 220.0 g of methanol. During the addition, the internal temperature was held at 65° C. or higher. After methanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 43 g. After adding 50 g of methanol to the filter, pressurized filtration was performed once again. The amount of calcium chloride in the filtrate was analyzed by ion chromatography, and the residual amount of calcium chloride in the polyamide was calculated. Operations from addition of methanol to calculation of the residual amount of calcium chloride were repeated, and washing was ended at the point at which the residual amount reached 1,000 ppm or less. The number of washes was 6 and the amount of washing liquid was 300 g. A solid precipitate present after washing was thermally dried in an 80° C. vacuum dryer to yield 9.8 g (yield: 98.0%) of powdered polyamide 66. The amount of energy required in drying, calculated from the solvent content, was 3.6 kJ per 1 g of polyamide 66.

### Example 16

A 300 mL three-necked flask in which a stirring bar had been placed was charged with 18 g of an airbag base fabric (16.4 g of polyamide 66 and 1.6 g of silicone coating) and 100 g of a 25 wt % calcium chloride methanol solution (calcium chloride: 25.0 g; water content: 8.1 g (molar amount of water/molar amount of calcium chloride=2)) as a metal chloride alcohol solution, was immersed in an 80° C. oil bath, and was stirred by a magnetic stirrer for 12 hours while causing dissolution of the polyamide 66 to obtain a polyamide thermal dissolution liquid. The obtained solution was passed through a 200-mesh stainless steel mesh in order to separate insoluble matter, and was then subjected to pressurized filtration using a membrane filter having a pore diameter of 10 μm. The viscosity at 25° C. of the obtained solution was 43,000 mPa·s. The polyamide thermal dissolution liquid was stirred while being diluted through addition of 220.0 g of methanol. During the addition, the internal temperature was held at 65° C. or higher. After methanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 34 g. After adding 50 g of methanol to the filter, pressurized filtration was performed once again. The amount of calcium chloride in the filtrate was analyzed by ion chromatography, and the residual amount of calcium chloride in the polyamide was calculated. Operations from addition of methanol to calculation of the residual amount of calcium chloride were repeated, and washing was ended at the point at which the residual amount reached 1,000 ppm or less. The number of washes was 6 and the amount of washing liquid was 300 g. The solid precipitate present after washing was thermally dried in an 80° C. vacuum dryer to yield 10.1 g (yield: 61.6%) of powdered polyamide 66. The amount of energy required in drying, calculated from the solvent content, was 3.5 kJ per 1 g of polyamide 66.

### Reference Example 3

In a 200 mL glass bottle in which a stirring bar had been placed, 25.0 g of calcium chloride, 8.1 g of water, and 67 g of methanol were weighed out and were stirred to obtain a uniform solution. In addition, 0.01 g of calcium hydroxide was added and stirred to obtain a cloudy white solution. A mesh made of SUS316 was loaded into the glass bottle and was immersed at room temperature for 100 hours. The supernatant remained colorless and transparent.

### Reference Example 4

In a 200 mL glass bottle in which a stirring bar had been placed, 25.0 g of calcium chloride, 8.1 g of water, and 67 g of methanol were weighed out and were stirred to obtain a uniform solution. In addition, 0.1 g of calcium hydroxide was added and stirred to obtain a cloudy white solution. A mesh made of SUS316 was loaded into the glass bottle and was immersed at room temperature for 100 hours. The supernatant was colored yellow.

### Example 17

A 300 mL three-necked flask in which a stirring bar had been placed was charged with 10 g of pellets of polyamide 66 and 100 g of the solution produced in Reference Example 3 (calcium chloride: 25.0 g; water content: 8.1 g (molar amount of water/molar amount of calcium chloride=2)), was immersed in an 80° C. oil bath, and was stirred by a magnetic stirrer for 12 hours while causing dissolution of the polyamide 66 to obtain a polyamide thermal dissolution liquid. The viscosity at 25° C. of the obtained polyamide thermal dissolution liquid was 4,200 mPa·s. The polyamide thermal dissolution liquid was stirred while being diluted through addition of 220.0 g of methanol. During the addition, the internal temperature was held at 65° C. or higher. After methanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 43 g. After adding 50 g of methanol to the filter, pressurized filtration was performed once again. The amount of calcium chloride in the filtrate was analyzed by ion chromatography, and the residual amount of calcium chloride in the polyamide was calculated. Operations from addition of methanol to calculation of the residual amount of calcium chloride were repeated, and washing was ended at the point at which the residual amount reached 1,000 ppm or less. The number of washes was 6 and the amount of washing liquid was 300 g. A solid precipitate present after washing was thermally dried in an 80° C. vacuum dryer to yield 9.8 g (yield: 98.0%) of powdered polyamide 66. The obtained polyamide was white. The calcium content was 500 mass ppm and the molar content of halogen atoms was 0.02 times the molar content of calcium. The amount of energy required in drying, calculated from the solvent content, was 3.6 kJ per 1 g of polyamide 66.

### Example 18

A 300 mL three-necked flask in which a stirring bar had been placed was charged with 10 g of pellets of polyamide 66 and 100 g of the solution produced in Reference Example 4 (calcium chloride: 25.0 g; water content: 8.1 g (molar amount of water/molar amount of calcium chloride=2)), was immersed in an 80° C. oil bath, and was stirred by a magnetic stirrer for 12 hours while causing dissolution of the polyamide 66 to obtain a polyamide thermal dissolution liquid. The viscosity at 25° C. of the obtained polyamide thermal dissolution liquid was 4,200 mPa·s. The polyamide thermal dissolution liquid was stirred while adding 220.0 g of methanol. During the addition, the internal temperature was held at 65° C. or higher. After methanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 43 g. After adding 50 g of methanol to the filter, pressurized filtration was performed once again. The amount of calcium chloride in the filtrate was analyzed by ion chromatography, and the residual amount of calcium chloride in the polyamide was calculated. Operations from addition of methanol to calculation of the residual amount of calcium chloride were repeated, and washing was ended at the point at which the residual amount reached 1,000 ppm or less. The number of washes was 6 and the amount of washing liquid was 300 g. A solid precipitate present after washing was thermally dried in an 80° C. vacuum dryer to yield 9.8 g (yield: 98.0%) of powdered polyamide 66. The obtained polyamide was colored faintly yellow. The amount of energy required in drying, calculated from the solvent content, was 3.6 kJ per 1 g of polyamide 66.

### Example 19

A 300 mL three-necked flask in which a stirring bar had been placed was charged with 10.1 g of a base fabric formed of polyamide 66 fibers and polyethylene terephthalate fibers (10 g of polyamide 66 and 0.01 g of polyethylene terephthalate) and 100 g of a 25 wt % calcium chloride methanol solution (calcium chloride: 25.0 g; water content: 8.1 g (molar amount of water/molar amount of calcium chloride=2)) as a metal chloride alcohol solution, was immersed in an 80° C. oil bath, and was stirred by a magnetic stirrer for 12 hours while causing dissolution of the polyamide 66 to obtain a polyamide thermal dissolution liquid. The obtained polyamide thermal dissolution liquid was passed through a stainless steel mesh having an opening size of 1 mm to separate insoluble matter. The viscosity at 25° C. of the obtained polyamide thermal dissolution liquid was 4,100 mPa·s. The polyamide thermal dissolution liquid was stirred while adding 220.0 g of methanol. During the addition, the internal temperature was held at 65° C. or higher. After methanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 43 g. After adding 50 g of methanol to the filter, pressurized filtration was performed once again. The amount of calcium chloride in the filtrate was analyzed by ion chromatography, and the residual amount of calcium chloride in the polyamide was calculated. Operations from addition of methanol to calculation of the residual amount of calcium chloride were repeated, and washing was ended at the point at which the residual amount reached 1,000 ppm or less. The number of washes was 6 and the amount of washing liquid was 300 g. A solid precipitate present after washing was thermally dried in an 80° C. vacuum dryer to yield 9.8 g (yield: 98.0%) of powdered polyamide 66. The amount of energy required in drying, calculated from the solvent content, was 3.6 kJ per 1 g of polyamide 66.

### Example 20

A 300 mL three-necked flask in which a stirring bar had been placed was charged with 11 g of offcuts of a base fabric for clothing (10 g of polyamide 66 and 1 g of polyurethane coating) and 100 g of a 25 wt % calcium chloride methanol solution (calcium chloride: 25.0 g; water content: 8.1 g (molar amount of water/molar amount of calcium chloride=2)) as a metal chloride alcohol solution, was immersed in an 80° C. oil bath, and was stirred by a magnetic stirrer for 12 hours while causing dissolution of the polyamide 66 to obtain a polyamide thermal dissolution liquid. The obtained solution was treated in a centrifuge to cause sedimentation, and the resultant supernatant was subjected to pressurized filtration using a membrane filter having a pore diameter of 10 μm. The viscosity at 25° C. of the obtained polyamide thermal dissolution liquid was 4,000 mPa·s. The polyamide solution was stirred while adding 220.0 g of methanol. During the addition, the internal temperature was held at 65° C. or higher. After methanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 43 g. After adding 50 g of methanol to the filter, pressurized filtration was performed once again. The amount of calcium chloride in the filtrate was analyzed by ion chromatography, and the residual amount of calcium chloride in the polyamide was calculated. Operations from addition of methanol to calculation of the residual amount of calcium chloride were repeated, and washing was ended at the point at which the residual amount reached 1,000 ppm or less. The number of washes was 6 and the amount of washing liquid was 300 g. A solid precipitate present after washing was thermally dried in an 80° C. vacuum dryer to yield 9.8 g (yield: 98.0%) of powdered polyamide 66. The amount of energy required in drying, calculated from the solvent content, was 3.6 kJ per 1 g of polyamide 66.

### Example 21

A 300 mL three-necked flask in which a stirring bar had been placed was charged with 10.5 g of tire cord offcuts (10 g of polyamide 66 and 1 g of coating RFL adhesive component) and 100 g of a 25 wt % calcium chloride methanol solution (calcium chloride: 25.0 g; water content: 8.1 g (molar amount of water/molar amount of calcium chloride=2)) as a metal chloride alcohol solution, was immersed in an 80° C. oil bath, and was stirred by a magnetic stirrer for 12 hours while causing dissolution of the polyamide 66 to obtain a polyamide thermal dissolution liquid. The obtained solution was treated in a centrifuge to cause sedimentation, and the resultant supernatant was subjected to pressurized filtration using a membrane filter having a pore diameter of 10 μm. The viscosity at 25° C. of the obtained polyamide thermal dissolution liquid was 4,000 mPa·s. The polyamide solution was stirred while adding 220.0 g of methanol. During the addition, the internal temperature was held at 65° C. or higher. After methanol addition, the flask was raised from the oil bath and was subjected to cooling. One hour later, stirring was stopped once the temperature reached 30° C., and solid precipitate was recovered by pressurized filtration using a 10 μm membrane filter. The weight of the filtration residue in a damp state was 43 g. After adding 50 g of methanol to the filter, pressurized filtration was performed once again. The amount of calcium chloride in the filtrate was analyzed by ion chromatography, and the residual amount of calcium chloride in the polyamide was calculated. Operations from addition of methanol to calculation of the residual amount of calcium chloride were repeated, and washing was ended at the point at which the residual amount reached 1,000 ppm or less. The number of washes was 6 and the amount of washing liquid was 300 g. A solid precipitate present after washing was thermally dried in an 80° C. vacuum dryer to yield 9.8 g (yield: 98.0%) of powdered polyamide 66. The amount of energy required in drying, calculated from the solvent content, was 3.6 kJ per 1 g of polyamide 66.

### Reference Example 5

A 1000 mL glass bottle in which a stirring bar had been placed was charged with 10 g of polyamide 66 and 100 g of a 20 wt % calcium chloride methanol solution, was immersed in a 60° C. water bath, and was stirred for 12 hours by a magnetic stirrer while causing dissolution of the polyamide. With the glass bottle still immersed in the water bath, 110 g of methanol was added under stirring. Solid did not precipitate at this time. The glass bottle was immersed in an ice bath and was cooled under stirring. The internal temperature dropped from 50° C. to 20° C. over 30 minutes during this cooling at a cooling rate of 60° C./hr. After cooling, suction filtration was performed to recover 65 g of precipitated solid. Thorough washing with water and vacuum drying at 40° C. were performed to yield 9.9 g of powdered polyamide.

The obtained polyamide was analyzed and was found to have a median diameter of 41.4 μm and a span of 1.75.

### Reference Example 6

A 1000 mL glass bottle in which a stirring bar had been placed was charged with 10 g of polyamide 66 and 100 g of a 20 wt % calcium chloride methanol solution, was immersed in a 90° C. oil bath, and was stirred for 12 hours by a magnetic stirrer while causing dissolution of the polyamide. With the glass bottle still immersed in the oil bath, 400 g of methanol was added under stirring. Solid did not precipitate at this time. The glass bottle was immersed in an ice bath and was cooled under stirring. The internal temperature dropped from 85° C. to 20° C. over 60 minutes during this cooling at a cooling rate of 65° C./hr. After cooling, suction filtration was performed to recover 64 g of precipitated solid. Thorough washing with water and vacuum drying at 40° C. were performed to yield 9.9 g of powdered polyamide.

The obtained polyamide was analyzed and was found to have a median diameter of 40.5 μm and a span of 2.00.

### Reference Example 7

A 1000 mL glass bottle in which a stirring bar had been placed was charged with 3 g of polyamide 66 and 100 g of a 20 wt % calcium chloride methanol solution, was immersed in a 60° C. water bath, and was stirred for 12 hours by a magnetic stirrer while causing dissolution of the polyamide. With the glass bottle still immersed in the water bath, 103 g of methanol was added under stirring. Solid did not precipitate at this time. The glass bottle was immersed in an ice bath and was cooled under stirring. The internal temperature dropped from 50° C. to 20° C. over 30 minutes during this cooling at a cooling rate of 60° C./hr. After cooling, suction filtration was performed to recover 23 g of precipitated solid. Thorough washing with water and vacuum drying at 40° C. were performed to yield 2.7 g of powdered polyamide.

The obtained polyamide was analyzed and was found to have a median diameter of 20.4 μm and a span of 2.57.

### Reference Example 8

A 1000 mL glass bottle in which a stirring bar had been placed was charged with 18 g of polyamide 66 and 100 g of a 20 wt % calcium chloride methanol solution, was immersed in a 60° C. water bath, and was stirred for 24 hours by a magnetic stirrer while causing dissolution of the polyamide. With the glass bottle still immersed in the water bath, 118 g of methanol was added under stirring. Solid did not precipitate at this time. The glass bottle was immersed in an ice bath and was cooled under stirring. The internal temperature dropped from 50° C. to 20° C. over 32 minutes during this cooling at a cooling rate of 56° C./hr. After cooling, suction filtration was performed to recover 125 g of precipitated solid. Thorough washing with water and vacuum drying at 40° C. were performed to yield 17.6 g of powdered polyamide.

The obtained polyamide was analyzed and was found to have a median diameter of 21.5 μm and a span of 2.28.

### Reference Example 9

A 1000 mL glass bottle in which a stirring bar had been placed was charged with 10 g of polyamide 66 and 100 g of a 20 wt % calcium chloride methanol solution, was immersed in a 90° C. oil bath, and was stirred for 12 hours by a magnetic stirrer while causing dissolution of the polyamide. With the glass bottle still immersed in the oil bath, 600 g of methanol was added under stirring. Solid did not precipitate at this time. The glass bottle was immersed in an ice bath and was cooled under stirring. The internal temperature dropped from 85° C. to 20° C. over 70 minutes during this cooling at a cooling rate of 56° C./hr. After cooling, suction filtration was performed to recover 64 g of precipitated solid. Thorough washing with water and vacuum drying at 40° C. were performed to yield 9.9 g of powdered polyamide.

The obtained polyamide was analyzed and was found to have a median diameter of 40.2 μm and a span of 2.95.

### Reference Example 10

A 1000 mL glass bottle in which a stirring bar had been placed was charged with 10 g of polyamide 66 and 100 g of a 20 wt % calcium chloride methanol solution, was immersed in a 60° C. oil bath, and was stirred for 12 hours by a magnetic stirrer while causing dissolution of the polyamide. With the glass bottle still immersed in the oil bath, 30 g of methanol was added under stirring. Solid did not precipitate at this time. The glass bottle was immersed in an ice bath and was cooled under stirring. The internal temperature dropped from 50° C. to 20° C. over 30 minutes during this cooling at a cooling rate of 60° C./hr. After cooling, suction filtration was performed to recover 37 g of precipitated solid. Thorough washing with water and vacuum drying at 40° C. were performed to yield 6.5 g of powdered polyamide.

The obtained polyamide was analyzed and was found to have a median diameter of 30.3 μm and a span of 3.36.

### Reference Example 11

Powdered polyamide was obtained in the same way as in Example 1 with the used polyamide changed to nylon 6.

The obtained polyamide was analyzed and was found to have a median diameter of 42.1 μm and a span of 1.77.

### Comparative Example 5

A 1000 mL glass bottle in which a stirring bar had been placed was charged with 10 g of polyamide 66 and 100 g of a 20 wt % calcium chloride methanol solution, was immersed in a 60° C. water bath, and was stirred for 12 hours by a magnetic stirrer while causing dissolution of the polyamide. With the glass bottle still immersed in the water bath, 110 g of a methanol aqueous solution (methanol and water mixed in weight ratio of 8:2) was added under stirring. Solid precipitated at this time. Upon measurement of the amount of polyamide in the supernatant, the precipitated amount was 2.3 g. The glass bottle was immersed in an ice bath and was cooled under stirring. The internal temperature dropped from 50° C. to 20° C. over 30 minutes during this cooling at a cooling rate of 60° C./hr. After cooling, suction filtration was performed to recover 65 g of precipitated solid. Thorough washing with water and vacuum drying at 40° C. were performed to yield 9.9 g of powdered polyamide.

The obtained polyamide was analyzed and was found to have a median diameter of 30 μm and a span of 6.28.

### Comparative Example 6

A 1,000 mL flask in which a stirring bar had been placed was charged with 10 g of polyamide 66 and 210 g of a 10 wt % calcium chloride methanol solution and was stirred by a magnetic stirrer under heating to 90° C. in an oil bath, but the polyamide did not dissolve.

### Comparative Example 7

A 1000 mL autoclave in which a stirring bar had been placed was charged with 10 g of polyamide 66 and 210 g of a 10 wt % calcium chloride methanol solution, was hermetically sealed, and was stirred by a magnetic stirrer for 12 hours under heating to 140° C. by a heater to dissolve the polyamide. The heating was stopped, and cooling was performed in an ice bath. The internal temperature dropped from 140° C. to 20° C. over 150 minutes during this cooling at a cooling rate of 48° C./hr. After cooling, suction filtration was performed to recover 64 g of precipitated solid. Thorough washing with water and vacuum drying at 40° C. were performed to yield 9.9 g of powdered polyamide.

The obtained polyamide was analyzed and was found to have a median diameter of 10 μm and a span of 20.00.

### Comparative Example 8

Operations were performed in the same way as in Comparative Example 3 to recover 64 g of powdered polyamide with the exception that the cooling rate was controlled to 5° C./hr using a heating medium circulation device. The cooling time was 24 hours.

The obtained polyamide was analyzed and was found to have a median diameter of 30 μm and a span of 1.94.

The following describes examples of aspect (II) of the present disclosure.

An analysis method used in the examples and comparative examples was as follows.

### Example 1

A 1000 mL glass bottle in which a stirring bar had been placed was charged with 10 g of polyamide 66 and 100 g of a 20 wt % calcium chloride methanol solution, and was stirred for 12 hours by a magnetic stirrer in a 50° C. water bath while causing dissolution of the polyamide. The glass bottle was taken out of the water bath, and 800 g of methanol was added under stirring at room temperature. Once precipitation of solid had been confirmed, the glass bottle was stirred in an 80° C. water bath for 1 hour. After stirring, the glass bottle was taken out of the water bath, 30 g of precipitated solid was recovered by suction filtration, and the precipitated solid was washed twice using 50 g of methanol. The recovered solid content was transferred to a 500 mL beaker in which a stirring bar had been placed, was washed under stirring through addition of 100 g of water, and was then subjected to solid-liquid separation by vacuum filtration. The amount of calcium chloride remaining in the solid content was calculated through analysis of the resultant filtrate. Water washing was repeated in a case in which the amount was 1,000 ppm or more relative to polyamide and was ended at the point at which the amount reached less than 1,000 ppm. The number of water washes was 4 and the amount of washing water was 400 g. Moreover, 26 g of solid content was recovered. Vacuum drying was performed at 40° C. to yield 9.9 g of powdered polyamide.

### Example 2

After dissolving polyamide and causing precipitation of solid in the same way as in Example 1, the precipitated solid was recovered by suction filtration and was washed twice using 50 g of methanol to recover 49 g of solid content. The recovered solid content was loaded into a vacuum dryer and was subjected to thermal vacuum drying at 50° C. In water washing of the obtained solid content in the same way as in Example 1, the number of water washes was 4 and the amount of washing water was 400 g. Moreover, 21 g of solid content was recovered. Vacuum drying was performed at 40° C. to yield 9.9 g of powdered polyamide.

### Example 3

After dissolving polyamide and causing precipitation of solid in the same way as in Example 1 with the exception that the used polyamide was changed to nylon 6, the precipitated solid was recovered by suction filtration and was washed twice using 50 g of methanol to recover 47 g of solid content. The recovered solid content was loaded into a vacuum dryer and was subjected to thermal vacuum drying at 50° C. In water washing of the obtained solid content in the same way as in Example 1, the number of water washes was 4 and the amount of washing water was 400 g. Moreover, 20 g of solid content was recovered. Vacuum drying was performed at 40° C. to yield 9.7 g of powdered polyamide.

### Comparative Example 1

After dissolving polyamide and causing precipitation of solid in the same way as in Example 1, the precipitated solid was recovered by suction filtration and was washed twice using 50 g of methanol to recover 50 g of solid content. In water washing of the obtained solid content in the same way as in Example 1, the number of water washes was 10 and the amount of washing water was 1,000 g. Moreover, 78 g of solid was recovered. Vacuum drying was performed at 40° C. to yield 9.9 g of powdered polyamide.

The following describes examples of aspect (III) of the present disclosure.

A silicone-coated nylon 66 base fabric (hereinafter, referred to as a “nylon 66 base fabric”) used in the present examples is a base fabric in which a silicone resin constitutes 10% of mass of the base fabric.

### Example 1

A 300 mL glass bottle in which a stirring bar had been placed was charged with 10 g of the nylon 66 base fabric and 100 g of a 20 wt % calcium chloride methanol solution, was immersed in a 60° C. water bath, and was stirred for 12 hours by a magnetic stirrer while causing dissolution of the polyamide. The viscosity of the polyamide dissolution liquid was 500 mPa·s. The polyamide dissolution liquid was passed through a stainless steel mesh having an opening size of 1 mm and a stainless steel mesh having an opening size of 500 μm to remove the silicone resin. The removed silicone resin was returned to the original 1000 mL glass bottle, was washed with 5 g of a 20 wt % calcium chloride methanol solution, and was then passed through the meshes once again to perform separation from a polyamide-containing solution. The recovered polyamide-containing solution was transferred to a 1,000 mL beaker and was stirred while 500 g of methanol was added thereto. A produced precipitate was filtered and recovered using a 1 μm membrane filter. Solid present after filtration was thoroughly washed with water. The washed solid was thermally dried in a 40° C. vacuum dryer to yield 8.8 g (yield: 97.8%) of recycled polyamide.

### Example 2

A 300 mL glass bottle in which a stirring bar had been placed was charged with 7 g of the nylon 66 base fabric and 100 g of a 10 wt % zinc chloride methanol solution, was immersed in a 60° C. water bath, and was stirred by a magnetic stirrer for 50 hours while causing dissolution of the polyamide. The viscosity of the polyamide dissolution liquid was 100 mPa·s. The polyamide dissolution liquid was passed through a stainless steel mesh having an opening size of 1 mm and a stainless steel mesh having an opening size of 500 μm to remove the silicone resin. The removed silicone resin was returned to the original 1000 mL glass bottle, was washed with 5 g of a 10 wt % zinc chloride methanol solution, and was then passed through the meshes once again to perform separation from a polyamide-containing solution. The recovered polyamide-containing solution was transferred to a 1,000 mL beaker and was stirred while 500 g of methanol was added thereto. A produced precipitate was filtered and recovered using a 1 μm membrane filter. Solid present after filtration was thoroughly washed with water. The washed solid was thermally dried in a 40° C. vacuum dryer to yield 6.0 g (yield: 95.2%) of recycled polyamide.

### Example 3

A 300 mL glass bottle in which a stirring bar had been placed was charged with 10 g of a nylon 6 base fabric (same silicone resin content as the nylon 66 base fabric) and 100 g of a 20 wt % calcium chloride methanol solution (water content: 1,000 ppm), was immersed in a 60° C. water bath, and was stirred by a magnetic stirrer for 12 hours while causing dissolution of the polyamide. The viscosity of the polyamide dissolution liquid was 400 mPa·s. A mixture of the polyamide solution and silicone resin was passed through a stainless steel mesh having an opening size of 1 mm and a stainless steel mesh having an opening size of 500 μm to remove the silicone resin. The removed silicone resin was returned to the original 1000 mL glass bottle, was washed with 20 g of a 20 wt % calcium chloride methanol solution, and was then passed through the meshes once again to perform separation from a polyamide-containing solution. The recovered polyamide-containing solution was transferred to a 1,000 mL beaker and was stirred while 500 g of methanol was added thereto. A produced precipitate was filtered and recovered using a 1 μm membrane filter. Solid present after filtration was thoroughly washed with water. The washed solid was thermally dried in a 40° C. vacuum dryer to yield 8.5 g (yield: 94.4%) of recycled polyamide.

### Example 4

An evaporator was used to concentrate 534 g of a filtrate obtained in Example 1 to obtain 459 g of methanol as a distilled fraction and 75 g of a 20 wt % calcium chloride methanol solution as a pot residue.

The obtained pot residue was used to obtain recycled polyamide from 7.5 g of the nylon 66 base fabric in the same way as in Example 1, thereby yielding 6.6 g of recycled polyamide (yield: 97.8%).

### Comparative Example 1

A 300 mL glass bottle in which a stirring bar had been placed was charged with 25 g of the nylon 66 base fabric and 100 g of a saturated calcium chloride dihydrate methanol solution, was immersed in a 60° C. water bath, and was stirred by a magnetic stirrer for 24 hours while causing dissolution of the polyamide. The viscosity of the polyamide dissolution liquid was 35,000 mPa·s. The polyamide dissolution liquid was passed through a stainless steel mesh having an opening size of 1 mm and a stainless steel mesh having an opening size of 500 μm to remove the silicone resin. The removed silicone resin was returned to the original 1,000 mL glass bottle, was washed using 20 g of a saturated calcium chloride dihydrate methanol solution, and was passed through the meshes once again to perform separation from a polyamide-containing solution. The recovered polyamide-containing solution was transferred to a 1,000 mL beaker and was stirred while 500 g of methanol was added thereto. A produced precipitate was filtered and recovered using a 1 μm membrane filter. Solid present after filtration was thoroughly washed with water. The washed solid was thermally dried in a 40° C. vacuum dryer to yield 10.8 g (yield: 48.0%) of recycled polyamide. Upon peeling of the removed silicone resin, nylon 66 was confirmed to be remaining in the silicone resin.

The following describes an example of aspect (IV) of the present disclosure.

### Example 1

A 2,000 mL glass bottle in which a stirring bar had been placed was charged with 200 g of anhydrous calcium chloride, 20 mg of calcium hydroxide, and 800 g of methanol and was stirred for 3 hours to obtain a methanol composition. A mesh made of SUS316 was loaded into the glass bottle and was immersed at room temperature for 100 hours. The supernatant remained colorless and transparent.

### Comparative Example 1

A 2,000 mL glass bottle in which a stirring bar had been placed was charged with 200 g of anhydrous calcium chloride and 800 g of methanol and was stirred for 3 hours to obtain a methanol composition. A mesh made of SUS316 was loaded into the glass bottle and was immersed at room temperature for 100 hours. The supernatant was colored yellow.

### Comparative Example 2

A 2,000 mL glass bottle in which a stirring bar had been placed was charged with 200 g of anhydrous calcium chloride, 20 mg of sodium hydroxide, and 800 g of methanol and was stirred for 3 hours to obtain a methanol composition. Small pieces of sodium chloride were scattered inside thereof. A mesh made of SUS316 was loaded into the glass bottle and was immersed at room temperature for 100 hours. Although the supernatant was not colored, fine particles of sodium chloride were formed an intersection sites of the mesh, and there was discoloration of the metal surface.

The following describes examples of aspect (V) of the present disclosure.

### Example 1

A 300 mL glass bottle in which a stirring bar had been placed was charged with 10 g of polyamide 66 and 100 g of a 20 wt % calcium chloride methanol solution, was immersed in a 60° C. water bath, and was stirred for 12 hours by a magnetic stirrer while causing dissolution of the polyamide. The recovered polyamide-containing solution was transferred to a 1,000 mL beaker and was stirred while 500 g of methanol was added thereto. A produced precipitate was filtered and recovered using a 1 μm membrane filter. Solid present after filtration was washed on the filter using 200 g of methanol. Upon analysis of the solid present after washing, the content of calcium chloride relative to polyamide was 10%. The obtained solid was thermally dried in a 40° C. vacuum dryer to yield 10.2 g of recycled polyamide (containing 0.98 g of calcium chloride). The obtained polyamide had a powdered form.

### Example 2

A 300 mL glass bottle in which a stirring bar had been placed was charged with 10 g of polyamide 66 and 100 g of a 10 wt % zinc chloride solution, was immersed in a 60° C. water bath, and was stirred for 12 hours by a magnetic stirrer while causing dissolution of the polyamide. The recovered polyamide-containing solution was transferred to a 1,000 mL beaker and was stirred while 500 g of methanol was added thereto. A produced precipitate was filtered and recovered using a 1 μm membrane filter. Solid present after filtration was washed on the filter using 200 g of methanol. Upon analysis of the solid present after washing, the content of calcium chloride relative to polyamide was 9%. The obtained solid was thermally dried in a 40° C. vacuum dryer to yield 10.1 g of recycled polyamide (containing 0.95 g of zinc chloride). The obtained polyamide had a powdered form.

### Comparative Example 1

A 300 mL glass bottle in which a stirring bar had been placed was charged with 10 g of polyamide 66 and 100 g of a 20 wt % calcium chloride methanol solution, was immersed in a 60° C. water bath, and was stirred for 12 hours by a magnetic stirrer while causing dissolution of the polyamide. The recovered polyamide-containing solution was transferred to a 1,000 mL beaker and was stirred while 500 g of methanol was added thereto. A produced precipitate was filtered and recovered using a 1 μm membrane filter. Solid present after filtration was washed on the filter using 100 g of methanol. Upon analysis of the solid present after washing, the content of calcium chloride relative to polyamide was 25%. The obtained solid was thermally dried in a 40° C. vacuum dryer to yield 12.4 g of recycled polyamide (containing 2.5 g of calcium chloride). The obtained polyamide stuck together inside of the vessel and could not easily be removed from the vessel.

The following describes examples of aspect (VI) of the present disclosure.

### (Base Fabric for Airbag)

In the following examples and comparative example, a base fabric for an airbag was used as a mixed material of polyamide and polyethylene terephthalate.

This airbag base fabric is a woven fabric formed of polyamide fibers (nylon 66 fibers) and polyethylene terephthalate fibers and has a weight ratio of polyamide fibers to polyethylene terephthalate fibers of 99:1. The airbag base fabric was cut to 50 mm×50 mm, and the cut airbag base fabric was used as a sample.

### Example 1

A 300 mL glass bottle in which a stirring bar had been placed was charged with 10 g of the airbag base fabric and 100 g of a 20 wt % calcium chloride methanol solution, was immersed in a 60° C. water bath, and was stirred by a magnetic stirrer for 12 hours while causing dissolution of the polyamide. The polyamide dissolution liquid was passed through a stainless steel mesh having an opening size of 1 mm and a stainless steel mesh having an opening size of 500 μm in order to remove a woven fabric of polyethylene terephthalate that had not dissolved. The obtained polyethylene terephthalate was washed with methanol and was dried to yield 0.095 g (yield of 95% relative to polyethylene terephthalate in base fabric).

The recovered polyamide-containing solution was transferred to a 1,000 mL beaker and was stirred while 500 g of methanol was added thereto. A produced precipitate was filtered and recovered using a 1 μm membrane filter. Solid present after filtration was thoroughly washed with water. The washed solid was thermally dried in a 40° C. vacuum dryer to yield 9.8 g of recycled polyamide (yield of 99% relative to polyamide in base fabric).

### Example 2

A 300 mL glass bottle in which a stirring bar had been placed was charged with 10 g of the airbag base fabric and 200 g of a 10 wt % zinc chloride methanol solution, was immersed in a 60° C. water bath, and was stirred by a magnetic stirrer for 50 hours while causing dissolution of the polyamide. The polyamide dissolution liquid was passed through a stainless steel mesh having an opening size of 1 mm and a stainless steel mesh having an opening size of 500 μm to remove woven fabric of polyethylene terephthalate that had not dissolved. The obtained polyethylene terephthalate was washed with methanol and dried to yield 0.095 g (yield of 95% relative to polyethylene terephthalate in base fabric).

The recovered polyamide-containing solution was transferred to a 1,000 mL beaker and was stirred while 500 g of methanol was added thereto. A produced precipitate was filtered and recovered using a 1 μm membrane filter. Solid present after filtration was thoroughly washed with water. The washed solid was thermally dried in a 40° C. vacuum dryer to yield 9.5 g of recycled polyamide (yield of 95% relative to polyamide in base fabric).

### Comparative Example 1

A 300 mL glass bottle in which a stirring bar had been placed was charged with 10 g of the airbag base fabric and 200 g of concentrated sulfuric acid, was immersed in a 100° C. oil bath, and was stirred by a magnetic stirrer for 24 hours while causing dissolution of the polyamide. The polyamide dissolution liquid was passed through a Hastelloy mesh having an opening size of 1 mm and a Hastelloy mesh having an opening size of 500 μm in order to attempt to remove a woven fabric of polyethylene terephthalate that had not dissolved, but all of the woven fabric of polyethylene terephthalate had dissolved.

The recovered polyamide-containing solution was transferred to a 2,000 mL beaker and was stirred in an immersed state in an ice bath while 1,500 g of water was added thereto. A produced precipitate was filtered and recovered using a 1 μm membrane filter. Solid present after filtration was thoroughly washed with water. The washed solid was thermally dried in a 40° C. vacuum dryer to yield 8.8 g (yield of 89% relative to polyamide in base fabric). With regards to the reduced yield, it was confirmed through analysis of the filtrate that adipic acid and hexamethylenediamine were present as decomposition products.

The following describes examples of aspect (VII) of the present disclosure.

A urethane-coated nylon 66 base fabric (hereinafter, referred to as a “nylon 66 base fabric”) used in the present examples is a base fabric in which a urethane resin constitutes 10% of mass of the base fabric.

### Example 1

A 300 mL glass bottle in which a stirring bar had been placed was charged with 10 g of the nylon 66 base fabric and 100 g of a 20 wt % calcium chloride methanol solution, was immersed in a 60° C. water bath, and was stirred by a magnetic stirrer for 12 hours while causing dissolution of the polyamide. The viscosity of the polyamide dissolution liquid was 500 mPa·s. The polyamide dissolution liquid was passed through a stainless steel mesh having an opening size of 1 mm and a stainless steel mesh having an opening size of 500 μm to remove the urethane resin. The removed urethane resin was returned to the original 1000 mL glass bottle, was washed with 5 g of a 20 wt % calcium chloride methanol solution, and was then passed through the meshes once again to perform separation from a polyamide-containing solution. The recovered polyamide-containing solution was transferred to a 1,000 mL beaker and was stirred while 500 g of methanol was added thereto. A produced precipitate was filtered and recovered using a 1 μm membrane filter. Solid present after filtration was thoroughly washed with water. The washed solid was thermally dried in a 40° C. vacuum dryer to yield 8.8 g (yield: 97.8%) of recycled polyamide.

### Example 2

A 300 mL glass bottle in which a stirring bar had been placed was charged with 7 g of the nylon 66 base fabric and 100 g of a 10 wt % zinc chloride methanol solution, was immersed in a 60° C. water bath, and was stirred by a magnetic stirrer for 50 hours while causing dissolution of the polyamide. The viscosity of the polyamide dissolution liquid was 100 mPa·s. The polyamide dissolution liquid was passed through a stainless steel mesh having an opening size of 1 mm and a stainless steel mesh having an opening size of 500 μm to remove the urethane resin. The removed urethane resin was returned to the original 1000 mL glass bottle, was washed with 5 g of a 10 wt % zinc chloride methanol solution, and was then passed through the meshes once again to perform separation from a polyamide-containing solution. The recovered polyamide-containing solution was transferred to a 1,000 mL beaker and was stirred while 500 g of methanol was added thereto. A produced precipitate was filtered and recovered using a 1 μm membrane filter. Solid present after filtration was thoroughly washed with water. The washed solid was thermally dried in a 40° C. vacuum dryer to yield 6.0 g (yield: 95.2%) of recycled polyamide.

### Example 3

A 300 mL glass bottle in which a stirring bar had been placed was charged with 10 g of a nylon 6 base fabric (same urethane resin content as nylon 66 base fabric) and 100 g of a 20 wt % calcium chloride methanol solution (water content: 1,000 ppm), was immersed in a 60° C. water bath, and was stirred by a magnetic stirrer for 12 hours while causing dissolution of the polyamide. The viscosity of the polyamide dissolution liquid was 400 mPa·s. The mixture of polyamide solution and urethane resin was passed through a stainless steel mesh having an opening size of 1 mm and a stainless steel mesh having an opening size of 500 μm to remove the urethane resin. The removed urethane resin was returned to the original 1000 mL glass bottle, was washed with 20 g of a 20 wt % calcium chloride methanol solution, and was then passed through the meshes once again to perform separation from a polyamide-containing solution. The recovered polyamide-containing solution was transferred to a 1,000 mL beaker and was stirred while 500 g of methanol was added thereto. A produced precipitate was filtered and recovered using a 1 μm membrane filter. Solid present after filtration was thoroughly washed with water. The washed solid was thermally dried in a 40° C. vacuum dryer to yield 8.5 g (yield: 94.4%) of recycled polyamide.

### Example 4

An evaporator was used to concentrate 534 g of filtrate obtained in Example 1 and to obtain 459 g of methanol as a distilled fraction and 75 g of a 20 wt % calcium chloride methanol solution as a pot residue.

The obtained pot residue was used to obtain recycled polyamide from 7.5 g of the nylon 66 base fabric in the same way as in Example 1, thereby yielding 6.6 g of recycled polyamide (yield: 97.8%).

### Comparative Example 1

A 300 mL glass bottle in which a stirring bar had been placed was charged with 25 g of the nylon 66 base fabric and 100 g of a saturated calcium chloride dihydrate methanol solution, was immersed in a 60° C. water bath, and was stirred by a magnetic stirrer for 24 hours while causing dissolution of the polyamide. The viscosity of the polyamide dissolution liquid was 35,000 mPa·s. The polyamide dissolution liquid was passed through a stainless steel mesh having an opening size of 1 mm and a stainless steel mesh having an opening size of 500 μm to remove the urethane resin. The removed urethane resin was returned to the original 1,000 mL glass bottle, was washed using 20 g of a saturated calcium chloride dihydrate methanol solution, and was passed through the meshes once again to perform separation from a polyamide-containing solution. The recovered polyamide-containing solution was transferred to a 1,000 mL beaker and was stirred while 500 g of methanol was added thereto. A produced precipitate was filtered and recovered using a 1 μm membrane filter. Solid present after filtration was thoroughly washed with water. The washed solid was thermally dried in a 40° C. vacuum dryer to yield 10.8 g (yield: 48.0%) of recycled polyamide. Upon peeling of the removed urethane resin, nylon 66 was confirmed to be remaining in the urethane resin.

### INDUSTRIAL APPLICABILITY

Through the production method of the present embodiment (I), it is possible to reduce liquid content in precipitated powdered polyamide and provide a method of producing powdered polyamide with a reduced amount of washing solvent and reduced energy consumption in drying.

Through aspect (II) of the present disclosure, the amount of waste liquid can be reduced in a recycling process of polyamide, and thus it is expected that the amount of energy required in the process can be suppressed and that the burden of the process can be mitigated.

Through the production method of the present embodiment (III), it is possible to provide a method of producing recycled polyamide powder efficiently and with high yield.

Through aspect (IV) of the present disclosure, it is possible to provide a solvent that has low corrosiveness and that can dissolve polyamide.

Through aspect (V) of the present disclosure, it is possible to provide a method of producing polyamide that enables recovery of polyamide with high efficiency and high yield and that can also yield high quality polyamide without performing excessive washing.

Through aspect (VI) of the present disclosure, it is possible to provide a method of producing polyamide, a method of producing polyethylene terephthalate, and a method of producing polyamide and polyethylene terephthalate that enable recovery of polyamide and/or polyethylene terephthalate from a mixed material of polyamide and polyethylene terephthalate with high efficiency and high yield.

1. A method of producing powdered polyamide comprising:
step 1: a step of heating and dissolving a polyamide resin composition in a metal chloride alcohol solution containing a metal chloride and an alcohol to obtain a polyamide thermal dissolution liquid;
step 2: a step of diluting the polyamide thermal dissolution liquid with an alcohol to obtain an alcohol dilution; and
step 3: a step of cooling the alcohol dilution to cause precipitation of powdered polyamide, wherein
a mass proportion of metal chloride relative to 100 mass % of the metal chloride alcohol solution in the step 1 is not less than 23 mass % and not more than 35 mass %, the polyamide thermal dissolution liquid contains not less than 0.2 mol and not more than 2.5 mol of water relative to 1 mol of metal chloride in the step 1, and the polyamide thermal dissolution liquid is diluted without dropping below a temperature of 50° C. in the step 2.

2. A method of producing powdered polyamide comprising:
step 1: a step of heating and dissolving a polyamide resin composition in a metal chloride alcohol solution containing a metal chloride and an alcohol to obtain a polyamide thermal dissolution liquid;
step 2: a step of diluting the polyamide thermal dissolution liquid with an alcohol to obtain an alcohol dilution; and
step 3: a step of cooling the alcohol dilution to cause precipitation of powdered polyamide, wherein
a mass proportion of metal chloride relative to 100 mass % of the metal chloride alcohol solution in the step 1 is not less than 23 mass % and not more than 35 mass %, the polyamide thermal dissolution liquid contains not less than 0.2 mol and not more than 2.5 mol of water relative to 1 mol of metal chloride in the step 1, and mass of polyamide that precipitates in the step 2 is 1 mass % or less relative to total mass of polyamide contained in the polyamide thermal dissolution liquid.

3-6. (canceled)

7. The method of producing powdered polyamide according to claim 1, further comprising
step 4: a step of washing the powdered polyamide obtained in the step 3 at least once using a solvent.

8. The method of producing powdered polyamide according to claim 7, wherein a solvent used in a first washing in the step 4 is the same alcohol as the alcohol that is used in the step 1.

9. The method of producing powdered polyamide according to claim 1, wherein a temperature of the heating and dissolving of the step 1 is not lower than 60° C. and not higher than 80° C.

10. The method of producing powdered polyamide according to claim 1, further comprising
step 5: a step of heating the powdered polyamide that has precipitated in the step 3 to obtain a heated powdered polyamide.

11. The method of producing powdered polyamide according to claim 10, further comprising, after the step 5,
step 6: a step of performing solid-liquid separation of the heated powdered polyamide obtained in the step 5 and washing a solid obtained thereby.

12. The method of producing powdered polyamide according to claim 1, wherein the polyamide resin composition is a polyamide resin composition that contains polyamide coated with a silicone resin, and a concentration of polyamide in the polyamide thermal dissolution liquid in the step 1 is 5 mass % to 15 mass %.

13. The method of producing powdered polyamide according to claim 1, wherein the polyamide resin composition is a polyamide resin composition that contains polyamide coated with a silicone resin, and viscosity at 25° C. of the polyamide thermal dissolution liquid in the step 1 is 10 mPa·s to 20,000 mPa·s.

14. (canceled)

15. The method of producing powdered polyamide according to claim 1, wherein the metal chloride alcohol solution is a metal chloride alcohol solution that contains a metal chloride in a concentration of not less than 23 mass % and not more than 35 mass %, a hydroxide of the same metal as a metal included in the metal chloride in a concentration of 0.001 mass % to 1 mass %, and water in a concentration of 0.001 mass % to 10 mass %.

16. The method of producing powdered polyamide according to claim 1, wherein the method is a method of producing powdered polyamide containing 0.001 ppm to 1,500 ppm of calcium atoms and having a halogen atom molar content of less than 1 relative to calcium atom molar content.

17. The method of producing powdered polyamide according to claim 1, wherein the polyamide resin composition contains at least polyamide and polyethylene terephthalate.

18. The method of producing powdered polyamide according to claim 1, wherein the polyamide resin composition contains polyamide coated with a urethane resin.

19. The method of producing powdered polyamide according to claim 1, comprising, after the steps 1 to 3:
step 7: a step of recovering powdered polyamide that has precipitated;
step 8: a washing step of washing the powdered polyamide that has been recovered; and
step 9: a drying step of thermally drying the powdered polyamide that is present after the washing, wherein
an amount of metal chloride that is attached to the powdered polyamide present after the thermal drying of the step 9 is 20 parts by mass or less relative to 100 parts by mass of the powdered polyamide.
